(19) United States
(12) Patent Application Publication
(10) Pub. No.: US 2024/0348400 A1
(43) Pub. Date: Oct. 17, 2024

(54) METHOD AND DEVICE FOR DETERMINING PTRS-DMRS ASSOCIATION IN A WIRELESS COMMUNICATION SYSTEM

(71) Applicant: Samsung Electronics Co., Ltd., Gyeonggi-do (KR)

(72) Inventors: Youngrok JANG, Gyeonggi-do (KR); Ameha Tsegaye ABEBE, Gyeonggi-do (KR); Seongmok LIM, Gyeonggi-do (KR); Hyoungju JI, Gyeonggi-do (KR)

(21) Appl. No.: 18/625,598

(22) Filed: Apr. 3, 2024

(30) Foreign Application Priority Data
Apr. 7, 2023 (KR) 10-2023-0046328

(51) Int. Cl. H04L 5/00

(52) U.S. Cl. CPC H04L 5/0051

(57) ABSTRACT

The disclosure relates to a 5G or 6G communication system for supporting a higher data transmission rate. A method performed by a UE in a wireless communication system includes receiving, from a BS, DCI scheduling a PUSCH of two CWs, the DCI including information on an association between a PTRS and a DMRS; identifying a PTRS port based on the information; and transmitting, to the BS, the PUSCH and the PTRS for the PUSCH. The PTRS is transmitted on the PTRS port.

### CROSS-REFERENCE TO RELATED APPLICATION(S)

This application is based on and claims priority under 35 U.S.C. § 119 (a) to Korean Patent Application No. 10-2023-0046328, which was filed in the Korean Intellectual Property Office on Apr. 7, 2023, the entire disclosure of which is incorporated herein by reference.

### 1. FIELD

The disclosure relates generally to an operation of a terminal and a base station (BS) in a wireless communication system, and more particularly to a method and a device for determining an association between a demodulation reference signal (DMRS) and a phase tracking reference signal (PTRS) in a wireless communication system.

### 2. DESCRIPTION OF RELATED ART

5^{th} generation (5G) mobile communication technologies define broad frequency bands such that high transmission rates and new services are possible, and can be implemented in “sub 6 gigahertz (GHz)” bands, such as 3.5 GHZ, and also in “above 6 GHz” bands, which may be referred to as mm Wave, including 28 GHz and 39 GHz.

In addition, it has been considered to implement 6^{th} generation (6G) mobile communication technologies (e.g., beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

Since the initial development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mm Wave, supporting numerologies (e.g., operating multiple subcarrier spacings (SCSs)) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amounts of data transmissions and a polar code for highly reliable transmission of control information, layer 2 (L2) pre-processing, and network slicing for providing a dedicated network specialized to a specific service.

There are ongoing discussions regarding improvement and performance enhancement of initial 5G mobile communication technologies in view of services to be supported by newer 5G mobile communication technologies, such as physical layer standardization regarding technologies including vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, a non-terrestrial network (NTN), which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended Reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), and also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### SUMMARY

An aspect of the disclosure is to provide a device and a method by which a service is effectively providable in a wireless communication system.

In accordance with an aspect of the disclosure, a method performed by a UE in a wireless communication system is provided. The method includes receiving, from a BS, DCI scheduling a PUSCH of two CWs, the DCI including information on an association between a PTRS and a DMRS; identifying a PTRS port based on the information; and transmitting, to the BS, the PUSCH and the PTRS for the PUSCH. The PTRS is transmitted on the PTRS port.

In accordance with another aspect of the disclosure, a method performed by a BS in a wireless communication system is provided. The method includes transmitting, to a UE, DCI scheduling a PUSCH of two CWs, the DCI including information on an association between a PTRS and a DMRS; and receiving, from the UE, the PUSCH and the PTRS for the PUSCH, wherein the PTRS is received on a PTRS port which is based on the information.

In accordance with another aspect of the disclosure, a UE is provided for use in a wireless communication system. The UE includes a transceiver, and a controller coupled with the transceiver and configured to receive, from a BS, DCI scheduling a PUSCH of two CWs, the DCI including information on an association between a PTRS and a DMRS, identify a PTRS port based on the information, and transmit, to the BS, the PUSCH and the PTRS for the PUSCH. The PTRS is transmitted on the PTRS port.

In accordance with another aspect of the disclosure, a BS is provided for use in a wireless communication system. The BS includes a transceiver; and a controller coupled with the transceiver and configured to transmit, to a UE, DCI scheduling a PUSCH of two CWs, the DCI including information on an association between a PTRS and a DMRS, and receive, from the UE, the PUSCH and the PTRS for the PUSCH. The PTRS is received on a PTRS port which is based on the information.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a time-frequency domain in a wireless communication system according to an embodiment;

FIG. 2 illustrates frames, subframes, and slots in a wireless communication system according to an embodiment;

FIG. 3 illustrates a BWP configuration in a wireless communication system according to an embodiment;

FIG. 4 illustrates a control resource set (CORESET) of a downlink (DL) control channel in a wireless communication system according to an embodiment;

FIG. 5 illustrates a DL control channel in a wireless communication system according to an embodiment;

FIG. 6 illustrates time domain resource allocation with regard to a physical DL shared channel (PDSCH) in a wireless communication system according to an embodiment;

FIG. 7 illustrates physical uplink (UL) shared channel (PUSCH) repeated transmission type B in a wireless communication system according to an embodiment;

FIG. 8 is a flowchart illustrating operations of a terminal according to an embodiment;

FIG. 9 is a flowchart illustrating operations of a BS according to an embodiment;

FIG. 10 illustrates a UE in a wireless communication system according to an embodiment; and

FIG. 11 illustrates a BS in a wireless communication system according to an embodiment.

### DETAILED DESCRIPTION

Hereinafter, various embodiments of the disclosure will be described in detail with reference to the accompanying drawings.

In describing the embodiments, descriptions related to technical contents well-known in the art and not associated directly with the disclosure will be omitted to prevent obscuring of the main idea of the disclosure and more clearly transfer the main idea.

In the accompanying drawings, some elements may be exaggerated, omitted, or schematically illustrated. Furthermore, the size of each element does not completely reflect the actual size. In the drawings, identical or corresponding elements are provided with identical reference numerals.

Advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Throughout the specification, the same or like reference numerals designate the same or like elements.

The terms which will be described below are terms defined in consideration of the functions in the disclosure, and may be different according to users, intentions of the users, or customs. Therefore, the definitions of the terms should be made based on the contents throughout the specification.

In the following description, a BS is an entity that allocates resources to terminals, and may include at least one of a gNode B, an eNode B, a Node Ba wireless access unit, a BS controller, and a node on a network. A terminal may include a UE, a mobile station (MS), a cellular phone, a smartphone, a computer, or a multimedia system capable of performing communication functions. In the disclosure, a DL refers to a radio link via which a BS transmits a signal to a terminal, and a UL refers to a radio link via which a terminal transmits a signal to a BS.

In the following description, long term evolution (LTE) or LTE-advanced (A) systems may be described by way of example, but the embodiments of the disclosure may also be applied to other communication systems having similar technical backgrounds or channel types. Examples of such communication systems may include 5G mobile communication technologies (e.g., NR) developed beyond LTE-A, and in the following description, the “5G” may be the concept that covers the exiting LTE, LTE-A, or other similar services.

In addition, based on determinations by those skilled in the art, the embodiments of the disclosure may also be applied to other communication systems through some modifications without significantly departing from the scope of the disclosure.

Herein, each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

Herein, the term “unit” refers to a software element or a hardware element, such as a field programmable gate array (FPGA) or an application specific integrated circuit (ASIC), which performs a predetermined function. However, the term “unit” does not always have a meaning limited to software or hardware. The term “unit” may be constructed either to be stored in an addressable storage medium or to execute one or more processors. Therefore, a “unit” includes, e.g., software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by a “unit” may be either combined into a smaller number of elements, or a “unit”, or divided into a larger number of elements, or a “unit”. Moreover, the elements and “units” or may be implemented to reproduce one or more CPUs within a device or a security multimedia card. Furthermore, a “unit” may include one or more processors.

A wireless communication system is advancing to a broadband wireless communication system for providing high-speed and high-quality packet data services using communication standards, such as high-speed packet access (HSPA) of 3^{rd} generation partnership project (3GPP), LTE or evolved universal terrestrial radio access (E-UTRA), LTE-A, LTE-Pro, high-rate packet data (HRPD) of 3GPP2, ultra-mobile broadband (UMB), IEEE 802.16e, etc., as well as typical voice-based services.

As a typical example of a broadband wireless communication system, an LTE system employs an orthogonal frequency division multiplexing (OFDM) scheme in a DL and employs a single carrier frequency division multiple access (SC-FDMA) scheme in a UL. The UL indicates a radio link through which a UE (or an MS) transmits data or control signals to a BS (or eNode B), and the DL indicates a radio link through which the BS transmits data or control signals to the UE.

The above multiple access schemes may separate data or control information of respective users by allocating and operating time-frequency resources for transmitting the data or control information for each user so as to avoid overlapping each other, i.e., so as to establish orthogonality.

Since a 5G communication system, which is a post-LTE communication system, should freely reflect various requirements of users, service providers, etc., services satisfying various requirements should be supported. The services considered in the 5G communication system include eMBB communication, mMTC, URLLC, etc.

eMBB aims at providing a data rate higher than that supported by existing LTE, LTE-A, or LTE-Pro. For example, in the 5G communication system, eMBB should provide a peak data rate of 20 Gbps in the DL and a peak data rate of 10 Gbps in the UL for a single BS. Furthermore, the 5G communication system should provide an increased user-perceived data rate to the UE, as well as the maximum data rate. In order to satisfy such requirements, transmission/reception technologies including a further enhanced MIMO transmission technique are required to be improved. In addition, the data rate for the 5G communication system may be obtained using a frequency bandwidth more than 20 MHz in a frequency band of 3 to 6 GHz or 6 GHZ or more, instead of transmitting signals using a transmission bandwidth up to 20 MHz in a band of 2 GHz used in LTE.

In addition, mMTC is being considered to support application services such as the Internet of things (IoT) in the 5G communication system. mMTC has requirements, such as support of connection of a large number of UEs in a cell, enhancement coverage of UEs, improved battery time, a reduction in the cost of a UE, etc., in order to effectively provide the IoT. Since the IoT provides communication functions while being provided to various sensors and various devices, it should support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. A UE supporting mMTC should be configured to be inexpensive, and may require a very long battery life-time such as 10 to 15 years because it may be difficult to frequently replace the battery of the UE.

URLLC, which is a cellular-based mission-critical wireless communication service, may be used for remote control for robots or machines, industrial automation, unmanned aerial vehicles, remote health care, emergency alert, etc. Thus, URLLC should provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

These 5G services, i.e., eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the above-described three services.

In the following description, the term “a/b” may be understood as at least one of a or b.

### NR Time-Frequency Resources

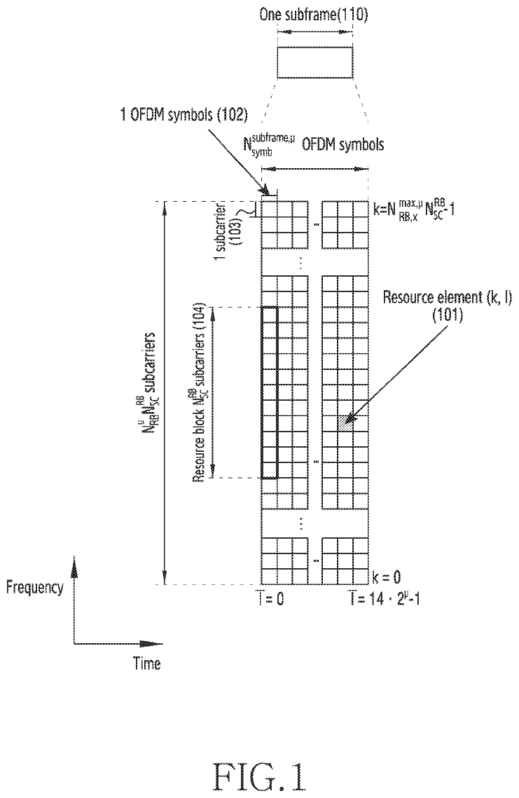

FIG. 1 illustrates a time-frequency domain in a wireless communication system according to an embodiment. In particular, FIG. 1 illustrates a time-frequency domain, which is a radio resource domain in which data or control channels are transmitted in a 5G system.

Referring to FIG. 1, the horizontal axis denotes a time domain, and the vertical axis denotes a frequency domain. A basic unit of resources in the time and frequency domains is a resource element (RE) 101, which may be defined as one OFDM symbol 102 along the time axis and one subcarrier 103 along the frequency axis. In the frequency domain, N_{SC}^{SB} (e.g., 12) consecutive REs may constitute one resource block (RB) 104. In the time axis, one subframe 110 may include a plurality of OFDM symbols 102. For example, one subframe may have a length of 1 ms.

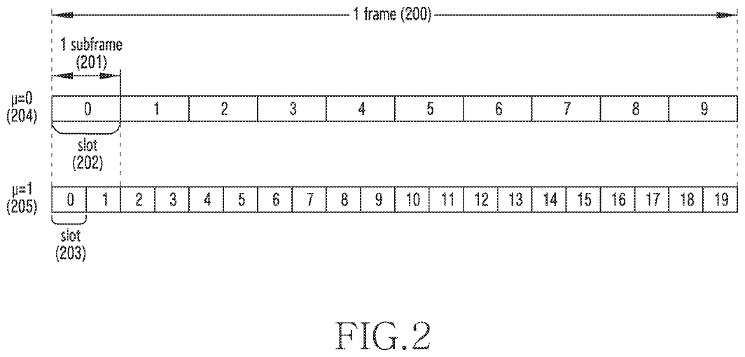

FIG. 2 illustrates frames, subframes, and slots in a wireless communication system according to an embodiment.

Referring to FIG. 2, a frame 200 may be defined as 10 ms. A subframe 201 may be defined as 1 ms. Therefore, the frame 200 may include a total of ten subframes 201.

One slot 202 or 203 may be defined as 14 OFDM symbols (i.e., the number of symbols per one slot N_{symb}^{slot}=14).

The subframe 201 may include one slot or multiple slots 202 and 203. The number of slots 202 and 203 per one subframe 201 may differ depending on configuration values u 204 and 205 regarding the SCS. For example, FIG. 2 illustrates a case in which the SCS configuration value is μ=0 (204), and a case in which μ=1 (205). In the case of μ=0 (204), one subframe 201 may include one slot 202. In the case of μ=1 (205), one subframe 201 may include two slots 203. That is, the number of slots per one subframe Nₛₗₒₜ^{subframe,μ} may differ depending on the SCS configuration value μ, and the number of slots per one frame Nₛₗₒₜ^{frame,μ} may differ accordingly. Nₛₗₒₜ^{subframe,μ} and Nₛₗₒₜ^{frame,μ} may be defined according to each SCS configuration u as in Table 1 below.

TABLE 1

| N_{symb}^{slot} | Nₛₗₒₜ^{frame, μ} | Nₛₗₒₜ^{subframe, μ} |
|---|---|---|
| 14 | 10 | 1 |
| 14 | 20 | 2 |
| 14 | 40 | 4 |
| 14 | 80 | 8 |
| 14 | 160 | 16 |
| 14 | 320 | 32 |

### BWP

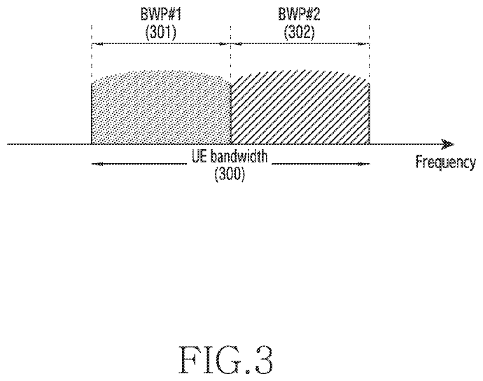

FIG. 3 illustrates a BWP configuration in a wireless communication system according to an embodiment.

Referring to FIG. 3, a UE bandwidth 300 is configured to include two BWPs, i.e., BWP #1 301 and BWP #2 302.

A BS may configure one or multiple BWPs for a UE, and may configure the following pieces of information with regard to each BWP given in Table 2 below.

TABLE 2

| | |
|---|---|
| BWP ::= | SEQUENCE { |
| bwp-Id | BWP-Id, |
| (bandwidth part identifier) | |
| locationAndBandwidth | INTEGER (1..65536), |
| (bandwidth part location) | |
| subcarrierSpacing | ENUMERATED {n0, n1, n2, n3, |
| n4, n5}, | |
| (subcarrier spacing) | |
| cyclicPrefix | ENUMERATED |
| { extended } | |
| (cyclic prefix) | |
| } | |

The example in Table 2 above is not limiting, and various parameters related to the BWP may be configured for the UE, in addition to the above configuration information in Table 2.

The above pieces of information may be transferred, from the stations, to the UE, through upper layer signaling, e.g., radio resource control (RRC) signaling.

One configured BWP or at least one BWP among multiple configured BWPs may be activated. Whether or not to activate a configured BWP may be semi-statically transferred, from the stations, to the UE, through RRC signaling, or dynamically transferred through DL control information (DCI).

According to an embodiment, a UE, prior to an RRC connection, may have an initial BWP for initial access configured by the BS through a master information block (MIB). To be more specific, the UE may receive configuration information regarding a CORESET and a search space which may be used to transmit a physical DL control channel (PDCCH) for receiving system information (SI), which may correspond to remaining SI (RMSI) or SI block 1 (SIB1), for initial access through the MIB in the initial access step. Each of the CORESET and the search space configured by the MIB may be considered as identity (ID) 0. The BS may notify the UE of configuration information regarding CORESET #0, such as frequency allocation information, time allocation information, and numerology, through the MIB. In addition, the BS may notify the UE of configuration information regarding the monitoring cycle and occasion regarding CORESET #0, i.e., configuration information regarding CORESET #0, through the MIB. The UE may consider that a frequency domain configured by CORESET #0 acquired from the MIB is an initial BWP for initial access. The ID of the initial BWP may be considered to be 0.

The BWP-related configuration supported by 5G may be used for various purposes.

If the bandwidth supported by the UE is smaller than the system bandwidth, this may be supported through the BWP configuration. For example, the BS may configure the frequency location (configuration information 2) of the BWP for the UE such that the UE can transmit/receive data at a specific frequency location within the system bandwidth.

In addition, the BS may configure multiple BWPs for the UE for the purpose of supporting different numerologies. For example, in order to support a UE's data transmission/reception using both an SCS of 15 kHz and an SCS of 30 kHz, two BWPs may be configured as SCSs of 15 kHz and 30 kHz, respectively. Different BWPs may be subjected to frequency division multiplexing, and when data is to be transmitted/received at a specific SCS, the BWP configured as the corresponding SCS may be activated.

In addition, the BS may configure BWPs having different sizes of bandwidths for the UE for the purpose of reducing power consumed by the UE. For example, if the UE supports a substantially large bandwidth (e.g., 100 MHz) and always transmits/receives data with the corresponding bandwidth, a substantially large amount of power consumption may occur.

Particularly, it may be substantially inefficient from the viewpoint of power consumption to unnecessarily monitor the DL control channel with a large bandwidth of 100 MHz in the absence of traffic. In order to reduce power consumed by the UE, the BS may configure a BWP of a relatively small bandwidth, for example, a BWP of 20 MHz, for the UE. The UE may perform a monitoring operation in the 20 MHz BWP in the absence of traffic, and may transmit/receive data with the 100 MHz BWP as instructed by the BS if data has occurred.

In connection with the BWP configuring method, UEs, before being RRC-connected, may receive configuration information regarding the initial BWP through an MIB in the initial access step. More specifically, a UE may have a CORESET configured for a DL control channel which may be used to transmit DCI for scheduling a SI block (SIB) from the MIB of a physical broadcast channel (PBCH). The bandwidth of the CORESET configured by the MIB may be considered as the initial BWP, and the UE may receive, through the configured initial BWP, a PDSCH through which an SIB is transmitted. The initial BWP may be used for the purpose of receiving the SIB, and also for other SI (OSI), paging, random access, etc.

### BWP Change

If a UE has one or more BWPs configured therefor, the BS may instruct to the UE to change (or switch) the BWPs by using a BWP indicator field inside DCI. For example, if the currently activated BWP of the UE is BWP #1 301 in FIG. 3, the BS may indicate BWP #2 302 with a BWP indicator inside DCI, and the UE may change the BWP to BWP #2 302 indicated by the BWP indicator inside received DCI.

As described above, DCI-based BWP changing may be indicated by DCI for scheduling a PDSCH or a PUSCH, and a UE, upon receiving a BWP change request, should be able to receive or transmit the PDSCH or PUSCH scheduled by the corresponding DCI in the changed BWP with no problem. To this end, requirements regarding a delay time, i.e., a time-bandwidth product (TBWP), required during a BWP change are specified in standards, and may be defined, e.g., as shown in Table 3.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}
Depends on UE capability.
Note 2:
If the BWP switch involves changing of SCS, the BWP switch delay is determined by the larger one between the SCS before BWP switch and the SCS after BWP switch.

The requirement regarding the BWP change delay time supports type 1 or type 2, depending on the capability of the UE. The UE may report the supportable BWP delay time type to the BS.

If the UE has received DCI including a BWP change indicator in slot n, according to the above-described requirement regarding the BWP change delay time, the UE may complete a change to the new BWP indicated by the BWP change indicator at a timepoint not later than slot n+TBWP, and may transmit/receive a data channel scheduled by the corresponding DCI in the newly changed BWP. If the BS wants to schedule a data channel by using the new BWP, the BS may determine time domain resource allocation regarding the data channel in view of the UE's BWP change delay time (i.e., TBWP). That is, when scheduling a data channel by using the new BWP, the BS may schedule the corresponding data channel after the BWP change delay time, in connection with the method for determining time domain resource allocation regarding the data channel. Accordingly, the UE may not expect that the DCI that indicates a BWP change will indicate a slot offset (K0 or K2) value smaller than the BWP change delay time (TBWP).

If the UE has received DCI (e.g., DCI format 1_1 or 0_1) indicating a BWP change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a BWP change in slot n, and if the slot offset value indicated by the corresponding DCI is K, the UE may perform no transmission or reception from the third symbol of slot n to the symbol before slot n+K (that is, the last symbol of slot n+K−1).

### PDCCH: Regarding DCI

In a 5G system, scheduling information regarding UL data (or PUSCH) or DL data (or PDSCH) is transferred from a BS to a UE through DCi. The UE may monitor, with regard to the PUSCH or PDSCH, a fallback DCI format and a non-fallback DCI format. The fallback DCI format may include a fixed field predefined between the BS and the UE, and the non-fallback DCI format may include a configurable field.

The DCI may be subjected to channel coding and modulation processes and then transmitted through a PDCCH. A cyclic redundancy check (CRC) is attached to the DCI message payload, and the CRC may be scrambled by a radio network temporary identifier (RNTI) corresponding to the ID of the UE. Different RNTIs may be used according to the purpose of the DCI message (e.g., UE-specific data transmission, power control command, random access response (RAR), etc.). That is, the RNTI is not explicitly transmitted, but is transmitted while being included in a CRC calculation process. Upon receiving a DCI message transmitted through the PDCCH, the UE may identify the CRC by using the allocated RNTI. If the CRC identification result is correct, the UE may know that the corresponding message has been transmitted to the UE.

For example, DCI for scheduling a PDSCH regarding SI may be scrambled by an SI-RNTI. DCI for scheduling a PDSCH regarding an RAR message may be scrambled by an random access (RA)-RNTI. DCI for scheduling a PDSCH regarding a paging message may be scrambled by a paging (P)-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell (C)-RNTI.

DCI format 0_0 may be used as fallback DCI for scheduling the PUSCH, and the CRC may be scrambled by a C-RNTI. DCI format 0_0 in which the CRC is scrambled by a C-RNTI may include, e.g., the following pieces of information given in Table 4.

TABLE 4
- Identifier for DCI formats - [1] bit
- Frequency domain resource assignment -[┌log₂(N_{RB}^{UL,BWP}(N_{RB}^{UL,BWP} +
1)/2)] ]bits
- Time domain resource assignment - X bits
- Frequency hopping flag - 1 bit.
- Modulation and coding scheme (MCS) - 5 bits
- New data indicator (NDI) - 1 bit
- Redundancy version (RV) - 2 bits
- HARQ process number - 4 bits
- TPC command for scheduled PUSCH - [2] bits
- UL/supplementary UL indicator (UL/SUL indicator) - 0 or 1 bit

DCI format 0_1 may be used as non-fallback DCI for scheduling the PUSCH, and the CRC may be scrambled by a C-RNTI. DCI format 0_1 in which the CRC is scrambled by a C-RNTI may include, e.g., the following pieces of information given in Table 5.

```
TABLE 5
  - Carrier indicator − 0 or 3 bits
  - UL/SUL indicator − 0 or 1 bit
  - Identifier for DCI formats − [1] bits
  - BWP indicator − 0, 1 or 2 bits
  - Frequency domain resource assignment
    • For resource allocation type 0, ┌N_{RB}^{UL,BWP}/P┐ bits
    • For resource allocation type 1, ┌log₂ (N_{RB}^{UL,BWP}(N_{RB}^{UL,BWP} +
      1)/2)┐ bits
  - Time domain resource assignment −1, 2, 3, or 4 bits
  - virtual RB-to-physical RB (VRB-to-PRB) mapping − 0 or 1 bit, only
for resource allocation type 1.
    • 0 bit if only resource allocation type 0 is configured;
    • 1 bit otherwise.
  - Frequency hopping flag − 0 or 1 bit, only for resource allocation type
    1.
    • 0 bit if only resource allocation type 0 is configured;
    • 1 bit otherwise.
  - MCS − 5 bits
  - NDI − 1 bit
  - RV − 2 bits
  - HARQ process number − 4 bits
  - 1st DL assignment index− 1 or 2 bits
    • 1 bit for semi-static HARQ-ACK codebook;
    • 2 bits for dynamic HARQ-ACK codebook with single HARQ-
      ACK codebook.
  - 2nd DL assignment index − 0 or 2 bits
    • 2 bits for dynamic HARQ-ACK codebook with two HARQ-
      ACK sub-codebooks;
    • 0 bit otherwise.
  - TPC command for scheduled PUSCH − 2 bits
  $‐ SRS resource indicator - ⌈ {log}_{2} ( {\sum }_{k = 1}^{{L}_{max} \sum } ( \begin{matrix}{N}_{SRS} \\ k\end{matrix} ) ) ⌉ or ⌈ {log}_{2} ( {N}_{SRS} ) ⌉$
bits
    $⌈ {log}_{2} ( {\sum }_{k = 1}^{{L}_{max} \sum } ( \begin{matrix}{N}_{SRS} \\ k\end{matrix} ) ) ⌉ bits for non - codebook based PUSCH$
      transmission;
    • ┌log₂(N_{SRS})┐ bits for codebook based PUSCH transmission.
  - Precoding information and number of layers-up to 6 bits
  - Antenna ports − up to 5 bits
  - SRS request − 2 bits
  - CSI request − 0, 1, 2, 3, 4, 5, or 6 bits
  - Code block group (CBG) transmission information − 0, 2, 4, 6, or 8
    bits
  - PTRS-DMRS association − 0 or 2 bits.
  - beta_offset indicator− 0 or 2 bits
  - DMRS sequence initialization− 0 or 1 bit
```

DCI format 1_0 may be used as fallback DCI for scheduling the PDSCH, and the CRC may be scrambled by a C-RNTI. DCI format 1_0 in which the CRC is scrambled by a C-RNTI may include, e.g., the following pieces of information given in Table 6.

TABLE 6

- Identifier for DCI formats - [1] bit
- Frequency domain resource assignment -
[┌log₂(N_{RB}^{DL,BWP}(N_{RB}^{DL,BWP} + 1)/2)┐ bits
- Time domain resource assignment - X bits
- VRB-to-PRB mapping - 1 bit.
- MCS - 5 bits
- NDI - 1 bit
- Redundancy version - 2 bits
- HARQ process number - 4 bits
- DL assignment index - 2 bits
- TPC command for scheduled physical UL control
channel (PUCCH) - [2] bits
- PUCCH resource indicator - 3 bits
- PDSCH-to-HARQ feedback timing indicator - [3] bits

DCI format 1_1 may be used as non-fallback DCI for scheduling the PDSCH, and the CRC may be scrambled by a C-RNTI. DCI format 1_1 in which the CRC is scrambled by a C-RNTI may include, e.g., the following pieces of information given in Table 7.

```
TABLE 7
- Carrier indicator - 0 or 3 bits
- Identifier for DCI formats - [1] bits
- BWP indicator - 0, 1 or 2 bits
- Frequency domain resource assignment
    • For resource allocation type 0, ┌N_{RB}^{DL,BWP}/P┐ bits
    • For resource allocation type 1, ┌log₂(N_{RB}^{DL,BWP}(N_{RB}^{DL,BWP} +
1)/2)┐ bits
- Time domain resource assignment -1, 2, 3, or 4 bits
- VRB-to-PRB mapping - 0 or 1 bit, only for resource allocation type
1.
    • 0 bit if only resource allocation type 0 is configured;
    • 1 bit otherwise.
- PRB bundling size indicator - 0 or 1 bit
- Rate matching indicator - 0, 1, or 2 bits
- Zero power (ZP) CSI-RS trigger - 0, 1, or 2 bits
For transport block 1:
  - MCS - 5 bits
  - NDI - 1 bit
  - RV - 2 bits
For transport block 2:
  - MCS - 5 bits
  - NDI - 1 bit
  - RV - 2 bits
- HARQ process number - 4 bits
- DL assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports - 4, 5, or 6 bits
- Transmission configuration indication- 0 or 3 bits
- SRS request - 2 bits
- CBG transmission information - 0, 2, 4, 6, or 8 bits
- CBG flushing out information - 0 or 1 bit
- DMRS sequence initialization - 1 bit
```

### PDCCH: CORESET, REG, CCE, Search Space

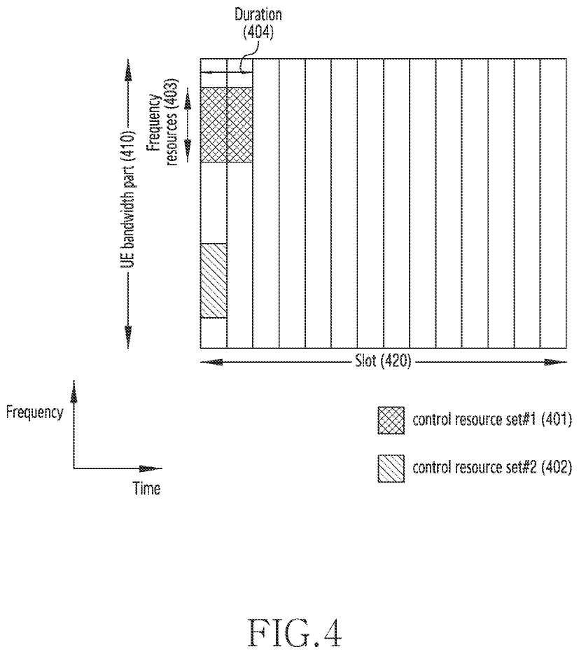

FIG. 4 illustrates a CORESET of a DL control channel in a wireless communication system according to an embodiment.

Referring to FIG. 4, a UE BWP 410 is configured along the frequency axis, and two CORESETs (CORESET #1 401 and CORESET #2 402) are configured within one slot 420 along the time axis. The CORESETs 401 and 402 may be configured in a specific frequency resource 403 within the entire UE BWP 410 along the frequency axis. One or multiple OFDM symbols may be configured along the time axis, and this may be defined as a CORESET duration 404.

In the example illustrated in FIG. 4, CORESET #1 401 is configured to have a CORESET duration corresponding to two symbols, and CORESET #2 402 is configured to have a CORESET duration corresponding to one symbol.

A CORESET may be configured for a UE by a BS through upper layer signaling (e.g., SI, MIB, RRC signaling). The description that a CORESET is configured for a UE includes that information such as a CORESET identity, the CORESET's frequency location, and the CORESET's symbol duration is provided. For example, the CORESET may include the following pieces of information given in Table 8.

TABLE 8

| | |
|---|---|
| ControlResourceSet ::= | SEQUENCE{ |
| -- Corresponds to L1 parameter ′CORESET-ID′ | |
| controlResourceSetId | |
| ControlResourceSetId, | |
| (control resource set identity)) | |
| frequencyDomainResources | BIT STRING |
| (SIZE (45)), | |

(frequency domain resource assignment information)

| | |
|---|---|
| duration | INTEGER |
| (1..maxCoReSetDuration), | |

(time domain resource assignment information)

| | |
|---|---|
| cce-REG-MappingType | CHOICE { |
| (CCE-to-REG mapping type) | |
| interleaved | SEQUENCE { |
| reg-BundleSize | ENUMERATED {n2, n3, n6}, |
| (REG bundle size) | |
| precoderGranularity ENUMERATED | {sameAsREG-bundle, |
| allContiguousRBs}, | |
| interleaverSize | ENUMERATED {n2, n3, n6} |
| (interleaver size) | |
| shiftIndex | |

INTEGER(0..maxNrofPhysicalResourceBlocks-1)

| | |
|---|---|
| OPTIONAL | |
| (interleaver shift) | |
| }, | |
| nonInterleaved | NULL |
| }, | |
| tci-StatesPDCCH | SEQUENCE(SIZE |
| (1..maxNrofTCI-StatesPDCCH)) OF TCI-StateId | OPTIONAL, |
| (QCL configuration information) | |
| tci-PresentInDCI | ENUMERATED |
| {enabled} | |
| | OPTIONAL, -- Need S |
| } | |

In Table 8, tci-StatesPDCCH (simply referred to as transmission configuration indication (TCI) state) configuration information may include information of one or multiple synchronization signals (SSs)/PBCH block index or channel state information reference signal (CSI-RS) index, which is quasi-co-located (QCL) with a DMRS transmitted in a corresponding CORESET.

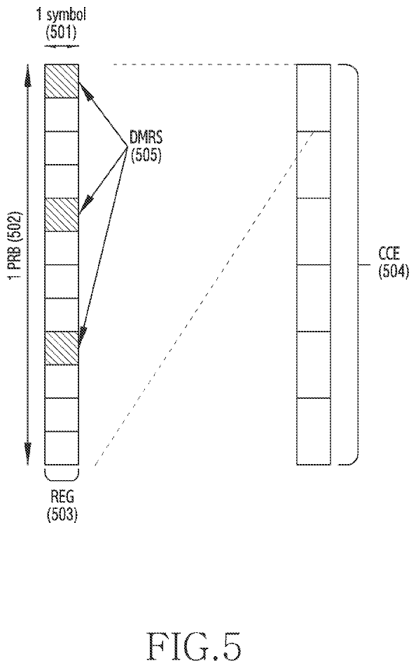

FIG. 5 illustrates a DL control channel in a wireless communication system according to an embodiment. More specifically, FIG. 5 illustrates basic units of time and frequency resources constituting a DL control channel available in 5G.

Referring to FIG. 5, a basic unit of time and frequency resources constituting a control channel may be referred to as an RE group (REG) 503, and the REG 503 may be defined by one OFDM symbol 501 along the time axis and one PRB 502 (i.e., 12 subcarriers) along the frequency axis. The BS may configure a DL control channel allocation unit by concatenating REGs 503.

Provided that the basic unit of DL control channel allocation in 5G is a control channel element (CCE) 504 as illustrated in FIG. 5A, one CCE 504 may include multiple REGs 503. For example, the REG 503 may include 12 REs, and if one CCE 504 includes six REGs 503, one CCE 504 may then include 72 REs. A DL CORESET, once configured, may include multiple CCEs 504, and a specific DL control channel may be mapped to one or multiple CCEs 504 and then transmitted according to the aggregation level (AL) in the CORESET. The CCEs 504 in the CORESET are distinguished by numbers, and the numbers of CCEs 504 may be allocated according to a logical mapping scheme.

The basic unit of the DL control channel illustrated in FIG. 5, i.e., the REG 503 may include both REs to which DCI is mapped, and an area to which a reference signal (i.e., DMRS 505) for decoding the same is mapped.

As in FIG. 5, three DMRSs 505 may be transmitted inside one REG 503. The number of CCEs for transmitting a PDCCH may be 1, 2, 4, 8, or 16 according to the AL, and different number of CCEs may be used to implement link adaption of the DL control channel. For example, in the case of AL=L, one DL control channel may be transmitted through L CCEs. The UE should detect a signal while being no information regarding the DL control channel, and a search space indicating a set of CCEs has thus been defined for blind decoding. The search space is a set of DL control channel candidates including CCEs that the UE should attempt to decode at a given AL. Since 1, 2, 4, 8, or 16 CCEs constitute a bundle at various ALs, the UE may have multiple search spaces. A search space set may be defined as a set of search spaces at all configured ALs.

Search spaces may be classified into common search spaces (CSSs) and UE-specific search spaces. A group of UEs or all UEs may investigate a CSS of the PDCCH in order to receive cell-common control information such as a paging message or dynamic scheduling regarding SI. For example, PDSCH scheduling allocation information for transmitting an SIB including a cell operator information or the like may be received by investigating the CSS of the PDCCH. In the case of a CSS, a group of UEs or all UEs should receive the PDCCH, and the same may thus be defined as a pre-promised set of CCEs. Scheduling allocation information regarding a UE-specific PDSCH or PUSCH may be received by investigating the UE-specific search space of the PDCCH. The UE-specific search space may be defined UE-specifically as a function of various system parameters and the UE's identity.

In a 5G system, a parameter regarding a search parameter regarding a PDCCH may be configured for the UE by the BS through upper layer signaling (e.g., SIB, MIB, or RRC signaling). For example, the BS may provide the UE with configurations such as the number of PDCCH candidates at each AL, the monitoring cycle regarding the search space, the monitoring occasion with regard to each symbol in a slot regarding the search space, the search space type (e.g., CSS or UE-specific search space), a combination of an RNTI and a DCI format to be monitored in the corresponding search space, a CORESET index for monitoring the search space, etc. For example, the parameter may include the following pieces of information in Table 9.

TABLE 9

| | |
|---|---|
| SearchSpace ::= | SEQUENCE { |

-- Identity of the search space. SearchSpaceId = 0 identifies the SearchSpace
configured via PBCH (MIB) or ServingCellConfigCommon.

| | |
|---|---|
| searchSpaceId | SearchSpaceId, |
| (search space identity) | |
| controlResourceSetId | ControlResourceSetId, |
| (control resource set identity) | |
| monitoringSlotPeriodicityAndOffset | CHOICE { |
| (monitoring slot level cycle) | |
| sl1 | NULL, |
| sl2 | INTEGER (0..1), |
| sl4 | |
| INTEGER (0..3), | |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |
| } | |
| | OPTIONAL, |
| duration(monitoring duration) | INTEGER (2..2559) |
| monitoringSymbolsWithinSlot | BIT STRING (SIZE (14)) |
| OPTIONAL, | |
| (monitoring symbols within slot) | |
| nrofCandidates | SEQUENCE { |

(number of PDCCH candidates per aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8}, |
| }, | |
| searchSpaceType | CHOICE { |
| (search space type) | |

-- Configures this search space as common search space (CSS) and DCI

| | |
|---|---|
| formats to monitor. | |
| common | SEQUENCE { |
| (common search space) | |
| } | |
| ue-Specific | SEQUENCE { |
| (UE-specific search space) | |

```
          -- Indicates whether the UE monitors in this USS for DCI formats 0-0 and
1-0 or for formats 0-1 and 1-1.
          formats ENUMERATED {formats0-0-And-1-0,
```

formats0-1-And-1-1},
...
}

According to configuration information, the BS may configure one or multiple search space sets for the UE. The BS may configure search space set 1 and search space set 2 for the UE, may configure DCI format A scrambled by an X-RNTI to be monitored in a CSS in search space set 1, and may configure DCI format B scrambled by a Y-RNTI to be monitored in a UE-specific search space in search space set 2.

According to configuration information, one or multiple search space sets may exist in a CSS or a UE-specific search space. For example, search space set #1 and search space set #2 may be configured as a CSS, and search space set #3 and search space set #4 may be configured as a UE-specific search space.

Combinations of DCI formats and RNTIs given below may be monitored in a CSS. The example given below is not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. The example given below is not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

Enumerated RNTIs may follow the definition and usage given below. The example given below is not limiting.
C-RNTI: used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
RA-RNTI: used to schedule a PDSCH in a random access step
P-RNTI: used to schedule a PDSCH in which paging is transmitted
SI-RNTI: used to schedule a PDSCH in which SI is transmitted
Interruption RNTI (INT-RNTI): used to indicate whether a PDSCH is punctured
TPC for PUSCH RNTI (TPC-PUSCH-RNTI): used to indicate a power control command regarding a PUSCH
TPC for PUCCH RNTI (TPC-PUCCH-RNTI): used to indicate a power control command regarding a PUCCH
TPC for SRS RNTI (TPC-SRS-RNTI): used to indicate a power control command regarding an SRS

The DCI formats enumerated above may follow the definitions in Table 10.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands for |
| | SRS transmissions by one or more UEs |

In 5G, the search space at AL-L in connection with CORESET p and search space set s may be expressed by Equation (1) below:

$$L \cdot \{ ( {Y}_{p , {n}_{s , f}^{u}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad ( 1 )$$

L: aggregation level
n_{CI}: carrier index
N_{CEE,p}: total number of CCEs existing in CORESET p
n_{s,f}^{μ}: slot index
M_{s,max}^{(L)}: number of PDCCH candidates at aggregation level L
m_{s,n}_{_{CI}}=0, . . . , M_{s,max}^{(L)}−1: PDCCH candidate index at aggregation level L
i=0, . . . , L−1

$${Y}_{p , {n}_{s , f}^{u}} = ( {A}_{p} \cdot {Y}_{p , {n}_{s , f}^{u} - 1} ) mod D ,$$

Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

The

$${Y}_{p , {n}_{s , f}^{u}}$$

value may correspond to u in the case of a CSS.

The

$${Y}_{p , {n}_{s , f}^{u}}$$

value changed by the UE's identity (C-RNTI or ID configured for the UE by the BS) and the time index in the case of a UE-specific search space.

Multiple search space sets may be configured by different parameters (e.g., the parameters in Table 9), and the group of search space sets monitored by the UE at each timepoint may differ. For example, if search space set #1 is configured at by X-slot cycle, if search space set #2 is configured at by Y-slot cycle, and if X and Y are different, the UE may monitor search space set #1 and search space set #2 both in a specific slot, and may monitor one of search space set #1 and search space set #2 both in another specific slot.

### PDSCH/PUSCH: Regarding Time Resource Allocation

Hereinafter, a time domain resource allocation method regarding a data channel in a next-generation mobile communication system (e.g., a 5G or NR system) will be described.

A BS may configure table regarding time domain resource allocation information regarding a PDSCH and a PUSCH for a UE through upper layer signaling (e.g., RRC signaling). A table including a maximum of maxNrofDL-Allocations=16 entries may be configured for the PDSCH, and a table including a maximum of maxNrofUL-Allocations=16 entries may be configured for the PUSCH. The time domain resource allocation information may include PDCCH-to-PDSCH slot timing (corresponding to a slot-unit time interval between a timepoint at which a PDCCH is received and a timepoint at which a PDSCH scheduled by the received PDCCH is transmitted; labeled K0), PDCCH-to-PUSCH slot timing (corresponding to a slot-unit time interval between a timepoint at which a PDCCH is received and a timepoint at which a PUSCH scheduled by the received PDCCH is transmitted; labeled K2), information regarding the location and length of the start symbol by which a PDSCH or PUSCH is scheduled inside a slot, the mapping type of a PDSCH or PUSCH, etc. For example, information such as in Table 11 or Table 12 below may be transmitted from the BS to the UE. However, the information is not limited thereto.

TABLE 11
PDSCH-TimeDomainResourceAllocationList information element

```
  PDSCH-TimeDomainResourceAllocationList ::= SEQUENCE
(SIZE(1..maxNrofDL-Allocations)) OF PDSCH-
TimeDomainResourceAllocation
  PDSCH-TimeDomainResourceAllocation::=  SEQUENCE {
```

| | |
|---|---|
| k0 | |
| INTEGER(0..32) | |
| OPTIONAL, -- Need S | |
| mappingType | |
| ENUMERATED {typeA, typeB}, | |
| startSymbolAndLength | INTEGER |
| (0..127) | |
| } | |

-- TAG-PDSCH-TIMEDOMAINRESOURCEALLOCATIONLIST-

STOP
-- ASN1STOP

TABLE 12
PUSCH-TimeDomainResourceAllocationList information element

```
  PUSCH-TimeDomainResourceAllocation ::= SEQUENCE
(SIZE(1..maxNrofUL-AllocationList ::= PUSCH-
TimeDomainResourceAllocation
  PUSCH-TimeDomainResourceAllocation ::= SEQUENCE {
    k2
```

| | |
|---|---|
| INTEGER(0..32) | OPTIONAL, -- Need S |
| mappingType | |

ENUMERATED {typeA, typeB},

| | |
|---|---|
| startSymbolAndLength | INTEGER |
| (0..127) | |
| } | |

```
  -- TAG-PUSCH-TIMEDOMAINRESOURCEALLOCATIONLIST-
STOP
  -ASN1STOP
```

The BS may notify the UE of one of the entries of the table regarding time domain resource allocation information described above through layer 1 (L1) signaling (e.g., DCI) (e.g., “time domain resource allocation” field inside DCI may indicate the same). The UE may acquire time domain resource allocation information regarding a PDSCH or PUSCH, based on the DCI acquired from the BS.

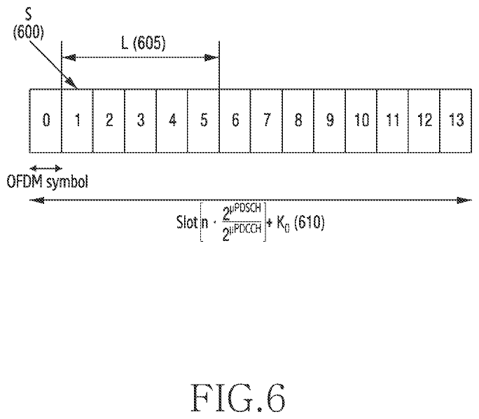

FIG. 6 illustrates time domain resource allocation with regard to a PDSCH in a wireless communication system according to an embodiment.

Referring to FIG. 6, the UE may indicate the time domain location of a PDSCH resource according to the SCS (μPDSCH, μPDCCH) of a data channel and a control channel configured by using an upper layer, the scheduling offset (K0) value, and the start location 600 and length 605 of an OFDM symbol inside one slot dynamically indicated through DCI.

### PUSCH: Regarding Transmission Scheme

PUSCH transmission may be dynamically scheduled by a UL grant inside DCI, or operated by means of configured grant Type 1 or Type 2. Dynamic scheduling indication regarding PUSCH transmission can be made by DCI format 0_0 or 0_1.

Configured grant Type 1 PUSCH transmission may be configured semi-statically by receiving configuredGrantConfig including rrc-ConfiguredUplinkGrant in Table 13 through upper signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 14 through upper signaling. If PUSCH transmission is operated by a configured grant, parameters applied to the PUSCH transmission are applied through configuredGrantConfig (upper signaling) in Table 13, except for dataScramblingIdentityPUSCH, txConfig, codebookSubset, maxRank, and scaling of UCI-OnPUSCH, which are provided by pusch-Config in Table 14, which is upper signaling. If provided with transformPrecoder inside configuredGrantConfig (upper signaling) in Table 13, the UE applies tp-pi2BPSK inside pusch-Config in Table 14 to PUSCH transmission operated by a configured grant.

TABLE 13

| | |
|---|---|
| ConfiguredGrantConfig ::= | SEQUENCE { |
| frequencyHopping | ENUMERATED {intraSlot, |
| interSlot} | OPTIONAL, -- |
| Need S, | |
| cg-DMRS-Configuration | DMRS-UplinkConfig, |
| mcs-Table | ENUMERATED {qam256, |
| qam64LowSE} | OPTIONAL, |
| -- Need S | |
| mcs-TableTransformPrecoder | ENUMERATED {qam256, |
| qam64LowSE} | OPTIONAL, |
| -- Need S | |
| uci-OnPUSCH | SetupRelease { CG-UCI- |
| OnPUSCH } | OPTIONAL, |
| -- Need M | |
| resourceAllocation | ENUMERATED |

{ resourceAllocationType0, resourceAllocationType1, dynamicSwitch },

| | |
|---|---|
| rbg-Size | ENUMERATED {config2} |
| OPTIONAL, -- Need S | |
| powerControlLoopToUse | ENUMERATED {n0, n1}, |
| p0-PUSCH-Alpha | P0-PUSCH-AlphaSetId, |
| transformPrecoder | ENUMERATED {enabled, |
| disabled } | OPTIONAL, |
| -- Need S | |
| nrofHARQ-Processes | INTEGER(1..16), |
| repK | ENUMERATED {n1, n2, n4, |
| n8}, | |
| repK-RV | ENUMERATED {s1-0231, s2- |
| 0303, s3-0000} | OPTIONAL, -- |
| Need R | |
| periodicity | ENUMERATED { |
| | sym2, sym7, |

sym1x14, sym2x14, sym4x14, sym5x14, sym8x14, sym10x14, sym16x14,

| | |
|---|---|
| sym20x14, | |
| | sym32x14, |

sym40x14, sym64x14, sym80x14, sym128x14, sym160x14, sym256x14,

| | |
|---|---|
| sym320x14, sym512x14, | |
| | sym640x14, |

sym1024x14, sym1280x14, sym2560x14, sym5120x14,

sym6, sym1x12,

sym2x12, sym4x12, sym5x12, sym8x12, sym10x12, sym16x12, sym20x12,

| | |
|---|---|
| sym32x12, | |
| | sym40x12, |

sym64x12, sym80x12, sym128x12, sym160x12, sym256x12, sym320x12,

| | |
|---|---|
| sym512x12, sym640x12, | |
| | sym1280x12, |
| sym2560x12 | |
| }, | |
| configuredGrantTimer | INTEGER (1..64) |
| OPTIONAL, -- Need R | |
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING |
| (SIZE(18)), | |
| antennaPort | INTEGER (0..31), |
| dmrs-SeqInitialization | INTEGER (0..1) |
| OPTIONAL, -- Need R | |
| precodingAndNumberOfLayers | INTEGER (0..63), |
| srs-ResourceIndicator | INTEGER (0..15) |
| OPTIONAL, -- Need R | |
| mcsAndTBS | INTEGER (0..31), |
| frequencyHoppiingOffset | INTEGER (1.. |
| maxNrofPhysicalResourceBlocks-1) | OPTIONAL, - |
| - Need R | |
| pathlossReferenceIndex | INTEGER |

(0..maxNrofPUSCH-PathlossReferenceRSs-1),

```
        ...
    }
  OPTIONAL, -- Need R
    ...
  }
```

A DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 14, which is upper signaling, is “codebook” or “nonCodebook”.

PUSCH transmission may be dynamically scheduled through DCI format 0_0 or 0_1, and may be semi-statically configured by a configured grant. Upon receiving indication of scheduling regarding PUSCH transmission through DCI format 0_0, the UE perform beam configuration for PUSCH transmission by using pucch-spatialRelationInfoID corresponding to a UE-specific PUCCH resource corresponding to the minimum ID inside an activated UL BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 14, the UE does not expect scheduling through DCI format 0_1.

TABLE 14

| | |
|---|---|
| PUSCH-Config ::= | SEQUENCE { |
| dataScramblingIdentityPUSCH | INTEGER (0..1023) |
| OPTIONAL, -- Need S | |
| txConfig | ENUMERATED |
| {codebook, nonCodebook} | |
| OPTIONAL, -- Need S | |
| dmrs-UplinkForPUSCH-MappingTypeA | SetupRelease { DMRS- |
| UplinkConfig } | OPTIONAL, -- |
| Need M | |
| dmrs-UplinkForPUSCH-MappingTypeB | SetupRelease { DMRS- |
| UplinkConfig } | OPTIONAL, -- |
| Need M | |
| pusch-PowerControl | PUSCH-PowerControl |
| OPTIONAL, -- Need M | |
| frequencyHopping | ENUMERATED {intraSlot, |
| interSlot} | OPTIONAL, --Need |
| S | |
| frequencyHoppingOffsetLists | SEQUENCE (SIZE (1..4)) |

OF INTEGER (1.. maxNrofPhysicalResourceBlocks-1)

| | |
|---|---|
| OPTIONAL, -- Need M | |
| resourceAllocation | ENUMERATED |

{ resourceAllocationType0, resourceAllocationType1, dynamicSwitch},

| | |
|---|---|
| pusch-TimeDomainAllocationList | SetupRelease { PUSCH- |
| TimeDomainResourceAllocationList } | OPTIONAL, -- |
| Need M | |
| pusch-AggregationFactor | ENUMERATED { n2, n4, |
| n8 } | OPTIONAL, -- |
| Need S | |
| mcs-Table | ENUMERATED {qam256, |
| qam64LowSE} | OPTIONAL, |
| -- Need S | |
| mcs-TableTransformPrecoder | ENUMERATED {qam256, |
| qam64LowSE} | OPTIONAL, |
| -- Need S | |
| transformPrecoder | ENUMERATED {enabled, |
| disabled} | OPTIONAL, -- |
| Need S | |
| codebookSubset | ENUMERATED |

{fullyAndPartialAndNonCoherent, partialAndNonCoherent,nonCoherent}

| | |
|---|---|
| OPTIONAL, -- Cond codebookBased | |
| maxRank | INTEGER (1..4) |
| OPTIONAL, -- Cond codebookBased | |
| rbg-Size | ENUMERATED |
| { config2} | OPTIONAL, -- Need |
| S | |
| uci-OnPUSCH | SetupRelease { UCI- |
| OnPUSCH} | OPTIONAL, -- Need M |
| tp-pi2BPSK | ENUMERATED |
| {enabled} | OPTIONAL, -- |
| Need S | |
| ... | |
| } | |

A codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determine a precoder for PUSCH transmission, based on an SRS resource indicator (SRI), a transmission precoding matrix indicator (TPMI), and a transmission rank (i.e., the number of PUSCH transmission layers).

The SRI may be given through the SRI field inside DCI or configured through srs-ResourceIndicator (upper signaling). During codebook-based PUSCH transmission, the UE has at least one SRS resource configured therefor, and may have a maximum of two SRS resources configured therefor. If the UE is provided with an SRI through DCI, the SRS resource indicated by the SRI refers to the SRS resource corresponding to the SRI among SRS resources transmitted prior to the PDCCH including the SRI. In addition, the TPMI and the transmission rank may be given through “precoding information and number of layers” (a field inside DCI) or configured through precodingAndNumberOfLayers (upper signaling). The TPMI is used to indicate a precoder applied to PUSCH transmission. If one SRS resource is configured for the UE, the TPMI is used to indicate a precoder to be applied in the configured SRS resource. If multiple SRS resources are configured for the UE, the TPMI is used to indicate a precoder to be applied in an SRS resource indicated through the SRI.

The precoder to be used for PUSCH transmission is selected from a UL codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “noncoherent”, based on UE capability reported by the UE to the BS. If the UE reported “partialAndNonCoherent” as UE capability, the UE does not expect that the value of codebookSubset (upper signaling) will be configured as “fully AndPartialAndNonCoherent”. In addition, if the UE reported “nonCoherent” as UE capability, UE does not expect that the value of codebookSubset (upper signaling) will be configured as “fully AndPartialAndNonCoherent” or “partialAndNonCoherent”. If nrofSRS-Ports inside SRS-ResourceSet (upper signaling) indicates two SRS antenna ports, UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical with regard to all SRS resources.

The UE transmit, to the BS, one or multiple SRS resources included in the SRS resource set wherein the value of usage is configured as “codebook” according to upper signaling, and the BS selects one from the SRS resources transmitted by the UE and instructs the UE to transmit a PUSCH by using transmission beam information of the corresponding SRS resource. In connection with the codebook-based PUSCH transmission, the SRI is used as information for selecting the index of one SRS resource, and is included in DCI. Additionally, the BS adds information indicating the rank and TPMI to be used by the UE for PUSCH transmission to the DCI. By using the SRS resource indicated by the SRI, the UE applies the precoder indicated by the rank and TPMI indicated based on the transmission beam of the corresponding SRS resource, thereby performing PUSCH transmission.

A non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected non-zero power (NZP) CSI-RS resource may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is positioned in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (upper signaling) will be configured together.

If multiple SRS resources are configured for the UE, the UE may determine a precoder to be applied to PUSCH transmission and the transmission rank, based on an SRI indicated by the BS. The SRI may be indicated through the SRI field inside DCI or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the BS by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources can be configured for non-codebook-based PUSCH transmission.

The BS transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the BS, one or multiple SRS resources inside the SRS resource set wherein the configured usage is “nonCodebook”, and the BS selects one or multiple SRS resources from the received one or multiple SRS resources.

In connection with the non-codebook-based PUSCH transmission, the SRI indicates an index that may express one SRS resource or a combination of multiple SRS resources, and the SRI is included in DCI. The number of SRS resources indicated by the SRI transmitted by the BS may be the number of transmission layers of the PUSCH, and the UE transmits the PUSCH by applying the precoder applied to SRS resource transmission to each layer.

### PUSCH: Preparation Procedure Time

If a BS schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in view thereof. The PUSCH preparation procedure time of the UE may follow Equation (2) below.

$$Tproc , \text{} 2 = max ( \text{} ( N 2 + d 2 , 1 + d 2 ) ( 2048 + 144 ) κ 2 - μ Tc + Text + Tswitch , d 2 , 2 ) \qquad ( 2 )$$

Each parameter in Tproc,2 described above in Equation (2) may have the following meaning:
N2: the number of symbols determined according to UE processing capability 1 or 2, based on the UE's capability, and numerology μ. May have a value in Table if UE processing capability 1 is reported according to the UE's capability report, and may have a value in Table 16 if UE processing capability 2 is reported, and if availability of UE processing capability 2 is configured through upper layer signaling.

TABLE 15

| | PUSCH preparation time N₂ |
|---|---|
| μ | [symbols] |
| 0 | 10 |
| 1 | 12 |
| 2 | 23 |
| 3 | 36 |

TABLE 16

| | PUSCH preparation time N₂ |
|---|---|
| μ | [symbols] |
| 0 | 5 |
| 1 | 5.5 |
| 2 | 11 for frequency range 1 |

d2,1: the number of symbols determined to be 0 if all REs of the first OFDM symbol of PUSCH transmission include DM-RSs, and to b1 otherwise.
κ: 64
μ: follows a value, among μ_{DL} and μ_{UL}, which makes Tproc,2 larger. μ_{DL} refers to the numerology of a DL used to transmit a PDCCH including DCI that schedules a PUSCH, and Luz refers to the numerology of a UL used to transmit a PUSCH.
Tc: has 1/(Δfₘₐₓ·N_{f}), Δfₘₐₓ=480·10³ Hz, N_{f}=4096
d2,2: follows a BWP switching time if DCI that schedules a PUSCH indicates BWP switching, and has 0 otherwise.
d2: if OFDM symbols overlap temporally between a PUSCH having a high priority index and a PUCCH having a low priority index, the d2 value of the PUSCH having a high priority index is used. Otherwise, d2 is 0.
Text: if the UE uses a shared spectrum channel access scheme, the UE may calculate Text and apply the same to a PUSCH preparation procedure time. Otherwise, Text is assumed to be 0.
Tswitch: if a UL switching spacing has been triggered, Tswitch is assumed to be the switching spacing time. Otherwise, Tswitch is assumed to be 0.

The BS and the UE determine that the PUSCH preparation procedure time is insufficient if the first symbol of a PUSCH starts earlier than the first UL symbol in which a cyclic prefix (CP) starts after Tproc,2 from the last symbol of a PDCCH including DCI that schedules the PUSCH, in view of the influence of timing advance between the UL and the DL and time domain resource mapping information of the PUSCH scheduled through the DCI. Otherwise, the BS and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### PUSCH: Regarding Repeated Transmission

A 5G system supports two types of methods for repeatedly transmitting a UL data channel; PUSCH repeated transmission type A and PUSCH repeated transmission type B. One of PUSCH repeated transmission type A and type B may be configured for a UE through upper layer signaling.

### 1. PUSCH Repeated Transmission Type A

As described above, the symbol length of a UL data channel and the location of the start symbol may be determined by a time domain resource allocation method in one slot, and a BS may notify a UE of the number of repeated transmissions through upper layer signaling (e.g., RRC signaling) or L1 signaling (e.g., DCI).
Based on the number of repeated transmissions received from the BS, the UE repeatedly transmit a UL data channel having the same length and start symbol as the configured UL data channel, in a continuous slot. If the BS configured a slot as a DL for the UE, or if at least one of symbols of the UL data channel configured for the UE is configured as a DL, the UE omits UL data channel transmission, but counts the number of repeated transmissions of the UL data channel.

### 2. PUSCH Repeated Transmission Type B

As described above, the start symbol and length of a UL data channel may be determined by a time domain resource allocation method in one slot, and the BS may notify the UE of the number of repeated transmissions (numberofrepetitions) through upper layer signaling (e.g., RRC signaling) or L1 signaling (e.g., DCI).
The nominal repetition of the UL data channel is determined as follows, based on the previously configured start symbol and length of the UL data channel. The slot in which the nth nominal repetition starts is given by

$${K}_{s} + ⌊ \frac{S + n \cdot L}{{N}_{symb}^{slot}} ⌋ ,$$

and the symbol starting in that slot is given by mod (S+n·L,N_{symb}^{slot}). The slot in which the nth nominal repetition ends is given by

$${K}_{s} + ⌊ \frac{S + ( n + 1 ) \cdot L - 1}{{N}_{symb}^{slot}} ⌋ ,$$

and the symbol ending in that slot is given by mod (S+ (n+1)·L−1, Nₛₗₒₜ^{symb}). In this regard, n=0, . . . , numberofrepetitions−1, S refers to the start symbol of the configured UL data channel, and L refers to the symbol length of the configured UL data channel. Kₛ refers to the slot in which PUSCH transmission starts, and N_{symb}^{slot} refers to the number of symbols per slot.
The UE determines an invalid symbol for PUSCH repeated transmission type B. A symbol configured as a DL by tdd-UL-DL-ConfigurationCommon or tdd-UL-DL-ConfigurationDedicated is determined as the invalid symbol for PUSCH repeated transmission type B. Additionally, the invalid symbol may be configured in an upper layer parameter (e.g., InvalidSymbolPattern). The upper layer parameter (e.g., InvalidSymbolPattern) may provide a symbol level bitmap across one or two slots, thereby configuring the invalid symbol. In the bitmap, 1 represents the invalid symbol. Additionally, the cycle and pattern of the bitmap may be configured through the upper layer parameter (e.g., InvalidSymbolPattern). If an upper layer parameter (e.g., InvalidSymbolPattern) is configured, and if parameter InvalidSymbolPatternIndicator-ForDCIFormat0_1 or InvalidSymbolPatternIndicator-ForDCIFormat0_2 indicates 1, the UE applies an invalid symbol pattern, and if the above parameter indicates 0, the UE does not apply the invalid symbol pattern. If an upper layer parameter (e.g., InvalidSymbolPattern) is configured, and if parameter InvalidSymbolPatternIndicator-ForDCIFormat0_1 or InvalidSymbolPatternIndicator-ForDCIFormat0_2 is not configured, the UE applies the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repeated transmission type B in one slot.

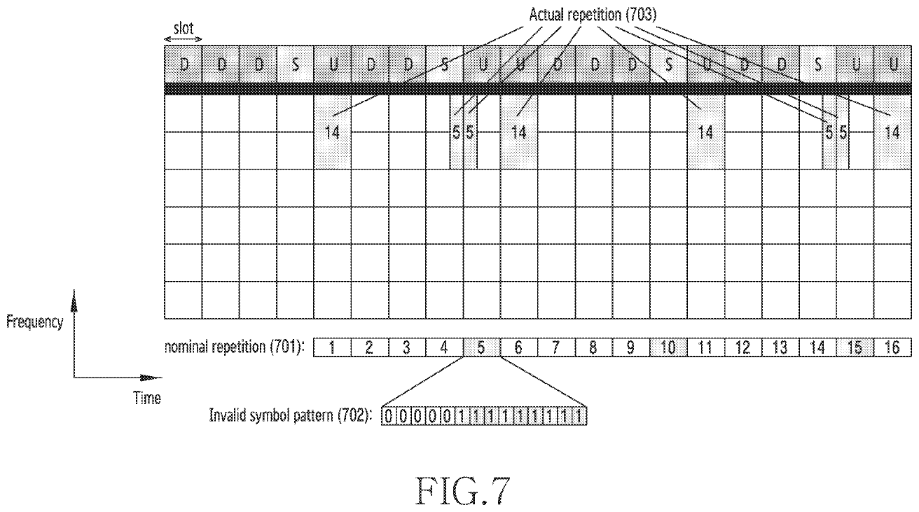

FIG. 7 illustrates PUSCH repeated transmission type B in a wireless communication system according to an embodiment.

Referring to FIG. 7, a UE may receive the following configurations: the start symbol S of a UL data channel is 0, the length L of the UL data channel is 14, and the number of repeated transmissions is 16. In this case, nominal repetitions appear in 16 consecutive slots (701). Thereafter, the UE may determine that the symbol configured as a DL symbol in each nominal repetition 701 is an invalid symbol. In addition, the UE determines that symbols configured as 1 in the invalid symbol pattern 702 are invalid symbols. If valid symbols other than invalid symbols in respective nominal repetitions constitute one or more consecutive symbols in one slot, they are configured and transmitted as actual repetitions (703).

In addition, with regard to PUSCH repeated transmission, additional methods may be defined in NR Release 16 with regard to UL grant-based PUSCH transmission and configured grant-based PUSCH transmission, across slot boundaries, as follows:
Method 1 (mini-slot level repetition): through one UL grant, two or more PUSCH repeated transmissions are scheduled inside one slot or across the boundary of consecutive slots. In addition, in connection with method 1, time domain resource allocation information inside DCI indicates resources of the first repeated transmission. In addition, time domain resource information of remaining repeated transmissions may be determined according to time domain resource information of the first repeated transmission, and the UL or DL direction determined with regard to each symbol of each slot. Each repeated transmission occupies consecutive symbols.
Method 2 (multi-segment transmission): through one UL grant, two or more PUSCH repeated transmissions are scheduled in consecutive slots. Transmission no. 1 is designated with regard to each slot, and the start point or repetition length may domain differ between respective transmission. In addition, in method 2, time resource allocation information inside DCI indicates the start point and repetition length of all repeated transmissions. In addition, when performing repeated transmissions inside a single slot through method 2, if there are multiple bundles of consecutive UL symbols in the corresponding slot, respective repeated transmissions are performed with regard to respective UL symbol bundles. If there is a single bundle of consecutive UL symbols in the corresponding slot, PUSCH repeated transmission is performed once according to the method of NR Release 15.
Method 3: two or more PUSCH repeated transmissions are scheduled in consecutive slots through two or more UL grants. Transmission no. 1 is designated with regard to each slot, and the nth UL grant may be received before PUSCH transmission scheduled by the (n−1) th UL grant is over.
Method 4: through one UL grant or one configured grant, one or multiple PUSCH repeated transmissions inside a single slot, or two or more PUSCH repeated transmissions across the boundary of consecutive slots may be supported. The number of repetitions indicated to the UE by the BS is only a nominal value, and the UE may actually perform a larger number of PUSCH repeated transmissions than the nominal number of repetitions. Time domain resource allocation information inside DCI or configured grant indicates resources of the first repeated transmission indicated by the BS. Time domain resource information of remaining repeated transmissions may be determined with reference to resource information of the first repeated transmission and the UL or DL direction of symbols. If time domain resource information of a repeated transmission indicated by the BS spans a slot boundary or includes a UL/DL switching point, the corresponding repeated transmission may be divided into multiple repeated transmissions. One repeated transmission may be included in one slot with regard to each UL period.

### PUSCH: Frequency Hopping Process

5G supports two kinds of PUSCH frequency hopping methods with regard to each PUSCH repeated transmission type. In PUSCH repeated transmission type A, intra-slot frequency hopping and inter-slot frequency hopping are supported, and in PUSCH repeated transmission type B, inter-repetition frequency hopping and inter-slot frequency hopping are supported.

The inter-slot frequency hopping method supported in PUSCH repeated transmission type A is a method in which a UE transmits allocated resources in the frequency domain, after changing the same by a configured frequency offset, by two hops in one slot. The start RB of each hop in connection with intra-slot frequency hopping may be expressed by Equation (3) as shown below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad ( 3 )$$

In Equation (3), i=0 and i=1 indicate the first and second hops, respectively, and RBstart represents the start RB in a UL BWP and is calculated from a frequency resource allocation method. RBoffset indicates a frequency offset between two hops through an upper layer parameter. The number of symbols of the first hop may be └N_{symb}^{PUSCH,s}/2┘, and number of symbols of the second hop may be N_{symb}^{PUSCH,s}−└N_{symb}^{PUSCH,s}/2┘. N_{symb}^{PUSCH,s} represents the number of OFDM symbols, which corresponds to the length of PUSCH transmission in one slot.

Next, according to the inter-slot frequency hopping method supported in PUSCH repeated transmission types A and B, the UE transmits allocated resources in the frequency domain, after changing the same by a configured frequency offset, in each slot. The start RB duringnₛ^{μ} slots in connection with inter-slot frequency hopping may be expressed by Equation (4) as shown below.

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad ( 4 )$$

In Equation (4), nₛ^{μ} refers to the current slot number during multi-slot PUSCH transmission, and RBₛₜₐᵣₜ refers to the start RB inside a UL BWP and is calculated from a frequency resource allocation method. RB_{offset} refers to a frequency offset between two hops through an upper layer parameter.

Next, according to the inter-repetition frequency hopping method supported in PUSCH repeated transmission type B, resources allocated in the frequency domain regarding one or multiple actual repetitions in each nominal repetition are moved by a configured frequency offset and then transmitted. The index RBstart (n) of the start RB in the frequency domain regarding one or multiple actual repetitions in the nth nominal repetition may follow Equation (5) below.

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad ( 5 )$$

In Equation (5), n refers to the index of nominal repetition, and RB_{offset} refers to an RB offset between two hops through an upper layer parameter.

### PUSCH: Related to Transmission Power

In a 5G system, a transmission power of a UL data channel may be determined through Equation (6) as follows.

$${P}_{PUSCH , b , f , c} ( i , j , {q}_{d} , l ) = min \{ \begin{matrix}{P}_{CMAX , f , c} ( i ) , \\ {P}_{{0}_{PUSCH} , b , f , c} ( j ) + 10 {log}_{10} ( {2}^{μ} \cdot {M}_{RB , b , f , c}^{PUSCH} ( i ) ) + {α}_{b , f , c} ( j ) \cdot {PL}_{b , f , c} ( {q}_{d} ) + \\ {Δ}_{TF , b , f , c} ( i ) + {f}_{b , f , c} ( i , l )\end{matrix} \} [ dBm ] \qquad ( 6 )$$

In Equation (6), j denotes the grant type of a PUSCH. Specifically, j=0 indicates a PUSCH grant for an RAR, j=1 indicates a configured grant, and j∈{2, 3, . . . . . . . J−1} indicates a dynamic grant. P_{CMAX,f,c} (i) denotes a maximum output power configured for a terminal at a carrier f of a supported cell c for PUSCH transmission occasion i. P_{0_PUSCH,b,f,c} (j) is a parameter configured by the sum of P_{0_NOMINAL_PUSCH,f,c} (j) configured as a higher layer parameter and P_{0_UE_PUSCH,b,f,c} (j), which may be determined through a higher layer configuration and an SRI (in a case of a dynamic grant PUSCH). M_{RB,b,f,c}^{PUSCH} (i) denotes a bandwidth for resource allocation represented by the number of RBs for PUSCH transmission occasion i, and Δ_{TF,b,f,c} (i) denotes a value determined according to a MCS and the type (e.g., whether UL-SCH is included or CSI is included) of information transmitted through a PUSCH. α_{b,f,c} (j) is a value for compensating for path loss and indicates a value that may be determined through a higher layer configuration and an SRI (in a case of a dynamic grant PUSCH). PL_{b,f,c} (qd) denotes a DL path loss estimation estimated by a terminal through a reference signal having a reference signal index of q_{d}, and the reference signal index q_{d} may be determined by a terminal through a higher layer configuration and an SRI (in a case of a dynamic grant PUSCH or a configured grant PUSCH (type 2 configured grant PUSCH) based on ConfiguredGrantConfig not including the higher layer configuration rrc-ConfiguredUplinkGrant) or through a higher layer configuration. f_{b,f,c} (i,l) is a closed loop power control value and may be supported in an accumulation scheme and an absolute scheme. If the higher layer parameter tpc-Accumulation is not configured for a terminal, a closed loop power control value may be determined in the accumulation scheme. f_{b,f,c} (i,l) may be determined by f_{b,f,c}(i−i₀,l)+Σₘ₌₀^{c(D}^{ᵢₛ}⁻¹⁾δ_{PUSCH,b,f,c} (m,l) that indicates a sum of a closed loop power control value of the previous PUSCH transmission occasion i−i0 and TPC command values for closed loop index l received through DCI, between a symbol before KPUSCH (i−i0)−1 symbols before transmission of PUSCH transmission occasion i−i0 and a symbol before KPUSCH (i) symbols before transmission of PUSCH transmission occasion i. If the higher layer parameter tpc-Accumulation is configured for a terminal, f_{b,f,c} (i,l) may be determined as δ_{PUSCH,b,f,c} (i,l) that indicates a TPC command value for closed loop index l received through DCI. Closed loop index 1 may be configured to be 0 or 1 if the higher layer parameter twoPUSCH-PC-AdjustmentStates is configured for a terminal, and the value thereof may be determined through a higher layer configuration and an SRI (in a case of a dynamic grant PUSCH).

The mapping relation between a TPC command field in DCI and a TPC value δ_{PUSCH,b,f,c} according to the accumulation scheme and the absolute scheme may be defined as shown in Table 17 below.

TABLE 17

| | Accumulate | Absoluted |
|---|---|---|
| TPC command field | δ_{PUSCH, b, f, c}[dB] | δ_{PUSCH, b, f, c}[dB] |
| 0 | −1 | −4 |
| 1 | 0 | −1 |
| 2 | 1 | 1 |
| 3 | 3 | 4 |

### PUSCH: Related to TPMI

If a 1-layer transmission using a single PUSCH antenna port is scheduled for a terminal by a BS through DCI or higher layer signaling, a TPMI may be defined as W=1. Otherwise, i.e., if a 1 or more-layer PUSCH using multiple PUSCH antenna ports is scheduled for a terminal by a BS through DCI or higher layer signaling, W that is a TPMI may be defined through Tables 18 to 24 as shown below.

TABLE 18

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

Table 18 shows a 1-layer TPMI when a terminal has two PUSCH antenna ports. In Table 18, if the terminal has a non-coherent antenna structure and has reported a terminal capability corresponding thereto to a BS, the BS may select one of TPMI indexes 0 and 1 and indicate same to the terminal, and if the terminal has a full-coherent antenna structure and has reported a terminal capability corresponding thereto to the BS, the BS may select one of TPMI indexes 0 to 5 and indicate same to the terminal.

TABLE 19

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ i\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - i\end{matrix} ]$ |
| 16-23 | $\frac{1}{2} [ \begin{matrix}1 \\ j \\ 1 \\ i\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - i\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - i\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ i\end{matrix} ]$ |
| 24-27 | $\frac{1}{2} [ \begin{matrix}1 \\ - j \\ 1 \\ - i\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ i\end{matrix} ]$ | $\frac{1}{2} [ \begin{matrix}1 \\ - j \\ - j \\ 1\end{matrix} ]$ | — | — | — | — |

Table 19 shows a 1-layer TPMI when a terminal has four PUSCH antenna ports and transform precoding is used (i.e., a discrete Fourier transform spread (DFTS)-OFDM waveform is used). In Table 19, if the terminal has a non-coherent antenna structure and has reported a terminal capability corresponding thereto to a BS, the BS may select one of TPMI indexes 0 to 3 and indicate same to the terminal, if the terminal has a partial-coherent antenna structure and has reported a terminal capability corresponding thereto to the BS, the BS may select one of TPMI indexes 0 to 11 and indicate same to the terminal, and if the terminal has a full-coherent antenna structure and has reported a terminal capability corresponding thereto to the BS, the BS may select one of TPMI indexes 0 to 27 and indicate same to the terminal.

TABLE 20

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ i\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - i\end{matrix} ]$ |
| 16-23 | $\frac{1}{2} [ \begin{matrix}1 \\ j \\ 1 \\ i\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - i\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - i\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ i\end{matrix} ]$ |
| 24-27 | $\frac{1}{2} [ \begin{matrix}1 \\ - j \\ 1 \\ - i\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ i\end{matrix} ]$ | $\frac{1}{2} [ \begin{matrix}1 \\ - j \\ - j \\ - 1\end{matrix} ]$ | — | — | — | — |

Table 20 shows a 1-layer TPMI when a terminal has four PUSCH antenna ports and transform precoding is not used (i.e., a CP-OFDM waveform is used). In Table 20, if the terminal has a non-coherent antenna structure and has reported a terminal capability corresponding thereto to a BS, the BS may select one of TPMI indexes 0 to 3 and indicate same to the terminal, if the terminal has a partial-coherent antenna structure and has reported a terminal capability corresponding thereto to the BS, the BS may select one of TPMI indexes 0 to 11 and indicate same to the terminal, and if the terminal has a full-coherent antenna structure and has reported a terminal capability corresponding thereto to the BS, the BS may select one of TPMI indexes 0 to 27 and indicate same to the terminal.

TABLE 21

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

Table 21 shows a 2-layer TPMI when a terminal has two PUSCH antenna ports and transform precoding is not used (i.e., a CP-OFDM waveform is used). In Table 21, if the terminal has a non-coherent antenna structure and has reported a terminal capability corresponding thereto to a BS, the BS may select and indicate TPMI index 0 to the terminal, and if the terminal has a full-coherent antenna structure and has reported a terminal capability corresponding thereto to the BS, the BS may select one of TPMI indexes 0 to 2 and indicate same to the terminal.

TABLE 22

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ i & - i\end{matrix} ]$ |
| 16-19 | $\frac{1}{2 \sqrt{2}} [ \begin{matrix}1 & 1 \\ j & j \\ 1 & - 1 \\ i & - i\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - i & i\end{matrix} ]$ |
| 20-21 | $\frac{1}{2 \sqrt{2}} [ \begin{matrix}1 & 1 \\ - j & - j \\ 1 & - 1 \\ - i & i\end{matrix} ]$ | $\frac{1}{2 \sqrt{2}} [ \begin{matrix}1 & 1 \\ - j & - j \\ j & - j \\ 1 & - 1\end{matrix} ]$ | — | — |

Table 22 shows a 2-layer TPMI when a terminal has four PUSCH antenna ports and transform precoding is not used (i.e., a CP-OFDM waveform is used). In Table 22, if the terminal has a non-coherent antenna structure and has reported a terminal capability corresponding thereto to a BS, the BS may select one of TPMI indexes 0 to and indicate same to the terminal. If the terminal has a partial-coherent antenna structure and has reported a terminal capability corresponding thereto to the BS, the BS may select one of TPMI indexes 0 to 13 and indicate same to the terminal. If the terminal has a full-coherent antenna structure and has reported a terminal capability corresponding thereto to the BS, the BS may select one of TPMI indexes 0 to 21 and indicate same to the terminal.

TABLE 23

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 \\ 1 & - 1 \\ 1 & 1 \\ 1 & - 1\end{matrix} \text{?}$ |
| 4-6 | $\frac{1}{2 \sqrt{3}} [ \begin{matrix}1 & 1 & 1 \\ 1 & - 1 & 1 \\ j & j & - \\ i & - i & -\end{matrix} \text{?}$ | $\frac{1}{2 \sqrt{3}} [ \begin{matrix}1 & 1 & 1 \\ 1 & - 1 & 1 \\ j & j & - \\ i & - i & -\end{matrix} \text{?}$ | $\frac{1}{2 \sqrt{3}} [ \begin{matrix}1 & 1 & 1 \\ - 1 & 1 & - 1 \\ j & j & - j \\ - i & i & i\end{matrix} \text{?}$ | — |

$\text{?} \text{indicates text missing or illegible when filed}$

Table 23 shows a 3-layer TPMI when a terminal has four PUSCH antenna ports and transform precoding is not used (i.e., a CP-OFDM waveform is used). In Table 23, if the terminal has a non-coherent antenna structure and has reported a terminal capability corresponding thereto to a BS, the BS may select and indicate TPMI index 0 to the terminal. If the terminal has a partial-coherent antenna structure and has reported a terminal capability corresponding thereto to the BS, the BS may select one of TPMI indexes 0 to 2 and indicate same to the terminal. If the terminal has a full-coherent antenna structure and has reported a terminal capability corresponding thereto to the BS, the BS may select one of TPMI indexes 0 to 6 and indicate same to the terminal.

TABLE 24

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 \\ 0 & 0 & 1 \\ 1 & - 1 & 0 \\ 0 & 0 & 1\end{matrix} \text{?}$ | $\frac{1}{2 \sqrt{2}} [ \begin{matrix}1 & 1 & 0 \\ 0 & 0 & 1 \\ j & - j & 0 \\ 0 & 0 & i\end{matrix} \text{?}$ | $\frac{1}{4} [ \begin{matrix}1 & 1 & 1 \\ 1 & - 1 & 1 \\ 1 & 1 & - 1 \\ 1 & - 1 & - 1\end{matrix} \text{?}$ |
| 4 | $\frac{1}{4} [ \begin{matrix}1 & 1 & 1 \\ 1 & - 1 & 1 \\ j & j & - j \\ i & - i & - i\end{matrix} \text{?}$ | — | — | — |

$\text{?} \text{indicates text missing or illegible when filed}$

Table 24 shows a TPMI which is 4-layer when a terminal has four PUSCH antenna ports and transform precoding is not used (i.e., a CP-OFDM waveform is used). In Table 24, if the terminal has a non-coherent antenna structure and has reported a terminal capability corresponding thereto to a BS, the BS may select and indicate TPMI index 0 to the terminal. If the terminal has a partial-coherent antenna structure and has reported a terminal capability corresponding thereto to the BS, the BS may select one of TPMI indexes 0 to 2 and indicate same to the terminal. If the terminal has a full-coherent antenna structure and has reported a terminal capability corresponding thereto to the BS, the BS may select one of TPMI indexes 0 to 4 and indicate same to the terminal.

### Related to UL PTRS

The higher layer parameter phaseTrackingRS for a PTRS may be configured for a terminal on the higher layer parameter DMRS-UplinkConfig. When the terminal transmits a PUSCH to a BS, the terminal may transmit a PTRS for phase tracking for an UL channel. A procedure of transmitting a UL PTRS by the terminal may be determined according to whether transform precoding is performed at the time of PUSCH transmission. In a case where transform precoding is performed and a transformPrecoderEnabled area is configured in the higher layer parameter PTRS-UplinkConfig, sampleDensity in the transformPrecoderEnabled area may indicate a sample density threshold represented by NRB0 to NRB4 in the following table. In a case where transform precoding is performed and a transformPrecoderEnabled area is configured in the higher layer parameter PTRS-UplinkConfig, the terminal may determine a PT-RS group pattern for a scheduled resource NRB according to Table 25. If a transform precoder is additionally applied to PUSCH transmission, the number of bits of a PTRS-DMRS association area for indicating the association between a PTRS and a DMRS in DCI format 0_1 or 0_2 may be 0.

TABLE 25

| | | Number of |
|---|---|---|
| | Number of | samples per |
| Scheduled bandwidth | PT-RS groups | PT-RS group |
| N_{RB0} ≤ N_{RB} < N_{RB1} | 2 | 2 |
| N_{RB1} ≤ N_{RB} < N_{RB2} | 2 | 4 |
| N_{RB2} ≤ N_{RB} < N_{RB3} | 4 | 2 |
| N_{RB3} ≤ N_{RB} < N_{RB4} | 4 | 4 |
| N_{RB4} ≤ N_{RB} | 8 | 4 |

In a case where transform precoding is not applied to PUSCH transmission and the higher layer parameter phaseTrackingRS is configured, the terminal may identify that frequencyDensity in a transformPrecoderDisabled area in the higher layer parameter PTRS-UplinkConfig indicates NRB0 to NRB1 and timeDensity indicates ptrs-MCS1 to ptrs-MCS3. The terminal may determine a PT-RS density of a time domain (LPT-RS) and a PT-RS density (KPT-RS) of a frequency domain, as shown in Tables 26 and 27 according to an MCS (IMCS) and an RB (NRB) of a scheduled PUSCH. In Table 26, ptrs-MCS4 is not specified by a higher layer parameter, but the BS and the terminal may know that ptrs-MCS4 is 29 or 28 according to a configured MCS table.

TABLE 26

| Scheduled MCS | Time Density (L_{PT-RS}) |
|---|---|
| I_{MCS} < ptrs-MCS₁ | PT-RS is not present |
| ptrs-MCS₁ ≤ I_{MCS} < ptrs-MCS₂ | 4 |
| ptrs-MCS₂ ≤ I_{MCS} < ptrs-MCS₃ | 2 |
| ptrs-MCS₃ ≤ I_{MCS} < ptrs-MCS₄ | 1 |

TABLE 27

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

In a case where a transform precoder is not applied to a PUSCH transmission and PTRS-UplinkConfig is configured, the BS may indicate, to the terminal, a “PTRS-DMRS association” area of 2 bits to indicate a PTRS-DMRS association in DCI format 0_1 or 0_2. The indicated PTRS-DMRS association area of 2 bits may be applied to Table 28 or 29 below according to a maximum number of ports of a PTRS configured by maxNrofPorts in the higher layer parameter PTRS-UplinkConfig. If the maximum number of PTRS ports is 1, the terminal may determine a PTRS-DMRS association through Table 28 and 2 bits indicated as the PTRS-DMRS association area, and transmit a PTRS according to the determined association. If the maximum number of PTRS ports is 2, the terminal may determine a PTRS-DMRS association through Table 29 and 2 bits indicated as the PTRS-DMRS association area, and transmit a PTRS according to the determined association.

TABLE 28

| Value | DMRS port |
|---|---|
| 0 | 1^{st} scheduled DMRS port |
| 1 | 2^{nd} scheduled DMRS port |
| 2 | 3^{rd} scheduled DMRS port |
| 3 | 4^{th} scheduled DMRS port |

TABLE 29

| Value of | | Value of | |
|---|---|---|---|
| MSB | DMRS port | LSB | DMRS port |
| 0 | 1^{st} DMRS port which | 0 | 1^{st} DMRS port which |
| | shares PTRS port 0 | | shares PTRS port 1 |
| 1 | 2^{nd} DMRS port which | 1 | 2^{nd} DMRS port which |
| | shares PTRS port 0 | | shares PTRS port 1 |

A DMRS port as shown in Tables 28 and 29 may be determined through a table determined by a higher layer parameter configuration and an “antenna ports” area indicated by the same DCI as DCI indicating a PTRS-DMRS association. In a case where a transform precoder is not configured by a higher configuration of a PUSCH, dmrs-Type and maxLength are configured to be 1 and 2 for a DMRS, respectively, and the rank of the PUSCH is 2, the terminal may determine a DMRS port through a bit indicated as an antenna ports area and a table for “antenna port(s)” as shown in Table 30. In a case where a noncodebook-based PUSCH is supported, the terminal may determine a rank value by referring to an SRI area indicated by the same DCI as DCI including an “antenna ports” area (i.e., if there is no SRI area, the rank may be considered as 1). In a case where a codebook-based PUSCH is supported, the terminal may determine a rank value by referring to a TPMI area indicated by the same DCI as DCI including an “antenna ports” area.

Table 30 is an example of an antenna port table referred at the time of PUSCH configuration described above, and if a PUSCH is configured by a different parameter, a DMRS port may be determined according to an antenna port table corresponding to the configuration and the bits of an antenna ports area indicated by DCI.

TABLE 30

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

The 1st scheduled DMRS to 4th scheduled DMRS in Table 28 may be defined as values obtained by sequentially mapping DMRS ports indicated by the bits of an antenna ports area of DCI and an antenna port table corresponding to a higher layer configuration. For example, if the bits of an antenna ports area of DCI is 0001 and a DMRS port is determined referring to Table 30, scheduled DMRS ports may be 0 and 1, DMRS port 0 may be defined as the 1st scheduled DMRS, and DMRS port 1 may be the 2nd scheduled DMRS. A DMRS port determined by the bits of another antenna ports area and an antenna port table corresponding to another higher layer configuration may also be similarly applied. The terminal may determine one DMRS port to be associated with a PTRS port by referring to a bit indicated as a PTRS-DMRS association in DCI among DMRS ports defined as described above, and transmit a

PTRS according to the determined DMRS port.

In Table 29, a DMRS port sharing PTRS port 0 and a DMRS port sharing PTRS port 1 may be defined according to codebook-based PUSCH transmission or non-codebook-based PUSCH transmission.

If the terminal transmits a PUSCH, based on a partial-coherent or non-coherent codebook, a UL layer transmitted through PUSCH antenna ports 1000 and 1002 is associated with PTRS port 0, and a UL layer transmitted through PUSCH antenna ports 1001 and 1003 is associated with PTRS port 1. More specifically, if layer-3: TPMI=2 is selected for codebook-based PUSCH transmission, the first layer is associated with PTRS port 0 because the first layer is transmitted through PUSCH antenna ports 1000 and 1002, and the second layer and the third layer are associated with PTRS port 1 because the second layer is transmitted through PUSCH antenna port 1001 and the third layer is transmitted through PUSCH antenna port 1003. The three layers indicate DMRS ports, respectively, a DMRS port for the first layer corresponds to “1st DMRS port which shares PTRS port 0” in Table 29, a DMRS port for the second layer corresponds to “1st DMRS port which shares PTRS port 1” in Table 29, and a DMRS port for the third layer corresponds to “2nd DMRS port which shares PTRS port 1” in Table 29. Similarly, a DMRS port associated with PTRS port 0 and a DMRS port associated with PTRS port 1 may be determined according to a different number of layers and a different TPMI. If the terminal transmits a PUSCH, based on a non-codebook, a DMRS port associated with PTRS port 0 and a DMRS port associated with PTRS port 1 may be distinguished according to antenna ports and an SRI indicated by DCI.

More specifically, an SRS resource included in an SRS resource set having “nonCodebook” as usage may be configured as whether the SRS resource is associated with PTRS port 0 or PTRS port 1, through the higher layer parameter ptrs-PortIndex. The BS may indicate SRS resources for transmitting a non-codebook-based PUSCH, by using an SRI. Ports of the indicated SRS resources may be mapped to PUSCH DMRS ports in one-to-one correspondence, respectively. An association between a PUSCH DMRS port and a PTRS port may be determined according to ptrs-PortIndex that is a higher layer parameter of an SRS resource mapped to the DMRS port. More specifically, it is assumed that n0, n0, n1, and n1 have been configured as ptrs-PortIndex for SRS resources 1 to 4 included in an SRS resource set having nonCodebook as usage. In addition, it is assumed that a PUSCH has been indicated through an SRI to be transmitted through SRS resources 1, 2, and 4, and DMRS ports 0, 1, and 2 have been indicated as an antenna ports area. The ports of SRS resources 1, 2, and 4 may be mapped to DMRS ports 0, 1, and 2, respectively. DMRS ports 0 and 1 are associated with PTRS port 0 and DMRS port 2 is associated with PTRS port 1 according to ptrs-PortIndex in an SRS resource. Therefore, in Table 29, DMRS port 0 corresponds to “1st DMRS port which shares PTRS port 0”, DMRS port 1 corresponds to “2nd DMRS port which shares PTRS port 0”, and DMRS port 2 may correspond to “1st DMRS port which shares PTRS port 1”. Similarly, a DMRS port associated with PTRS port 0 and a DMRS port associated with PTRS port 1 may be determined according to a different pattern of method of configuring ptrs-PortIndex in an SRS resource and a different SRI value. The terminal may determine, for two PTRS ports, an association between a DMRS port and a PTRS port as described above. Thereafter, the terminal may determine a DMRS port, among multiple DMRS ports associated with each PTRS port, to be associated with PTRS port 0 by referring to a most significant bit (MSB) of a PTRS-DMRS association and determine a DMRS port to be associated with PTRS port 1 by referring to a least significant bit (LSB), to transmit a PTRS.

### Pusch Dmrs

An antenna port field in DCI formats 0_1 and 1_2 may be expressed by 3, 4, or bits, and may be indicated through Tables 31 to 46 below.

Table 31 indicates an antenna port field indication when a transform precoder is disabled, dmrs-Type is equal to 1, maxLength is equal to 1, and rank is equal to 1.

TABLE 31

| | Number of DMRS | |
|---|---|---|
| | CDM group(s) | DMRS |
| Value | without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

Table 32 indicates an antenna port field indication when a transform precoder is disabled, dmrs-Type is equal to 1, maxLength is equal to 1, and rank is equal to 2.

TABLE 32

| | Number of DMRS | |
|---|---|---|
| | CDM group(s) | DMRS |
| Value | without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

Table 33 indicates an antenna port field indication when a transform precoder is disabled, dmrs-Type is equal to 1, maxLength is equal to 1, and rank is equal to 3.

TABLE 33

| | Number of DMRS | |
|---|---|---|
| | CDM group(s) | DMRS |
| Value | without data | port(s) |
| 0 | 2 | 0-2 |
| 1-7 | Reserved | Reserved |

Table 34 indicates an antenna port field indication when a transform precoder is disabled, dmrs-Type is equal to 1, maxLength is equal to 1, and rank is equal to 4.

TABLE 34

| | Number of DMRS | |
|---|---|---|
| | CDM group(s) | DMRS |
| Value | without data | port(s) |
| 0 | 2 | 0-3 |
| 1-7 | Reserved | Reserved |

Table 35 indicates an antenna port field indication when a transform precoder is disabled, dmrs-Type is equal to 1, maxLength is equal to 2, and rank is equal to 1.

TABLE 35

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

Table 36 indicates an antenna port field indication when a transform precoder is disabled, dmrs-Type is equal to 1, maxLength is equal to 2, and rank is equal to 2.

TABLE 36

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

Table 37 indicates an antenna port field indication when a transform precoder is disabled, dmrs-Type is equal to 1, maxLength is equal to 2, and rank is equal to 3.

TABLE 37

| | Number of DMRS | | Number of |
|---|---|---|---|
| | CDM group(s) | DMRS | front-load |
| Value | without data | port(s) | symbols |
| 0 | 2 | 0-2 | 1 |
| 1 | 2 | 0, 1, 4 | 2 |
| 2 | 2 | 2, 3, 6 | 2 |
| 3-15 | Reserved | Reserved | Reserved |

Table 38 indicates an antenna port field indication when a transform precoder is disabled, dmrs-Type is equal to 1, maxLength is equal to 2, and rank is equal to 4.

TABLE 38

| | Number of DMRS | | Number of |
|---|---|---|---|
| | CDM group(s) | DMRS | front-load |
| Value | without data | port(s) | symbols |
| 0 | 2 | 0-3 | 1 |
| 1 | 2 | 0, 1, 4, 5 | 2 |
| 2 | 2 | 2, 3, 6, 7 | 2 |
| 3 | 2 | 0, 2, 4, 6 | 2 |
| 4-15 | Reserved | Reserved | Reserved |

Table 39 indicates an antenna port field indication when a transform precoder is disabled, dmrs-Type is equal to 2, maxLength is equal to 1, and rank is equal to 1.

TABLE 39

| | Number of DMRS | |
|---|---|---|
| | CDM group(s) | DMRS |
| Value | without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12-15 | Reserved | Reserved |

Table 40 indicates an antenna port field indication when a transform precoder is disabled, dmrs-Type is equal to 2, maxLength is equal to 1, and rank is equal to 2.

TABLE 40

| | Number of DMRS | |
|---|---|---|
| | CDM group(s) | DMRS |
| Value | without data | port(s) |
| 0 | 1 | 0, 1 |
| 1 | 2 | 0, 1 |
| 2 | 2 | 2, 3 |
| 3 | 3 | 0, 1 |
| 4 | 3 | 2, 3 |
| 5 | 3 | 4, 5 |
| 6 | 2 | 0, 2 |
| 7-15 | Reserved | Reserved |

Table 41 indicates an antenna port field indication when a transform precoder is disabled, dmrs-Type is equal to 2, maxLength is equal to 1, and rank is equal to 3.

TABLE 41

| | Number of DMRS | |
|---|---|---|
| | CDM group(s) | DMRS |
| Value | without data | port(s) |
| 0 | 2 | 0-2 |
| 1 | 3 | 0-2 |
| 2 | 3 | 3-5 |
| 3-15 | Reserved | Reserved |

Table 42 indicates an antenna port field indication when a transform precoder is disabled, dmrs-Type is equal to 2, maxLength is equal to 1, and rank is equal to 4.

TABLE 42

| | Number of DMRS CDM | DMRS |
|---|---|---|
| Value | group(s) without data | port(s) |
| 0 | 2 | 0-3 |
| 1 | 3 | 0-3 |
| 2-15 | Reserved | Reserved |

Table 43 indicates an antenna port field indication when a transform precoder is disabled, dmrs-Type is equal to 2, maxLength is equal to 2, and rank is equal to 1.

TABLE 43

| | Number of DMRS CDM | DMRS | Number of |
|---|---|---|---|
| Value | group(s) without data | port(s) | front-load symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 3 | 0 | 1 |
| 7 | 3 | 1 | 1 |
| 8 | 3 | 2 | 1 |
| 9 | 3 | 3 | 1 |
| 10 | 3 | 4 | 1 |
| 11 | 3 | 5 | 1 |
| 12 | 3 | 0 | 2 |
| 13 | 3 | 1 | 2 |
| 14 | 3 | 2 | 2 |
| 15 | 3 | 3 | 2 |
| 16 | 3 | 4 | 2 |
| 17 | 3 | 5 | 2 |
| 18 | 3 | 6 | 2 |
| 19 | 3 | 7 | 2 |
| 20 | 3 | 8 | 2 |
| 21 | 3 | 9 | 2 |
| 22 | 3 | 10 | 2 |
| 23 | 3 | 11 | 2 |
| 24 | 1 | 0 | 2 |
| 25 | 1 | 1 | 2 |
| 26 | 1 | 6 | 2 |
| 27 | 1 | 7 | 2 |
| 28-31 | Reserved | Reserved | Reserved |

Table 44 indicates an antenna port field indication when a transform precoder is disabled, dmrs-Type is equal to 2, maxLength is equal to 2, and rank is equal to 2.

TABLE 44

| | Number of DMRS CDM | DMRS | Number of |
|---|---|---|---|
| Value | group(s) without data | port(s) | front-load symbols |
| 0 | 1 | 0, 1 | 1 |
| 1 | 2 | 0, 1 | 1 |
| 2 | 2 | 2, 3 | 1 |
| 3 | 3 | 0, 1 | 1 |
| 4 | 3 | 2, 3 | 1 |
| 5 | 3 | 4, 5 | 1 |
| 6 | 2 | 0, 2 | 1 |
| 7 | 3 | 0, 1 | 2 |
| 8 | 3 | 2, 3 | 2 |
| 9 | 3 | 4, 5 | 2 |
| 10 | 3 | 6, 7 | 2 |
| 11 | 3 | 8, 9 | 2 |
| 12 | 3 | 10, 11 | 2 |
| 13 | 1 | 0, 1 | 2 |
| 14 | 1 | 6, 7 | 2 |
| 15 | 2 | 0, 1 | 2 |
| 16 | 2 | 2, 3 | 2 |
| 17 | 2 | 6, 7 | 2 |
| 18 | 2 | 8, 9 | 2 |
| 19-31 | Reserved | Reserved | Reserved |

Table 45 indicates an antenna port field indication when a transform precoder is disabled, dmrs-Type is equal to 2, maxLength is equal to 2, and rank is equal to 3.

TABLE 45

| | Number of DMRS CDM | DMRS | Number of |
|---|---|---|---|
| Value | group(s) without data | port(s) | front-load symbols |
| 0 | 2 | 0-2 | 1 |
| 1 | 3 | 0-2 | 1 |
| 2 | 3 | 3-5 | 1 |
| 3 | 3 | 0, 1, 6 | 2 |
| 4 | 3 | 2, 3, 8 | 2 |
| 5 | 3 | 4, 5, 10 | 2 |
| 6-31 | Reserved | Reserved | Reserved |

Table 46 indicates an antenna port field indication when a transform precoder is disabled, dmrs-Type is equal to 2, maxLength is equal to 2, and rank is equal to 4.

TABLE 46

| | Number of DMRS CDM | DMRS | Number of |
|---|---|---|---|
| Value | group(s) without data | port(s) | front-load symbols |
| 0 | 2 | 0-3 | 1 |
| 1 | 3 | 0-3 | 1 |
| 2 | 3 | 0, 1, 6, 7 | 2 |
| 3 | 3 | 2, 3, 8, 9 | 2 |
| 4 | 3 | 4, 5, 10, 11 | 2 |
| 5-31 | Reserved | Reserved | Reserved |

In summary, Tables 31 to 34 may be used when dmrs-type is indicated to be 1 and maxLength is indicated to be 1, Tables 35 to 38 may be used when dmrs-type=1 and maxLength=2 are indicated, Tables 39 to 42 show DMRS ports used when dmrs-type is equal to 2 and maxLength is equal to 1, and Tables 43 to 46 show DMRS ports used when dmrs-type is equal to 2 and maxLength is equal to 2.

With respect to DCI format 0_1, if the higher layer signaling dmrs-UplinkForPUSCH-MappingTypeA and dmrs-UplinkForPUSCH-MappingTypeB are both configured for the terminal, a bit length of an antenna port field in DCI format 0_1 may be determined to be max {xA, xB}, xA and xB may indicate bit lengths of the antenna port field determined through dmrs-UplinkForPUSCH-MappingTypeA and dmrs-UplinkForPUSCH-MappingTypeB, respectively. If a PUSCH mapping type corresponding to the smaller value among xA and xB is scheduled, each of as many MSB bits as |xA−xB| may be allocated 0 bits and then transmitted.

With respect to DCI format 0_2, if the higher layer signaling antennaPortsFieldPresenceDCI-0-2 is not configured for the terminal, there may be no antenna port field in DCI format 0_2. That is, in this case, the length of an antenna port field is 0 bits, and the terminal may determine a DMRS port by assuming the 0-th entry in Tables 31 to 46. If the higher layer signaling antennaPortsFieldPresenceDCI-0-2 is configured for the terminal, the bit length of an antenna port field in DCI format 0_2 may be determined similarly to the above case of DCI format 0_1. If the higher layer signaling dmrs-UplinkForPUSCH-MappingTypeA-DCI-0-2 and dmrs-UplinkForPUSCH-MappingTypeB-DCI-0-2 are both configured for the terminal, the bit length of an antenna port field in DCI format 0_2 may be determined to be max {xA, xB}, and xA and xB may indicate bit lengths of the antenna port field determined through dmrs-UplinkForPUSCH-Mapping TypeA-DCI-0-2 and dmrs-UplinkForPUSCH-MappingTypeB-DCI-0-2, respectively. If a PDSCH mapping type corresponding to the smaller value among xA and xB is scheduled, each of as many MSB bits as |xA−xB| may be allocated 0 bits and then transmitted.

The numbers 1, 2, and 3 indicated by number of DMRS code division multiplexing (CDM) group(s) without data in Tables 31 to 46 indicates CDM groups {0}, {0, 1}, and {0, 1, 2}, respectively. DMRS port(s) shows indexes of used ports in sequence. An antenna port may be indicated by DMRS port+1000. A CDM group of a DMRS is connected to an antenna port and a method of generating a DMRS sequence as shown in Tables 47 and 48.

Table 47 shows parameters of a case of using dmrs-type=1, and Table 48 shows parameters of a case of using dmrs-type=2.

TABLE 47

| | | |
|---|---|---|
| CDM | w_{f}(k′) | wₜ(l′) |

| \tilde{p} | group | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| d2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 48

| | | |
|---|---|---|
| CDM | w_{f}(k′) | wₜ(l′) |

| \tilde{p} | group | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

A DMRS sequence according to each parameter may be determined using Equation (7) below.

In Equation (7), \tilde{p} denotes a DMRS port, k denotes a subcarrier index, l denotes an OFDM symbol index, u denotes an SCS, w_{f}(k′) and wₜ (l′) denote a frequency domain orthogonal cover code (FD-OCC) coefficient and a time domain orthogonal cover code (TD-OCC) coefficient corresponding to a k′ value and a l′ value, respectively, and A expresses the interval between CDM groups by using the number of subcarriers.

In Equation (7), β_{PUSCH}^{DMRS} is a scaling factor indicating the ratio between the energy-per-RE (EPRE) of a PUSCH and the EPRE of a DMRS, and may be calculated by

$${β}_{PUSCH}^{DMRS} = {10}^{- \frac{{β}_{DMRS}}{20}} ,$$

and the value of β_{DMRS} may be 0 dB, −3 dB, and −4.77 dB according to the number of CDM groups being 1, 2, and 3.

$${\tilde{a}}_{k , l}^{( {p}_{j} , μ )} = {w}_{f} ( {k}^{′} ) {w}_{t} ( {l}^{′} ) r ( 2 n + {k}^{′} ) \qquad ( 7 )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 , …$$

$$j = 0 , 1 , … , v - 1$$

$$[ \begin{matrix}{\tilde{a}}_{k , l}^{( {p}_{0} , μ )} \\ ⋮ \\ {\tilde{a}}_{k , l}^{( {p}_{ρ - 1} , μ )}\end{matrix} ] = {β}_{{DMRS}_{PUSCH}} W [ \begin{matrix}{\tilde{a}}_{k , l}^{( {p}_{0} , μ )} \\ ⋮ \\ {\tilde{a}}_{k , l}^{( {p}_{v - 1} , μ )}\end{matrix} ]$$

If frequency hopping is not used, the terminal may be required to assume that the higher layer signaling dmrs-AdditionalPosition is configured to be “pos2”, and a maximum of two additional DMRS symbols are available for PUSCH transmission. If frequency hopping is used, the terminal may be required to assume that the higher layer signaling dmrs-AdditionalPosition is configured to be “pos1”, and a maximum of one additional DMRS symbols are available for PUSCH transmission.

In a case of a PDSCH scheduled by DCI format 0_1 and 0_2, the terminal may assume that CDM groups indicated through the column of “number of DMRS CDM group(s) without data” in Tables 31 to 46 may include DMRS ports allocated to a different terminal co-schedulable through a multi-user MIMO scheme and may not be used for data transmission of the terminal, and may understand that 1, 2, and 3 of the values indicated through the column of “number of DMRS CDM group(s) without data” in Tables 31 to 46 may imply that the indexes of CDM groups corresponding to the above meaning correspond to CDM groups 0, {0,1}, and {0,1,2}, respectively.

### Regarding UE Capability Report

In LTE and NR, a UE may perform a procedure in which, while being connected to a serving BS, the UE reports capability supported by the UE to the corresponding BS. Herein, this will be referred to as a UE capability report.

The BS may transfer a UE capability enquiry message to the UE in a connected state so as to request a capability report. The message may include a UE capability request with regard to each radio access technology (RAT) type of the BS. The RAT type-specific request may include supported frequency band combination information and the like. In addition, in the case of the UE capability inquiry message, UE capability with regard to multiple RAT types may be requested through one RRC message container transmitted by the BS, or the BS may transfer a UE capability inquiry message including multiple UE capability requests with regard to respective RAT types. That is, multiple capability inquiries may be included in one message, and may configure a UE capability information message corresponding thereto and report the same multiple times.

In next-generation mobile communication systems, a UE capability request may be made regarding multi-RAT dual connectivity (MR-DC), such as NR, LTE, E-UTRA-NR dual connectivity (EN-DC). In addition, the UE capability inquiry message is transmitted initially after the UE is connected to the BS, in general, but may be requested in any condition if needed by the BS.

Upon receiving the UE capability report request from the BS in the above step, the UE configures UE capability according to band information and RAT type required by the BS. A method in which the UE configures UE capability in an NR system is summarized below:
1. If the UE receives a list regarding LTE and/or NR bands from the BS at a UE capability request, the UE constructs band combinations (BCs) regarding EN-DC and NR standalone (SA). That is, the UE configures a candidate list of BCs regarding EN-DC and NR SA, based on bands received from the BS at a request through FreqBandList. In addition, bands have priority in the order described in FreqBandList.
2. If the BS has set “eutra-nr-only” flag or “eutra” flag and requested a UE capability report, the UE removes everything related to NR SA BCs from the configured BC candidate list. Such an operation may occur only if an LTE BS (eNB) requests “eutra” capability.
3. The UE then removes fallback BCs from the BC candidate list configured in the above step. As used herein, a fallback BC refers to a BC that can be obtained by removing a band corresponding to at least one secondary cell (SCell) from a specific BC, and since a BC before removal of the band corresponding to at least one SCell can already cover a fallback BC, the same can be omitted. This step is applied in MR-DC as well, i.e., LTE bands are also applied. BCs remaining after this step constitute the final “candidate BC list”.
4. The UE selects BCs appropriate for the requested RAT type from the final “candidate BC list” and selects BCs to report. In this step, the UE configures supportedBandCombinationList in a determined order. That is, the UE configures BCs and UE capability to report according to a preconfigured rat-Type order (nr->eutra-nr->eutra). In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” include all feature set combinations regarding NR and EUTRA-NR BCs, and are obtainable from feature set combinations of containers of UE-NR-Capabilities and UE-MRDC-Capabilities.
5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the BS. The BSs performs scheduling and transmission/reception management appropriate for the UE, based on the UE capability received from the UE.

As used herein, upper signaling (or upper layer signaling) is a method for transferring signals from a BS to a UE by using a DL data channel of a physical layer, or from the UE to the BS by using an UL data channel of the physical layer, and may also be referred to as RRC signaling, packet data convergence protocol (PDCP) signaling, or a medium access control (MAC) control element (CE).

A UE may use various methods to determine whether or not to apply cooperative communication, e.g., PDCCH(s) that allocates a PDSCH to which cooperative communication is applied have a specific format, or PDCCH(s) that allocates a PDSCH to which cooperative communication is applied include a specific indicator indicating whether or not to apply cooperative communication, or PDCCH(s) that allocates a PDSCH to which cooperative communication is applied are scrambled by a specific RNTI, or cooperative communication application is assumed in a specific range indicated by an upper layer.

Hereinafter, it will be assumed, for convenience of description, that a non-coherent joint transmission (NC-JT) case refers to a case in which the UE receives a PDSCH to which cooperative communication is applied, based on conditions similar to those described above.

Hereinafter, the description that priority between A and B is determined may be variously mentioned, such as the entity having a high priority is selected according to a predetermined priority rule, and a corresponding operation is performed, or operations regarding the entity having a lower priority is omitted or dropped.

Hereinafter, the above examples may be described through multiple embodiments, but they are not independent of each other, and one or more embodiments may be applied simultaneously or in combination.

Hereinafter, for convenience of description, a cell, a transmission point, a panel, a beam, and/or a transmission direction which can be distinguished through an upper layer/L1 parameter such as a TCI state or spatial relation information, a cell ID, a transmission reception point (TRP) ID, or a panel ID may be described as a TRP, a beam, or a TCI state as a whole. Therefore, during actual application, a TRP, a beam, or a TCI state may be appropriately replaced with one of the above terms.

Although embodiments of the disclosure will be described with reference to a 5G system as an example, embodiments of the disclosure are also applicable to other communication systems having similar technical backgrounds or channel types. For example, LTE or LTE-A mobile communications and mobile communication technologies developed after 5G may be included therein. Therefore, embodiments of the disclosure are also applicable to other communication systems through a partial modification without substantially deviating from the scope of the disclosure as deemed by those skilled in the art. The content in the disclosure is applicable in FDD and TDD systems.

In the following description of the disclosure, upper layer signaling may refer to signaling corresponding to at least one, or a combination of one or more of MIB, SIB or SIB X (X=1, 2, . . . ), RRC, or MAC CE.

In addition, L1 may refer to signaling corresponding to at least one among signaling methods using the following physical layer channel or signaling, or a combination of one or more thereof.
PDCCH
DCI
UE-specific DCI
Group common DCI
Common DCI
Scheduling DCI (e.g., DCI used for the purpose of scheduling DL or UL data)
Non-scheduling DCI (e.g., DCI not used for the purpose of scheduling DL or UL data)
PUCCH
UL control information (UCI)

Hereinafter, the description that priority between A and B is determined may be variously mentioned, such as the entity having a high priority is selected according to a predetermined priority rule, and a corresponding operation is performed, or operations regarding the entity having a lower priority is omitted or dropped.

As used herein, the term “slot” may generally refer to a specific time unit corresponding to a TTI, may specifically refer to a slot used in a 5G NR system, or may refer to a slot or a subframe used in a 4th generation (4G) LTE system.

### PUSCH Transmission Method of 8TX Terminal

According to an embodiment of the disclosure, a method of transmitting a UL data channel (e.g., a PUSCH) by a terminal supporting 8 transmission antennas for transmitting a UL channel and signal is provided. This embodiment may be operated in combination with all of other embodiments of the disclosure.

The 8 transmission antennas for UL may refer to 8 physical antennas or 8 logical UL transmission ports configured through a method of virtualizing multiple antennas into one antenna even though a terminal has actual 8 or more physical antennas (or less than 8). However, the number of transmission antennas for UL is not limited according to various embodiments of the disclosure, and the disclosure may include all cases in which a terminal with 8 transmission antennas is assumable through other antenna configuration methods. In addition, a case of fewer or more transmission antennas rather than 8 (e.g., 6, 12, 16, or a random value equal to or greater than the values) may also be included in embodiments of the disclosure.

A terminal supporting 4 transmission antennas may perform PUSCH transmission by using a maximum of 4 layers through UL data channel transmission based on a CP-OFDM waveform, and the maximum of 4 layers may be included in one codeword (CW). In NR release 18, for example, to increase performance including maximum UL transmission throughput of a terminal, such as customer premises equipment (CPE) or fixed wireless access (FWA) having an improved form factor, compared to a terminal, such as a smartphone, having a relatively small size and performance, a terminal supporting 8 transmission antennas may perform PUSCH transmission by using a maximum of 8 layers through UL data channel transmission based on a CP-OFDM waveform, the first 4 layers among the maximum of 8 layers may be included in a first CW, and the remaining 4 layers may be included in a second CW.

If a terminal transmits a PUSCH to a BS, a PUSCH transmission scheme of the terminal may be classified as “codebook”-based PUSCH transmission and “nonCodebook”-based PUSCH transmission. If a terminal performs “codebook”-based PUSCH transmission, the terminal may transmit, to a BS, an SRS resource(s) which may be configured by multiple SRS ports (or may be configured by a single SRS port), and the BS may receive the SRS resource(s) to perform estimation for an UL channel. Thereafter, the BS may select one SRS resource from among multiple SRS resources (e.g., when the multiple SRS resources are received), based on UL channel information obtained through the received SRS resources, and indicate the SRS resource through an SRI in DCI scheduling a PUSCH. When the terminal interprets the SRI indicated by the BS through the DCI, the terminal may use an SRS resource ID indicatable through the SRI to consider a position of the most recent reception before DCI reception among multiple transmission positions for an SRS resource having the SRS resource ID before DCI reception.

In addition, the BS may select the number of layers and a precoder of an UL data channel, based on the determined SRS resource to determine a TPMI field in the same PUSCH scheduling DCI including an SRI field. If the terminal supports 4 transmission antennas, a row of a precoder indicated by a TPMI may denote a PUSCH antenna port (e.g., a, b, c, and d in [a b c d] T may indicate values for a first PUSCH antenna port, a second PUSCH antenna port, a third PUSCH antenna port, and a fourth PUSCH antenna port, respectively), and a maximum of 4 rows may be included. If the terminal supports 8 transmission antennas as described above, according to an embodiment, in a case where a maximum of 8 PUSCH antenna ports rather than a maximum of 4 are used to support a codebook-based UL data channel (this may include an UL control channel), a codebook which is able to support up to 8 antenna ports may be needed as well as a codebook which is supportable up to 4 PUSCH antenna ports.

In addition, the terminal may expect that DCI received from the BS includes two MCS fields, two RV fields, and two NDI fields, so as to perform PUSCH transmission including 5 or more layers. If the terminal receives a scheduling for PUSCH transmission including 5 or more layers from the BS through DCI, i.e., if PUSCH transmission configured by 2 CWs is scheduled for the terminal by the BS, the terminal may understand that a first MCS field, a first RV field, and a first NDI field in the DCI are applied to the first CW, and a second MCS field, a second RV field, and a second NDI field in the DCI are applied to the second CW. A condition for two MCS fields, two RV fields, and two NDI fields existing in DCI may correspond to a case where the terminal has received particular higher layer signaling from the BS (e.g., signaling that is distinguished from maxNrofCodeWordsScheduledByDCI which is higher layer signaling, such as maxNrofCodeWordsScheduledByDCI-PUSCH, indicating that reception of a maximum of 8 layers of a PDSCH is possible, or higher layer signaling for a PDSCH may be commonly applied). If the terminal receives a PUSCH scheduling for 2 CWs from the BS, the terminal may assume that two different transport blocks (TBs) for a corresponding PUSCH are transmitted. If the terminal receives a 26th index for a first MCS field, receives 1 as the index of an RV for a first RV field, and receives 0 or 1 for a first NDI field, the terminal may consider that a first TB is not transmitted. If the terminal receives a 26th index for a second MCS field, receives 1 as the index of an RV for a second RV field, and receives 0 or 1 for a second NDI field, the terminal may consider that a second TB is not transmitted. As described above, in a case where the terminal transmits only one TB because a first or second TB is not transmitted from the terminal, the terminal may include the one transmitted TB in a first CW of a PUSCH.

The terminal may reports, to the BS, a terminal capability (UE capability) implying that the terminal supports one of “fullCoherent”, “partialCoherent”, or “nonCoherent”, according to the coherency of an antenna supportable by the terminal. Based on the terminal capability reported from the terminal, under the determination of the BS, the higher layer signaling “codebookSubset” (or “codebookSubsetDCI-0-2-r16”) may be configured by the BS for the terminal, and a subset of a TPMI indicatable from the BS may be indicated to the terminal. One value among “fullyAndPartialAndNonCoherent” indicating that all TPMIs are indicatable, “partialAndNonCoherent” indicating that a partial-coherent or non-coherent TPMI is indicatable, and “nonCoherent” indicating that only a non-coherent TPMI is indicatable may be configured by the BS through higher layer signaling as a value of codebook Subset.

If the terminal supports 4 UL transmission antennas and supports full-coherent transmission, this may imply that the terminal transmits each layer of a PUSCH by using all of the 4 antennas (e.g., this means using a precoding matrix including 4 values, which are not 0, in each column thereof), i.e., by using all of 4 PUSCH antenna ports. If the terminal supports partial-coherent transmission, this may imply that the terminal transmits each layer of a PUSCH by using 2 antennas, which is capable of coherent transmission, among the total of 4 transmission antennas (e.g., this means using a precoding matrix including 2 values, which are not 0, in each column thereof), i.e., by using 2 PUSCH antenna ports. If the terminal supports non-coherent transmission, this may imply that the terminal transmits each layer of a PUSCH by using one antenna (e.g., this means using a precoding matrix including one value, which is not 0, in each column thereof), i.e., by using one PUSCH antenna port, and may have a meaning similar to that of supporting a PUSCH antenna port selection scheme.

As a requirement for coherent UL transmission, if the differences between a relative power and a phase error measured for a random antenna port through the most recently transmitted SRS, and a relative power and a phase error measured in a slot in a particular time window (e.g., a time window as in Table 49 below) from the most recently transmitted SRS are smaller than defined reference values, the terminal may assume that the antenna port is allowable for coherent UL MIMO transmission.

TABLE 49

| Difference of relative | Difference of relative | Time |
|---|---|---|
| phase error | power error | window |
| 40 degrees | 4 dB | 20 msec |

If the power and phase error difference values between antenna ports within a particular time window is within an allowable value, compared to the power and phase error difference values between ports at the time of SRS transmission, i.e., if the characteristic of the power and phase error difference values between antenna ports is maintained within the particular time window, a corresponding antenna port may be considered to support coherent UL transmission. If the terminal supports 4 UL transmission antennas and supports full coherent UL transmission, this may imply that all of the 4 transmission antennas are capable of coherent transmission. The terminal supporting 4 UL transmission antennas and supporting partial coherent UL transmission may imply that coherent transmission is possible for each of two antenna pairs each including two transmission antennas, but may not ensure that coherent transmission is supported for two antenna ports that is not a combination of antennas capable of coherent transmission (e.g., this does not mean coherent transmission being impossible and means that satisfying a requirement for coherent UL transmission within a particular time window is unable to be ensured). Therefore, when the terminal receives, from the BS, a higher layer signaling configuration for codebook-based PUSCH support and a PUSCH transmission scheduling through L1 signaling in consideration of whether the terminal supports coherent transmission between antenna ports, the terminal may support some or all of all TPMIs defined between the terminal and the BS.

If the terminal supports 8 transmission antennas and supports full coherent UL transmission, this may imply that all of the 8 transmission antennas are capable of coherent transmission. The terminal supporting 8 transmission antennas and supporting partial coherent UL transmission may imply that coherent transmission is possible for a transmission antenna combination in a set of some antennas among the 8 transmission antennas, but the terminal is not able to support coherent transmission for a transmission antenna combination incapable of coherent transmission. As the set of some antennas, a total of 2 antenna sets capable of coherent transmission, each set including 4 antennas may be possible, and a total of 4 antenna sets capable of coherent transmission, each set including 2 antennas may be possible.

If the terminal supports 8 transmission antennas and supports partial coherent UL transmission in which a total of 2 antenna sets capable of coherent transmission, each set including 4 antennas may exist, the terminal may define a set of coherent PUSCH antenna ports as below.

[Partial coherent antenna set combination 1-1] The terminal may expect that among 8 PUSCH antenna ports including PUSCH antenna ports 1000 to 1007, PUSCH antenna ports 1000, 1002, 1004, and 1006 are included in an antenna set in which the ports are coherent to each other, and PUSCH antenna ports 1001, 1003, 1005, and 1007 are included in another antenna set in which the ports are coherent to each other.

[Partial coherent antenna set combination 1-2] The terminal may expect that among 8 PUSCH antenna ports including PUSCH antenna ports 1000 to 1007, PUSCH antenna ports 1000, 1001, 1002, and 1003 are included in an antenna set in which the ports are coherent to each other, and PUSCH antenna ports 1004, 1005, 1006, and 1007 are included in another antenna set in which the ports are coherent to each other.

[Partial coherent antenna set combination 1-3] The terminal may expect that among 8 PUSCH antenna ports including PUSCH antenna ports 1000 to 1007, PUSCH antenna ports 1000, 1001, 1004, and 1005 are included in an antenna set in which the ports are coherent to each other, and PUSCH antenna ports 1002, 1003, 1006, and 1007 are included in another antenna set in which the ports are coherent to each other.

[Partial coherent antenna set combination 1-4] From among 8 PUSCH antenna ports including PUSCH antenna ports 1000 to 1007, 2 coherent antenna sets may be configured for the terminal by the BS through higher layer signaling, and 4 PUSCH antenna ports in each coherent antenna set may be configured. For example, PUSCH antenna ports 1000, 1004, 1006, and 1007 may be configured in a coherent antenna set for the terminal by the BS through higher layer signaling, and PUSCH antenna ports 1001, 1002, 1003, and 1005 may be configured in another coherent antenna set.

The terminal may not exclude any method of configuring 2 coherent antenna sets by using a combination of PUSCH antenna ports, in addition to [Partial coherent antenna set combination 1-1] to [Partial coherent antenna set combination 1-4].

If the terminal supports 8 transmission antennas and supports partial coherent UL transmission in which a total of 4 antenna sets capable of coherent transmission, each set including 2 antennas may exist, the terminal may define a set of coherent PUSCH antenna ports as below.

[Partial coherent antenna set combination 2-1] The terminal may expect that among 8 PUSCH antenna ports including PUSCH antenna ports 1000 to 1007, PUSCH antenna ports 1000 and 1002 are included in a first coherent antenna set, PUSCH antenna ports 1004 and 1006 are included in a second coherent antenna set, PUSCH antenna ports 1001 and 1003 are included in a third coherent antenna set, and PUSCH antenna ports 1005 and 1007 are included in a fourth coherent antenna set.

[Partial coherent antenna set combination 2-2] The terminal may expect that among 8 PUSCH antenna ports including PUSCH antenna ports 1000 to 1007, PUSCH antenna ports 1000 and 1001 are included in a first coherent antenna set, PUSCH antenna ports 1002 and 1003 are included in a second coherent antenna set, PUSCH antenna ports 1004 and 1005 are included in a third coherent antenna set, and PUSCH antenna ports 1006 and 1007 are included in a fourth coherent antenna set.

[Partial coherent antenna set combination 2-3] The terminal may expect that among 8 PUSCH antenna ports including PUSCH antenna ports 1000 to 1007, PUSCH antenna ports 1000 and 1004 are included in a first coherent antenna set, PUSCH antenna ports 1001 and 1005 are included in a second coherent antenna set, PUSCH antenna ports 1002 and 1006 are included in a third coherent antenna set, and PUSCH antenna ports 1003 and 1007 are included in a fourth coherent antenna set.

[Partial coherent antenna set combination 2-4] From among 8 PUSCH antenna ports including PUSCH antenna ports 1000 to 1007, 4 coherent antenna sets may be configured for the terminal by the BS through higher layer signaling, and 2 PUSCH antenna ports in each coherent antenna set may be configured. For example, PUSCH antenna ports 1000 and 1005 may be configured in a first coherent antenna set for the terminal by the BS through higher layer signaling, PUSCH antenna ports 1001 and 1006 may be configured in a second coherent antenna set, PUSCH antenna ports 1002 and 1007 may be configured in a third coherent antenna set, and PUSCH antenna ports 1003 and 1004 may be configured in a fourth coherent antenna set.

The terminal may not exclude any method of configuring 4 coherent antenna sets by using a combination of PUSCH antenna ports, in addition to [Partial coherent antenna set combination 2-1] to [Partial coherent antenna set combination 2-4].

The terminal may transmit, to the BS, a terminal capability related to coherency for a PUSCH antenna port of the terminal in addition to [Partial coherent antenna set combination 1-1] to [Partial coherent antenna set combination 1-4] and [Partial coherent antenna set combination 2-1] to [Partial coherent antenna set combination 2-4]. Accordingly, the BS may define a TPMI by considering a terminal capability related to coherency reported by the terminal, when scheduling codebook-based PUSCH transmission of the terminal.

If 1 is configured as a maximum number of PTRS ports for the terminal by the BS through higher layer signaling and, as described above, higher layer signaling indicating that PUSCH transmission based on two CWs, i.e., PUSCH transmission configured by 5 or more layers is possible is configured for the terminal by the BS and the terminal receives DCI scheduling PUSCH transmission of 5 or more layers from the BS, the terminal may define, as shown in Table 50, the meaning of each codepoint of a PTRS-DMRS association field in the DCI with respect to all cases of supporting full-coherent, partial-coherent, or non-coherent UL transmission. The size of the PTRS-DMRS association field in the DCI may be 2 bits. When a DMRS port connectable to one PTRS port is selected through the PTRS-DMRS association field in the DCI, the terminal may compare two MCS fields in the DCI to select a CW having a higher MCS among two CWs and select one of DMRS ports in the CW. If MCSs for the two CWs are the same, the PTRS port may select one of DMRS ports existing in a first CW.

In relation to the meaning (e.g., when the value is 0) of a first codepoint in Table 50, the terminal may assume that a PTRS is connected to a firstly scheduled DMRS port among DMRS ports included in a selected CW. Similarly, in relation to the meaning (e.g., when the value is 1, 2, or 3) of a second, third, or fourth codepoint in Table 50 below, the terminal may assume that a PTRS is connected to a secondly, thirdly, or fourthly scheduled DMRS port among DMRS ports included in a selected CW.

TABLE 50

| Value | DMRS port |
|---|---|
| 0 | 1^{st} scheduled DMRS port with the CW |
| 1 | 2^{nd} scheduled DMRS port with the CW |
| 2 | 3^{rd} scheduled DMRS port with the CW |
| 3 | 4^{th} scheduled DMRS port with the CW |

### Method of PTRS-DMRS Connection at Time of PUSCH Transmission by 8TX Partial-Coherent Terminal

In accordance with an embodiment of the disclosure, when the terminal supports 8 transmission antennas and supports partial coherent UL transmission in which a total of 2 antenna sets capable of coherent transmission, each set including 4 antennas may exist, a method of connecting a PTRS and a DMRS at the time of PUSCH transmission by the terminal is provided. This embodiment may be operated in combination with all of other embodiments of the disclosure.

Which set of PUSCH antenna ports is connected to which PTRS port and is able to share phase error information estimated when the PTRS port is received by the BS may be fixedly defined by the terminal and the BS in a specification, may be configured for the terminal by the BS through higher layer signaling, may be activated through a MAC-CE, may be indicated through L1 signaling, and/or may be notified through a combination of at least one of higher layer signaling, MAC-CE, and L1 signaling. For example, if the terminal and the BS fixedly define a connection relation between a PTRS port and a PUSCH antenna port set in a specification, the terminal and the BS may assume that a set configured by PUSCH antenna ports 1000, 1002, 1004, and 1006 is connected to PTRS port 0 so that phase error information estimated when the PTRS port is received by the BS is sharable between respective ports of the PUSCH antenna port set, and may assume that a set configured by PUSCH antenna ports 1001, 1003, 1005, and 1007 may have a relation similar to the above relation with PTRS port 1.

The above set of PUSCH antenna ports may be defined as a set identical to or different from one of [Partial coherent antenna set combination 1-1] to [Partial coherent antenna set combination 1-4] when a relation between the set and a PTRS port is defined.

If the terminal has received PTRS transmission-related higher layer signaling from the BS and 2 is configured as the number of maximally transmittable PTRS ports by the BS through higher layer signaling, when interpreting a PTRS-DMRS association field in DCI receivable from the BS, the terminal may consider the following method.

If the terminal supports partial coherent UL transmission in which a total of 2 antenna sets capable of coherent transmission may exist, the terminal may identify the connectivity between a PUSCH antenna port and a DMRS port according to an indicated TPMI structure. For example, if the terminal receives a scheduling for PUSCH transmission configured by 8 layers from the BS, 4 DMRS ports may be included in a first CW and 4 DMRS ports may be included also in a second CW. The 4 DMRS ports in each CW may all correspond to a single coherent antenna set, and some of the 4 DMRS ports in each CW may correspond to a first coherent antenna set and the remaining some of the 4 DMRS ports may correspond to a second coherent antenna set. If two types of situations are generalized for 5 or more layers, the following description may be given.

### [Method 2-1]

At the time of PUSCH transmission of 5 or more layers, the terminal and the BS may define a TPMI so that DMRS ports corresponding to one coherent antenna set are allocatable in each CW. As items required to be considered when a TPMI is defined, a combination of at least one of the following items may be considered. However, the disclosure is not limited thereto.

The terminal may consider a scheme of combining coherent antenna ports among PUSCH antenna ports, i.e., one of [Partial coherent antenna set combination 1-1] to [Partial coherent antenna set combination 1-4].

When a TPMI corresponding to 8 transmission antennas is configured, a method of reusing a full-coherent TPMI predefined considering 4 transmission antennas may be considered.

A sharing relation between a set of PUSCH antenna ports and each PTRS port may be considered.

In consideration of the above combinations, e.g., if PUSCH antenna ports 1000, 1002, 1004, and 1006 are included in a first coherent antenna set and PUSCH antenna ports 1001, 1003, 1005, and 1007 are included in a second coherent antenna set in consideration of [Partial coherent antenna set combination 1-1], and a full-coherent TPMI defined considering 4 transmission antennas is reused, the terminal and the BS may define a partial-coherent TPMI having 2 coherent antenna sets for 5 layers, as shown in Equation (8) below.

$$W = \frac{1}{2 \sqrt{5}} [ \begin{matrix}1 & 1 & 0 & 0 & 0 \\ 0 & 0 & 1 & 1 & 1 \\ 1 & 1 & 0 & 0 & 0 \\ 0 & 0 & 1 & - 1 & 1 \\ 1 & - 1 & 0 & 0 & 0 \\ 0 & 0 & 1 & 1 & - 1 \\ 1 & - 1 & 0 & 0 & 0 \\ 0 & 0 & 1 & - 1 & - 1\end{matrix} ] \qquad ( 8 )$$

A TPMI expressed by Equation (8) may be applied to a codebook-based PUSCH scheduled as 5 layers.

DMRS ports corresponding to the first 2 layers of the TPMI may be included in a first CW, and PUSCH antenna ports corresponding to the DMRS ports may be 1000, 1002, 1004, and 1006. In addition, it may be noted that the PUSCH antenna ports are all included in a first coherent antenna set, and it may be understood that respective rows of the 14th TPMI having 2 layers defined in Table 22 are placed on PUSCH antenna ports 1000, 1002, 1004, and 1006 that are the first coherent antenna set.

DMRS ports corresponding to the remaining 3 layers of the TPMI may be included in a second CW, PUSCH antenna ports corresponding to the DMRS ports may be 1001, 1003, 1005, and 1007, it may be noted that the PUSCH antenna ports are all included in a second coherent antenna set, and it may be understood that respective rows of the 3th TPMI having 3 layers defined in Table 23 are placed on PUSCH antenna ports 1001, 1003, 1005, and 1007 that is the second coherent antenna set.

Similarly, a partial-coherent TPMI having 2 coherent antenna sets for 5 layers may use one of the 14th to 21th TPMIs defined in Table 22 and one of the 3th to 6th TPMIs defined in Table 23 and be made by placing the rows of each TPMI on the position of a corresponding coherent antenna set, and a total of 32 TPMIs may be possible.

Equation (8) uses a predefined full-coherent 2-layer TPMI and full-coherent 3-layer TPMI of 4 transmission antennas with respect to the first 2 layers and the remaining 3 layers. However, methods of expressing 5 layers by using predefined 5 full-coherent 1-layer TPMIs of 4 transmission antennas with respect to the first 2 layers and the remaining 3 layers, or by using 2 full-coherent 1-layer TPMIs of 4 transmission antennas and 1 full-coherent 3-layer TPMI of 4 transmission antennas may not be excluded.

In addition, any order change in two columns corresponding to the first 2 layers of the TPMI expressed by Equation (8), and any order change in three columns corresponding to the remaining 3 layers may be considered without being excluded.

According to an embodiment of the disclosure, similar to the above example, the terminal and the BS may define a partial-coherent TPMI having 2 coherent antenna sets for 6 layers as shown in Equation (9) below.

$$W = \frac{1}{2 \sqrt{6}} [ \begin{matrix}1 & 1 & 1 & 0 & 0 & 0 \\ 0 & 0 & 0 & 1 & 1 & 1 \\ 1 & - 1 & 1 & 0 & 0 & 0 \\ 0 & 0 & 0 & 1 & - 1 & 1 \\ 1 & 1 & - 1 & 0 & 0 & 0 \\ 0 & 0 & 0 & 1 & 1 & - 1 \\ 1 & - 1 & - 1 & 0 & 0 & 0 \\ 0 & 0 & 0 & 1 & - 1 & - 1\end{matrix} ] \qquad ( 9 )$$

A TPMI expressed by Equation (9) may be applied to a codebook-based PUSCH scheduled as 6 layers.

DMRS ports corresponding to the first 3 layers of the TPMI may be included in a first CW, PUSCH antenna ports corresponding to the DMRS ports may be 1000, 1002, 1004, and 1006, it may be noted that the PUSCH antenna ports are all included in a first coherent antenna set, and it may be understood that respective rows of the 3th TPMI having 3 layers defined in Table 23 are placed on PUSCH antenna ports 1000, 1002, 1004, and 1006 that are the first coherent antenna set.

DMRS ports corresponding to the remaining 3 layers of the TPMI may be included in a second CW, PUSCH antenna ports corresponding to the DMRS ports may be 1001, 1003, 1005, and 1007, it may be noted that the PUSCH antenna ports are all included in a second coherent antenna set, and it may be understood that respective rows of the 3th TPMI having 3 layers defined in Table 23 are placed on PUSCH antenna ports 1001, 1003, 1005, and 1007 that is the second coherent antenna set.

Similarly, a partial-coherent TPMI having 2 coherent antenna sets for 6 layers may use one of the 3th to 6th TPMIs defined in Table 23 for each coherent antenna set and be made by placing the rows of each TPMI on the position of a corresponding coherent antenna set, and a total of 16 TPMIs may be possible.

Equation (9) uses a predefined full-coherent 3-layer TPMI and full-coherent 3-layer TPMI of 4 transmission antennas with respect to the first 3 layers and the remaining 3 layers. However, methods of expressing 6 layers by using a predefined 6 full-coherent 1-layer TPMIs of 4 transmission antennas with respect to the first 3 layers and the remaining 3 layers, or by using 3 full-coherent 1-layer TPMIs of 4 transmission antennas and 1 full-coherent 3-layer TPMI of 4 transmission antennas may not be excluded.

In addition, any order change in three columns corresponding to the first 3 layers of the TPMI expressed by Equation (9), and any order change in three columns corresponding to the remaining 3 layers may be considered without being excluded.

According to an embodiment of the disclosure, similar to the above example, the terminal and the BS may define a partial-coherent TPMI having 2 coherent antenna sets for 7 layers as shown in Equation (10) below.

$$W = \frac{1}{2 \sqrt{7}} [ \begin{matrix}1 & 1 & 1 & 0 & 0 & 0 & 0 \\ 0 & 0 & 0 & 1 & 1 & 1 & 1 \\ 1 & - 1 & 1 & 0 & 0 & 0 & 0 \\ 0 & 0 & 0 & 1 & - 1 & 1 & - 1 \\ 1 & 1 & - 1 & 0 & 0 & 0 & 0 \\ 0 & 0 & 0 & 1 & 1 & - 1 & - 1 \\ 1 & - 1 & - 1 & 0 & 0 & 0 & 0 \\ 0 & 0 & 0 & 1 & - 1 & - 1 & 1\end{matrix} ] \qquad ( 10 )$$

A TPMI expressed by Equation (10) may be applied to a codebook-based PUSCH scheduled as 7 layers.

DMRS ports corresponding to the first 3 layers of the TPMI may be included in a first CW, PUSCH antenna ports corresponding to the DMRS ports may be 1000, 1002, 1004, and 1006, it may be noted that the PUSCH antenna ports are all included in a first coherent antenna set, and it may be understood that respective rows of the 3th TPMI having 3 layers defined in Table 23 are placed on PUSCH antenna ports 1000, 1002, 1004, and 1006 that are the first coherent antenna set.

DMRS ports corresponding to the remaining 3 layers of the TPMI may be included in a second CW, PUSCH antenna ports corresponding to the DMRS ports may be 1001, 1003, 1005, and 1007, it may be noted that the PUSCH antenna ports are all included in a second coherent antenna set, and it may be understood that respective rows of the 3th TPMI having 4 layers defined in Table 24 are placed on PUSCH antenna ports 1001, 1003, 1005, and 1007 that is the second coherent antenna set.

Similarly, a partial-coherent TPMI having 2 coherent antenna sets for 7 layers may use one of the 3th to 6th TPMIs defined in Table 23 and one of the 3th and 4th TPMIs defined in Table 24 for the coherent antenna sets and be made by placing the rows of each TPMI on the position of a corresponding coherent antenna set, and a total of 8 TPMIs may be possible.

Equation (10) uses a predefined full-coherent 3-layer TPMI and full-coherent 4-layer TPMI of 4 transmission antennas with respect to the first 3 layers and the remaining 4 layers. However, methods of expressing 7 layers by using a predefined 7 full-coherent 1-layer TPMIs of 4 transmission antennas with respect to the first 3 layers and the remaining 4 layers, or by using 3 full-coherent 1-layer TPMIs of 4 transmission antennas and 1 full-coherent 4-layer TPMI of 4 transmission antennas may not be excluded.

In addition, any order change in three columns corresponding to the first 3 layers of the TPMI expressed by Equation (10), and any order change in four columns corresponding to the remaining 4 layers may be considered without being excluded.

According to an embodiment of the disclosure, similar to the above example, the terminal and the BS may define a partial-coherent TPMI having 2 coherent antenna sets for 8 layers as shown in Equation (11) below.

$$W = \frac{1}{4 \sqrt{2}} [ \begin{matrix}1 & 1 & 1 & 1 & 0 & 0 & 0 & 0 \\ 0 & 0 & 0 & 0 & 1 & 1 & 1 & 1 \\ 1 & - 1 & 1 & - 1 & 0 & 0 & 0 & 0 \\ 0 & 0 & 0 & 0 & 1 & - 1 & 1 & - 1 \\ 1 & 1 & - 1 & - 1 & 0 & 0 & 0 & 0 \\ 0 & 0 & 0 & 0 & 1 & 1 & - 1 & - 1 \\ 1 & - 1 & - 1 & 1 & 0 & 0 & 0 & 0 \\ 0 & 0 & 0 & 0 & 1 & - 1 & - 1 & 1\end{matrix} ] \qquad ( 11 )$$

A TPMI expressed by Equation (11) may be applied to a codebook-based PUSCH scheduled as 8 layers.

DMRS ports corresponding to the first 4 layers of the TPMI may be included in a first CW, PUSCH antenna ports corresponding to the DMRS ports may be 1000, 1002, 1004, and 1006, it may be noted that the PUSCH antenna ports are all included in a first coherent antenna set, and it may be understood that respective rows of the 3th TPMI having 4 layers defined in Table 24 are placed on PUSCH antenna ports 1000, 1002, 1004, and 1006 that are the first coherent antenna set.

DMRS ports corresponding to the remaining 4 layers of the TPMI may be included in a second CW, PUSCH antenna ports corresponding to the DMRS ports may be 1001, 1003, 1005, and 1007, it may be noted that the PUSCH antenna ports are all included in a second coherent antenna set, and it may be understood that respective rows of the 3th TPMI having 4 layers defined in Table 24 are placed on PUSCH antenna ports 1001, 1003, 1005, and 1007 that is the second coherent antenna set.

Similarly, a partial-coherent TPMI having 2 coherent antenna sets for 8 layers may use one of the 3th and 4th TPMIs defined in Table 24 for each coherent antenna set and be made by placing the rows of each TPMI on the position of a corresponding coherent antenna set, and a total of 4 TPMIs may be possible.

Equation (11) uses a predefined full-coherent 4-layer TPMI and full-coherent 4-layer TPMI of 4 transmission antennas with respect to the first 4 layers and the remaining 4 layers. However, methods of expressing 8 layers by using a predefined 8 full-coherent 1-layer TPMIs of 4 transmission antennas with respect to the first 4 layers and the remaining 4 layers, or by using 4 full-coherent 1-layer TPMIs of 4 transmission antennas and 1 full-coherent 4-layer TPMI of 4 transmission antennas may not be excluded.

In addition, any order change in four columns corresponding to the first 4 layers of the TPMI expressed by Equation (11)], and any order change in four columns corresponding to the remaining 4 layers may be considered without being excluded.

5-layer, 6-layer, 7-layer, and 8-layer TPMIs expressed by Equations (8)-(11) may include, when the terminal performs PUSCH transmission of 5 or more layers, PUSCH antenna ports corresponding to a first coherent antenna set in a first CW (e.g., according to [Partial coherent antenna set combination 1-1], PUSCH antenna ports 1000, 1002, 1004, and 1006 may be included), and include PUSCH antenna ports corresponding to a second coherent antenna set in a second CW (e.g., according to [Partial coherent antenna set combination 1-1], PUSCH antenna ports 1001, 1003, 1005, and 1007 may be included). In this case, if the terminal has received PTRS transmission-related higher layer signaling from the BS and 2 is configured as the number of maximally transmittable PTRS ports by the BS through higher layer signaling, when interpreting a PTRS-DMRS association field in DCI receivable from the BS, the terminal may consider the following method.

### PTRS-DMRS Association Method 2-1-1

If, as described above, higher layer signaling indicating that PUSCH transmission based on 2 CWs, i.e., PUSCH transmission configured by 5 or more layers is possible, is configured for the terminal by the BS, the terminal has received DCI scheduling PUSCH transmission of 5 or more layers from the BS, and a TPMI defined as shown in method 2-1 is indicated through the same DCI, the terminal may expect that PUSCH antenna ports in a coherent antenna set are included in each CW. The terminal may connect 2 PTRS ports to particular DMRS ports according to the meaning of each codepoint of a PTRS-DMRS association field of Table 51 below, defined by 4 bits, and use same at the time of PUSCH transmission. The terminal and the BS may define the meaning of each codepoint of a PTRS-DMRS association field as shown in Table 51.

TABLE 51

| Value | | Value | |
|---|---|---|---|
| of two | | of two | |
| MSBs | DMRS port | LSBs | DMRS port |
| 0 | 1^{st} DMRS port which | 0 | 1^{st} DMRS port which |
| | shares PTRS port 0 | | shares PTRS port 1 |
| | with the CW1 | | with the CW2 |
| 1 | 2^{nd} DMRS port which | 1 | 2^{nd} DMRS port which |
| | shares PTRS port 0 | | shares PTRS port 1 |
| | with the CW1 | | with the CW2 |
| 2 | 3^{rd} DMRS port which | 2 | 3^{rd} DMRS port which |
| | shares PTRS port 0 | | shares PTRS port 1 |
| | with the CW1 | | with the CW2 |
| 3 | 4^{th} DMRS port which | 3 | 4^{th} DMRS port which |
| | shares PTRS port 0 | | shares PTRS port 1 |
| | with the CW1 | | with the CW2 |

In Table 51, one of DMRS ports included in a first CW (CW1) may be connected to PTRS port 0 through 2 MSBs among 4 bits of a PTRS-DMRS association field in DCI, and one of DMRS ports included in a second CW (CW2) may be connected to PTRS port 1 through 2 LSBs. According to which PUSCH antenna port to which a DMRS is connected, the DMRS being included in each CW, a connection relation of PTRS port 0 indicated through 2 MSBs in Table 51 may correspond to a DMRS port in CW2 rather than CW1.

According to an embodiment of the disclosure, with respect to a first codepoint (when the value of two MSBs is 0) indicated through 2 MSBs in Table 51, the terminal may interpret a connected DMRS port to be “1st DMRS port which shares PTRS port 0 with the CW2”. In addition, as described above, which set of PUSCH antenna ports is connected to a random PTRS port and is able to share information processible by the BS are determined, and if the connection and sharing relations are identical to those of a coherent antenna set included in each CW, a DMRS port connected to a particular

CW (CW1 or CW2) may not be indicated to the terminal through a PTRS-DMRS association field.

According to an embodiment of the disclosure, with respect to a first codepoint (when the value of two MSBs is 0) indicated through 2 MSBs in Table 51, the terminal may interpret a connected DMRS port to be the first DMRS port sharing PTRS port 0, such as “1st DMRS port which shares PTRS port 0”, rather than a DMRS port included in CW1.

If the BS defines a PTRS-DMRS association field in DCI, based on [PTRS-DMRS association method 2-1-1], while DCI overhead is increased by consuming 4 bits, compared to a case of a maximum number of PTRS ports being 1, the BS may indicate a connection relation with 2 PTRS ports for all DMRS ports in all CWs. Therefore, the BS may secure a high degree of freedom for scheduling.

### PTRS-DMRS Association Method 2-1-2

If, as described above, higher layer signaling indicating that PUSCH transmission based on 2 CWs, i.e., PUSCH transmission configured by 5 or more layers is possible, is configured for the terminal by the BS, the terminal has received DCI scheduling PUSCH transmission of 5 or more layers from the BS, and a TPMI defined as shown in method 2-1 is indicated through the same DCI, the terminal may expect that PUSCH antenna ports in a coherent antenna set are included in each CW. The terminal may connect 2 PTRS ports to particular DMRS ports according to the meaning of each codepoint of a PTRS-DMRS association field of Table 52 below, defined by 2 bits, and use same at the time of PUSCH transmission. The terminal and the BS may define the meaning of each codepoint of a PTRS-DMRS association field as shown in Table 52.

TABLE 52

| Value | | Value | |
|---|---|---|---|
| of MSB | DMRS port | of LSB | DMRS port |
| 0 | 1^{st} DMRS port which | 0 | 1^{st} DMRS port which |
| | shares PTRS port 0 | | shares PTRS port 1 |
| | with the CW1 | | with the CW2 |
| 1 | 2^{nd} DMRS port which | 1 | 2^{nd} DMRS port which |
| | shares PTRS port 0 | | shares PTRS port 1 |
| | with the CW1 | | with the CW2 |

In Table 52, one of DMRS ports included in a first CW (CW1) may be connected to PTRS port 0 through an MSB among 2 bits of a PTRS-DMRS association field in DCI, and one of DMRS ports included in a second CW (CW2) may be connected to PTRS port 1 through an LSB. According to which PUSCH antenna port to which a DMRS is connected, the DMRS being included in each CW, a connection relation of PTRS port 0 indicated through an MSB in [Table 52] may correspond to a DMRS port in CW2 rather than CW1.

According to an embodiment of the disclosure, with respect to a first codepoint (when the value of MSB is 0) indicated through an MSB in Table 52, the terminal may interpret a connected DMRS port to be “1st DMRS port which shares PTRS port 0 with the CW2”. In addition, as described above, which set of PUSCH antenna ports is connected to a random PTRS port and is able to share information processible by the BS are determined, and if the connection and sharing relations are identical to those of a coherent antenna set included in each CW, a DMRS port connected to a particular CW (CW1 or CW2) may not be indicated to the terminal through a PTRS-DMRS association field.

According to an embodiment of the disclosure, with respect to a first codepoint (when the value of an MSB is 0) indicated through 2 MSBs in Table 52, the terminal may interpret a connected DMRS port to be the first DMRS port sharing PTRS port 0, such as “1st DMRS port which shares PTRS port 0”, rather than a DMRS port included in CW1.

If the BS defines a PTRS-DMRS association field in DCI, based on [PTRS-DMRS association method 2-1-2], while DCI overhead is maintained by consuming 2 bits, compared to a case of a maximum number of PTRS ports being 1, the BS is unable to indicate a connection relation with a PTRS for the third and fourth DMRSs in each CW, i.e., may indicate a connection relation with 2 PTRS ports for some DMRS ports in all CWs. Therefore, the degree of freedom for scheduling may be reduced.

In method [2-1], if the BS receives a PUSCH of 5 or more layers transmitted from the terminal, when the BS performs channel estimation for each CW and decodes data corresponding to each layer, the BS may allocate DMRS ports corresponding to one coherent antenna set to one CW so that the coherency between PUSCH antenna ports connected to the DMRS ports is ensured and thus channel estimation and decoding performance may be improved. However, as described above, in a case where the terminal transmits a PUSCH after connecting 2 PTRS ports to particular DMRS ports, when a PTRS-DMRS association is indicated, the number of bits of a PTRS-DMRS association field in DCI may be increased in order to obtain a maximum degree of freedom for scheduling.

### Method 2-2

At the time of PUSCH transmission of 5 or more layers, the terminal and the BS may define a TPMI so that DMRS ports corresponding to one or more coherent antenna set are allocatable in each CW. As items required to be considered at the time of defining, a combination of at least one of the following items may be considered.

The terminal may consider a scheme of combining coherent antenna ports among PUSCH antenna ports, i.e., one of [Partial coherent antenna set combination 1-1] to [Partial coherent antenna set combination 1-4].

When a TPMI corresponding to 8 transmission antennas is configured, a method of reusing a full-coherent TPMI predefined considering 4 transmission antennas may be considered.

A sharing relation between a set of PUSCH antenna ports and each PTRS port may be considered.

In consideration of the above items required to be considered at the time of TPMI configuration, if PUSCH antenna ports 1000, 1002, 1004, and 1006 are included in a first coherent antenna set and PUSCH antenna ports 1001, 1003, 1005, and 1007 are included in a second coherent antenna set in consideration of [Partial coherent antenna set combination 1-1], and a full-coherent TPMI defined considering 4 transmission antennas is reused, the terminal and the BS may define a partial-coherent TPMI having 2 coherent antenna sets for 5 layers, as shown in Equation (12) below.

$$W = \frac{1}{2 \sqrt{5}} [ \begin{matrix}1 & 0 & 1 & 0 & 0 \\ 0 & 1 & 0 & 1 & 1 \\ 1 & 0 & 1 & 0 & 0 \\ 0 & 1 & 0 & - 1 & 1 \\ 1 & 0 & - 1 & 0 & 0 \\ 0 & 1 & 0 & 1 & - 1 \\ 1 & 0 & - 1 & 0 & 0 \\ 0 & 1 & 0 & - 1 & - 1\end{matrix} ] \qquad ( 12 )$$

A TPMI expressed by Equation (12) may be applied to a codebook-based PUSCH scheduled as 5 layers.

DMRS ports corresponding to the first 2 layers of the TPMI may be included in a first CW, and DMRS ports corresponding to the remaining 3 layers may be included in a second CW.

PUSCH antenna ports connected to DMRS ports corresponding to the first layer and the third layer of the TPMI may be 1000, 1002, 1004, and 1006, it may be noted that the PUSCH antenna ports are all included in a first coherent antenna set, and it may be understood that respective rows of the 14th TPMI having 2 layers defined in Table 22 are placed on PUSCH antenna ports 1000, 1002, 1004, and 1006 that are the first coherent antenna set of the TPMI expressed by Equation (12), the first column of the 14th TPMI having 2 layers defined in Table 22 is placed on the first layer of the TPMI expressed by Equation (12), and the second column is placed on the third layer.

In addition, PUSCH antenna ports connected to DMRS ports corresponding to the second layer, the fourth layer, and the fifth layer of the TPMI may be 1001, 1003, 1005, and 1007, it may be noted that the PUSCH antenna ports are all included in a second coherent antenna set, and it may be understood that respective rows of the 3th TPMI having 3 layers defined in Table 23 are placed on PUSCH antenna ports 1001, 1003, 1005, and 1007 that is the second coherent antenna set, the first column of the 3th TPMI having 3 layers defined in Table 23 is placed on the second layer of the TPMI expressed by Equation (12), the second column is placed on the fourth layer, and the third column is placed on the fifth layer.

Similarly, a partial-coherent TPMI having 2 coherent antenna sets for 5 layers may use one of the 14th to 21th TPMIs defined in Table 22 and one of the 3th to 6th TPMIs defined in Table 23 and be made by placing the rows of each TPMI on the position of a corresponding coherent antenna set, and a total of 32 TPMIs may be possible.

Equation (12) uses a predefined full-coherent 2-layer TPMI and full-coherent 3-layer TPMI of 4 transmission antennas with respect to a first layer set including the first layer and the third layer and a second layer set including the second layer, the fourth layer, and the fifth layer. However, methods of expressing 5 layers by using predefined 5 full-coherent 1-layer TPMIs of 4 transmission antennas with respect to the first layer set and the second layer set, or by using 2 full-coherent 1-layer TPMIs of 4 transmission antennas and 1 full-coherent 3-layer TPMI of 4 transmission antennas may also be considered without being excluded.

In addition, any order change in two columns corresponding to the first 2 layers of the TPMI expressed by Equation (12), and any order change in three columns corresponding to the remaining 3 layers may be considered without being excluded.

As another example, the terminal and the BS may define a partial-coherent TPMI having 2 coherent antenna sets for 5 layers as shown in Equation (13) below.

$$W = \frac{1}{2 \sqrt{5}} [ \begin{matrix}1 & 0 & 1 & 1 & 0 \\ 0 & 1 & 0 & 0 & 1 \\ 1 & 0 & - 1 & 1 & 0 \\ 0 & 1 & 0 & 0 & 1 \\ 1 & 0 & 1 & - 1 & 0 \\ 0 & 1 & 0 & 0 & - 1 \\ 1 & 0 & - 1 & - 1 & 0 \\ 0 & 1 & 0 & 0 & - 1\end{matrix} ] \qquad ( 13 )$$

A TPMI expressed by Equation (13) may be applied to a codebook-based PUSCH scheduled as 5 layers.

DMRS ports corresponding to the first 2 layers of the TPMI may be included in a first CW, and DMRS ports corresponding to the remaining 3 layers may be included in a second CW.

PUSCH antenna ports connected to DMRS ports corresponding to the first layer, the third layer, and the fourth layer of the TPMI may be 1000, 1002, 1004, and 1006, it may be noted that the PUSCH antenna ports are all included in a first coherent antenna set, and it may be understood that respective rows of the 3th TPMI having 3 layers defined in Table 23 are placed on PUSCH antenna ports 1000, 1002, 1004, and 1006 that are the first coherent antenna set of the TPMI expressed by Equation (13), the first column of the 3th TPMI having 3 layers defined in Table 23 is placed on the first layer of the TPMI expressed by Equation (13), the second column is placed on the third layer, and the third column is placed on the fourth layer.
In addition, PUSCH antenna ports connected to DMRS ports corresponding to the second layer and the fifth layer of the TPMI may be 1001, 1003, 1005, and 1007, it may be noted that the PUSCH antenna ports are all included in a second coherent antenna set, and it may be understood that respective rows of the 14th TPMI having 2 layers defined in Table 22 are placed on PUSCH antenna ports 1001, 1003, 1005, and 1007 that is the second coherent antenna set, the first column of the 14th TPMI having 2 layers defined in Table 22 is placed on the second layer of the TPMI expressed by Equation (13), and the second column is placed on the fifth layer.

Similarly, a partial-coherent TPMI having 2 coherent antenna sets for 5 layers may use one of the 14th to 21th TPMIs defined in Table 22 and one of the 3th to 6th TPMIs defined in Table 23 and be made by placing the rows of each TPMI on the position of a corresponding coherent antenna set, and a total of 32 TPMIs may be possible.

According to an embodiment of the disclosure, Equation (13) uses a predefined full-coherent 3-layer TPMI and full-coherent 2-layer TPMI of 4 transmission antennas with respect to a first layer set including the first layer, the third layer, and the fourth layer and a second layer set including the second layer and the fifth layer. However, methods of expressing 5 layers by using predefined 5 full-coherent 1-layer TPMIs of 4 transmission antennas with respect to the first layer set and the second layer set, or by using 2 full-coherent 1-layer TPMIs of 4 transmission antennas and 1 full-coherent 3-layer TPMI of 4 transmission antennas may not be excluded.

In addition, according to an embodiment of the disclosure, any order change in two columns corresponding to the first 2 layers of the TPMI expressed by Equation (13), and any order change in three columns corresponding to the remaining 3 layers may be considered without being excluded.

Similarly, the terminal and the BS may define, e.g., a partial-coherent TPMI having 2 coherent antenna sets for 6 layers as shown in Equation (14) below.

$$W = \frac{1}{2 \sqrt{6}} [ \begin{matrix}1 & 1 & 0 & 1 & 0 & 0 \\ 0 & 0 & 1 & 0 & 1 & 1 \\ 1 & - 1 & 0 & 1 & 0 & 0 \\ 0 & 0 & 1 & 0 & - 1 & 1 \\ 1 & 1 & 0 & - 1 & 0 & 0 \\ 0 & 0 & 1 & 0 & 1 & - 1 \\ 1 & - 1 & 0 & - 1 & 0 & 0 \\ 0 & 0 & 1 & 0 & - 1 & - 1\end{matrix} ] \qquad ( 14 )$$

A TPMI expressed by Equation (14) may be applied to a codebook-based PUSCH scheduled through 6 layers.

DMRS ports corresponding to the first 3 layers of the TPMI may be included in a first CW, and DMRS ports corresponding to the remaining 3 layers may be included in a second CW.

PUSCH antenna ports connected to DMRS ports corresponding to the first layer, the second layer, and the fourth layer of the TPMI may be 1000, 1002, 1004, and 1006, it may be noted that the PUSCH antenna ports are all included in a first coherent antenna set, and it may be understood that respective rows of the 3th TPMI having 3 layers defined in Table 23 are placed on PUSCH antenna ports 1000, 1002, 1004, and 1006 that are the first coherent antenna set of the TPMI expressed by Equation (14), the first column of the 3th TPMI having 3 layers defined in Table 23 is placed on the first layer of the TPMI expressed by Equation (14), the second column is placed on the second layer, and the third column is placed on the fourth layer.

In addition, PUSCH antenna ports connected to DMRS ports corresponding to the third layer, the fifth layer, and the sixth layer of the TPMI may be 1001, 1003, 1005, and 1007, it may be noted that the PUSCH antenna ports are all included in a second coherent antenna set, and it may be understood that respective rows of the 3th TPMI having 3 layers defined in Table 23 are placed on PUSCH antenna ports 1001, 1003, 1005, and 1007 that is the second coherent antenna set, the first column of the 3th TPMI having 3 layers defined in Table 23 is placed on the third layer of the TPMI expressed by Equation (14), the second column is placed on the fifth layer, and the third column is placed on the sixth layer.

Similarly, a partial-coherent TPMI having 2 coherent antenna sets for 6 layers may use one of the 3th to 6th TPMIs defined in Table 23 for each coherent antenna set and be made by placing the rows of each TPMI on the position of a corresponding coherent antenna set, and a total of 16 TPMIs may be possible.

According to an embodiment of the disclosure, Equation (14) uses predefined 2 full-coherent 3-layer TPMIs of 4 transmission antennas with respect to a first layer set including the first layer, the second layer, and the fourth layer and a second layer set including the third layer, the fourth layer, and the fifth layer. However, methods of expressing 6 layers by using predefined 6 full-coherent 1-layer TPMIs of 4 transmission antennas with respect to the first layer set and the second layer set, or by using 3 full-coherent 1-layer TPMIs of 4 transmission antennas and 1 full-coherent 3-layer TPMI of 4 transmission antennas may not be excluded.

In addition, according to an embodiment of the disclosure, any order change in three columns corresponding to the first 3 layers of the TPMI expressed by Equation (14), and any order change in three columns corresponding to the remaining 3 layers may be considered without being excluded.

As another example, the terminal and the BS may define a partial-coherent TPMI having 2 coherent antenna sets for 6 layers as shown in Equation (15) below.

$$W = \frac{1}{2 \sqrt{6}} [ \begin{matrix}1 & 1 & 0 & 1 & 1 & 0 \\ 0 & 0 & 1 & 0 & 0 & 1 \\ 1 & - 1 & 0 & 1 & - 1 & 0 \\ 0 & 0 & 1 & 0 & 0 & 1 \\ 1 & 1 & 0 & - 1 & - 1 & 0 \\ 0 & 0 & 1 & 0 & 0 & - 1 \\ 1 & - 1 & 0 & - 1 & 1 & 0 \\ 0 & 0 & 1 & 0 & 0 & - 1\end{matrix} ] \qquad ( 15 )$$

A TPMI expressed by Equation (15) may be applied to a codebook-based PUSCH scheduled as 6 layers.

DMRS ports corresponding to the first 3 layers of the TPMI may be included in a first CW, and DMRS ports corresponding to the remaining 3 layers may be included in a second CW.

PUSCH antenna ports connected to DMRS ports corresponding to the first layer, the second layer, the fourth layer, and the fifth layer of the TPMI may be 1000, 1002, 1004, and 1006, it may be noted that the PUSCH antenna ports are all included in a first coherent antenna set, and it may be understood that respective rows of the 3th TPMI having 4 layers defined in Table 24 are placed on PUSCH antenna ports 1000, 1002, 1004, and 1006 that are the first coherent antenna set of the TPMI expressed by Equation (15), the first column of the 3th TPMI having 4 layers defined in Table 24 is placed on the first layer of the TPMI expressed by Equation (15), the second column is placed on the second layer, the third column is placed on the fourth layer, and the fourth column is placed on the fifth layer.

In addition, PUSCH antenna ports connected to DMRS ports corresponding to the third layer and the sixth layer of the TPMI may be 1001, 1003, 1005, and 1007, it may be noted that the PUSCH antenna ports are all included in a second coherent antenna set, and it may be understood that respective rows of the 14th TPMI having 2 layers defined in Table 22 are placed on PUSCH antenna ports 1001, 1003, 1005, and 1007 that is the second coherent antenna set, the first column of the 14th TPMI having 2 layers defined in Table 22 is placed on the third layer of the TPMI expressed by Equation (15), and the second column is placed on the sixth layer.

Similarly, a partial-coherent TPMI having 2 coherent antenna sets for 6 layers may use one of the 3th to 6th TPMIs having 4 layers defined in Table 24 and one of the 14th to 21th TPMIs having 2 layers defined in Table 22 and be made by placing the rows of each TPMI on the position of a corresponding coherent antenna set, and a total of 32 TPMIs may be possible.

According to an embodiment of the disclosure, Equation (15) uses a predefined full-coherent 4-layer TPMI and full-coherent 2-layer TPMI of 4 transmission antennas with respect to a first layer set including the first layer, the second layer, the fourth layer, and the fifth layer and a second layer set including the third layer and the sixth layer. However, methods of expressing 6 layers by using predefined 6 full-coherent 1-layer TPMIs of 4 transmission antennas with respect to the first layer set and the second layer set, or by using 4 full-coherent 1-layer TPMIs of 4 transmission antennas and 1 full-coherent 2-layer TPMI of 4 transmission antennas may not be excluded.

In addition, according to an embodiment of the disclosure, any order change in three columns corresponding to the first 3 layers of the TPMI expressed by Equation (15), and any order change in three columns corresponding to the remaining 3 layers may be considered without being excluded.

As another example, the terminal and the BS may define a partial-coherent TPMI having 2 coherent antenna sets for 6 layers as shown in Equation (16) below.

$$W = \frac{1}{2 \sqrt{6}} [ \begin{matrix}1 & 0 & 0 & 1 & 0 & 0 \\ 0 & 1 & 1 & 0 & 1 & 1 \\ 1 & 0 & 0 & 1 & 0 & 0 \\ 0 & 1 & - 1 & 0 & 1 & - 1 \\ 1 & 0 & 0 & - 1 & 0 & 0 \\ 0 & 1 & 1 & 0 & - 1 & - 1 \\ 1 & 0 & 0 & - 1 & 0 & 0 \\ 0 & 1 & - 1 & 0 & - 1 & 1\end{matrix} ] \qquad ( 16 )$$

A TPMI expressed by Equation (16) may be applied to a codebook-based PUSCH scheduled as 6 layers.

DMRS ports corresponding to the first 3 layers of the TPMI may be included in a first CW, and DMRS ports corresponding to the remaining 3 layers may be included in a second CW.

According to an embodiment of the disclosure, PUSCH antenna ports connected to DMRS ports corresponding to the first layer and the fourth layer of the TPMI may be 1000, 1002, 1004, and 1006, it may be noted that the PUSCH antenna ports are all included in a first coherent antenna set, and it may be understood that respective rows of the 14th TPMI having 2 layers defined in Table 22 are placed on PUSCH antenna ports 1000, 1002, 1004, and 1006 that are the first coherent antenna set, the first column of the 14th TPMI having 2 layers defined in Table 22 is placed on the first layer of the TPMI expressed by Equation (16), and the second column is placed on the fourth layer.

In addition, PUSCH antenna ports connected to DMRS ports corresponding to the second layer, the third layer, the fifth layer, and the sixth layer of the TPMI may be 1001, 1003, 1005, and 1007, it may be noted that the PUSCH antenna ports are all included in a second coherent antenna set, and it may be understood that respective rows of the 3th TPMI having 4 layers defined in Table 24 are placed on PUSCH antenna ports 1000, 1002, 1004, and 1006 that are the first coherent antenna set of the TPMI expressed by Equation (16), the first column of the 3th TPMI having 4 layers defined in Table 24 is placed on the second layer of the TPMI expressed by Equation (16), the second column is placed on the third layer, the third column is placed on the fifth layer, and the fourth column is placed on the sixth layer.

Similarly, a partial-coherent TPMI having 2 coherent antenna sets for 6 layers may use one of the 3th to 6th TPMIs defined in Table 24 and one of the 14th to 21th TPMIs having 2 layers defined in Table 22 and be made by placing the rows of each TPMI on the position of a corresponding coherent antenna set, and a total of 32 TPMIs may be possible.

Equation (16) uses a predefined full-coherent 2-layer TPMI and full-coherent 4-layer TPMI of 4 transmission antennas with respect to a first layer set including the first layer and the fourth layer and a second layer set including the second layer, the third layer, the fifth layer, and the sixth layer. However, methods of expressing 6 layers by using predefined 6 full-coherent 1-layer TPMIs of 4 transmission antennas with respect to the first layer set and the second layer set, or by using 4 full-coherent 1-layer TPMIs of 4 transmission antennas and 1 full-coherent 2-layer TPMI of 4 transmission antennas may not be excluded.

In addition, any order change in three columns corresponding to the first 3 layers of the TPMI expressed by Equation (16), and any order change in three columns corresponding to the remaining 3 layers may be considered without being excluded.

Similarly, the terminal and the BS may define, for example, a partial-coherent TPMI having 2 coherent antenna sets for 7 layers as shown in Equation (17) below.

$$W = \frac{1}{2 \sqrt{7}} [ \begin{matrix}1 & 1 & 0 & 1 & 1 & 0 & 0 \\ 0 & 0 & 1 & 0 & 0 & 1 & 1 \\ 1 & - 1 & 0 & 1 & - 1 & 0 & 0 \\ 0 & 0 & 1 & 0 & 0 & - 1 & 1 \\ 1 & 1 & 0 & - 1 & - 1 & 0 & 0 \\ 0 & 0 & 1 & 0 & 0 & - 1 & - 1 \\ 1 & - 1 & 0 & - 1 & 1 & 0 & 0 \\ 0 & 0 & 1 & 0 & 0 & 1 & - 1\end{matrix} ] \qquad ( 17 )$$

A TPMI expressed by Equation (17) may be applied to a codebook-based PUSCH scheduled as 7 layers.

DMRS ports corresponding to the first 3 layers of the TPMI may be included in a first CW, and DMRS ports corresponding to the remaining 3 layers may be included in a second CW.

PUSCH antenna ports connected to DMRS ports corresponding to the first layer, the second layer, the fourth layer, and the fifth layer of the TPMI may be 1000, 1002, 1004, and 1006, it may be noted that the PUSCH antenna ports are all included in a first coherent antenna set, and it may be understood that respective rows of the 3th TPMI having 4 layers defined in Table 24 are placed on PUSCH antenna ports 1001, 1003, 1005, and 1007 that are the first coherent antenna set, the first column of the 3th TPMI having 4 layers defined in Table 24 is placed on the first layer of the TPMI expressed by Equation (17), the second column is placed on the second layer, the third column is placed on the fourth layer, and the fourth column is placed on the fifth layer.

In addition, PUSCH antenna ports connected to DMRS ports corresponding to the third layer, the sixth layer, and the seventh layer of the TPMI may be 1001, 1003, 1005, and 1007, it may be noted that the PUSCH antenna ports are all included in a second coherent antenna set, and it may be understood that respective rows of the 3th TPMI having 3 layers defined in Table 23 are placed on PUSCH antenna ports 1000, 1002, 1004, and 1006 that are the first coherent antenna set of the TPMI expressed by Equation (17), the first column of the 3th TPMI having 3 layers defined in Table 23 is placed on the third layer of the TPMI expressed by Equation (17), the second column is placed on the sixth layer, and the third column is placed on the seventh layer.

Similarly, a partial-coherent TPMI having 2 coherent antenna sets for 7 layers may use one of the 3th and 4th TPMIs having 4 layers defined in Table 24 and one of the 3th to 6th TPMIs having 3 layers defined in Table 23 and be made by placing the rows of each TPMI on the position of a corresponding coherent antenna set, and a total of 8 TPMIs may be possible.

Equation (17) uses a predefined full-coherent 4-layer TPMI and full-coherent 3-layer TPMI of 4 transmission antennas with respect to a first layer set including the first layer, the second layer, the fourth layer, and the fifth layer and a second layer set including the third layer, the sixth layer, and the seventh layer. However, methods of expressing 7 layers by using predefined 7 full-coherent 1-layer TPMIs of 4 transmission antennas with respect to the first layer set and the second layer set, or by using 4 full-coherent 1-layer TPMIs of 4 transmission antennas and 1 full-coherent 3-layer TPMI of 4 transmission antennas may not be excluded.

In addition, any order change in three columns corresponding to the first 3 layers of the TPMI expressed by Equation (17), and any order change in four columns corresponding to the remaining 4 layers may be considered without being excluded.

As another example, the terminal and the BS may define a partial-coherent TPMI having 2 coherent antenna sets for 7 layers as shown in Equation (18) below.

$$W = \frac{1}{2 \sqrt{7}} [ \begin{matrix}1 & 0 & 0 & 1 & 1 & 0 & 0 \\ 0 & 1 & 1 & 0 & 0 & 1 & 1 \\ 1 & 0 & 0 & - 1 & 1 & 0 & 0 \\ 0 & 1 & - 1 & 0 & 0 & 1 & - 1 \\ 1 & 0 & 0 & 1 & - 1 & 0 & 0 \\ 0 & 1 & 1 & 0 & 0 & - 1 & - 1 \\ 1 & 0 & 0 & - 1 & - 1 & 0 & 0 \\ 0 & 1 & - 1 & 0 & 0 & - 1 & 1\end{matrix} ] \qquad ( 18 )$$

A TPMI expressed by Equation (18) may be applied to a codebook-based PUSCH scheduled as 7 layers.

DMRS ports corresponding to the first 3 layers of the TPMI may be included in a first CW, and DMRS ports corresponding to the remaining 4 layers may be included in a second CW.

PUSCH antenna ports connected to DMRS ports corresponding to the first layer, the fourth layer, and the fifth layer of the TPMI may be 1000, 1002, 1004, and 1006, it may be noted that the PUSCH antenna ports are all included in a first coherent antenna set, and it may be understood that respective rows of the 3th TPMI having 3 layers defined in Table 23 are placed on PUSCH antenna ports 1000, 1002, 1004, and 1006 that are the first coherent antenna set, the first column of the 3th TPMI having 3 layers defined in Table 23 is placed on the first layer of the TPMI expressed by Equation (18), the second column is placed on the fourth layer, and the third column is placed on the fifth layer.

In addition, PUSCH antenna ports connected to DMRS ports corresponding to the second layer, the third layer, the sixth layer, and the seventh layer of the TPMI may be 1001, 1003, 1005, and 1007, it may be noted that the PUSCH antenna ports are all included in a second coherent antenna set, and it may be understood that respective rows of the 3th TPMI having 4 layers defined in Table 24 are placed on PUSCH antenna ports 1000, 1002, 1004, and 1006 that is the expressed first coherent antenna set of the TPMI, the first column of the 3th TPMI having 4 layers defined in Table 24 is placed on the second layer of the TPMI expressed by Equation (18), the second column is placed on the third layer, the third column is placed on the sixth layer, and the fourth column is placed on the seventh layer.

Similarly, a partial-coherent TPMI having 2 coherent antenna sets for 7 layers may use one of the 3th to 6th TPMIs having 3 layers defined in Table 23 and one of the 3th and 4th TPMIs having 4 layers defined in Table 24 and be made by placing the rows of each TPMI on the position of a corresponding coherent antenna set, and a total of 8 TPMIs may be possible.

Equation (18) uses a predefined full-coherent 3-layer TPMI and full-coherent 4-layer TPMI of 4 transmission antennas with respect to a first layer set including the first layer, the fourth layer, and the fifth layer and a second layer set including the second layer, the third layer, the sixth layer, and the seventh layer. However, methods of expressing 7 layers by using predefined 7 full-coherent 1-layer TPMIs of 4 transmission antennas with respect to the first layer set and the second layer set, or by using 3 full-coherent 1-layer TPMIs of 4 transmission antennas and 1 full-coherent 4-layer TPMI of 4 transmission antennas may not be excluded.

In addition, any order change in three columns corresponding to the first 3 layers of the TPMI expressed by Equation (18), and any order change in four columns corresponding to the remaining 4 layers may be considered without being excluded.

Similarly, the terminal and the BS may define, for example, a partial-coherent TPMI having 2 coherent antenna sets for 8 layers as shown in Equation (19) below.

$$W = \frac{1}{4 \sqrt{2}} [ \begin{matrix}1 & 1 & 0 & 0 & 1 & 1 & 0 & 0 \\ 0 & 0 & 1 & 1 & 0 & 0 & 1 & 1 \\ 1 & - 1 & 0 & 0 & 1 & - 1 & 0 & 0 \\ 0 & 0 & 1 & - 1 & 0 & 0 & 1 & - 1 \\ 1 & 1 & 0 & 0 & - 1 & - 1 & 0 & 0 \\ 0 & 0 & 1 & 1 & 0 & 0 & - 1 & - 1 \\ 1 & - 1 & 0 & 0 & - 1 & 1 & 0 & 0 \\ 0 & 0 & 1 & - 1 & 0 & 0 & - 1 & 1\end{matrix} ] \qquad ( 19 )$$

A TPMI expressed by Equation (19) may be applied to a codebook-based PUSCH scheduled as 8 layers.

DMRS ports corresponding to the first 4 layers of the TPMI may be included in a first CW, PUSCH antenna ports corresponding to the DMRS ports may be 1000, 1002, 1004, and 1006, it may be noted that the PUSCH antenna ports are all included in a first coherent antenna set, and it may be understood that respective rows of the 3th TPMI having 4 layers defined in Table 24 are placed on PUSCH antenna ports 1000, 1002, 1004, and 1006 that are the first coherent antenna set.

DMRS ports corresponding to the remaining 4 layers of the TPMI may be included in a second CW, PUSCH antenna ports corresponding to the DMRS ports may be 1001, 1003, 1005, and 1007, it may be noted that the PUSCH antenna ports are all included in a second coherent antenna set, and it may be understood that respective rows of the 3th TPMI having 4 layers defined in Table 24 are placed on PUSCH antenna ports 1001, 1003, 1005, and 1007 that is the second coherent antenna set.

Similarly, a partial-coherent TPMI having 2 coherent antenna sets for 8 layers may use the 3th and 4th TPMIs defined in Table 24 for the respective coherent antenna sets and be made by placing the rows of each TPMI on the position of a corresponding coherent antenna set, and a total of 4 TPMIs may be possible.

Equation (19) uses a predefined full-coherent 4-layer TPMI and full-coherent 4-layer TPMI of 4 transmission antennas with respect to the first 4 layers and the remaining 4 layers. However, methods of expressing 8 layers by using a predefined 8 full-coherent 1-layer TPMIs of 4 transmission antennas with respect to the first 4 layers and the remaining 4 layers, or by using 4 full-coherent 1-layer TPMIs of 4 transmission antennas and 1 full-coherent 4-layer TPMI of 4 transmission antennas may not be excluded.

In addition, according to an embodiment of the disclosure, any order change in fourth columns corresponding to the first 4 layers of the TPMI expressed by Equation (19), and any order change in fourth columns corresponding to the remaining 4 layers may be considered without being excluded.

5-layer, 6-layer, 7-layer, and 8-layer TPMIs expressed by Equations (12) to (19) may include, when the terminal performs PUSCH transmission of 5 or more layers, PUSCH antenna ports corresponding to a first coherent antenna set and a second coherent antenna set in each CW (e.g., according to [Partial coherent antenna set combination 1-1], PUSCH antenna ports 1000, 1002, 1004, and 1006 that are a first coherent antenna set and PUSCH antenna ports 1001, 1003, 1005, and 1007 that are a second PUSCH antenna set may be included). In this case, if the terminal has received PTRS transmission-related higher layer signaling from the BS and 2 is configured as the number of maximally transmittable PTRS ports by the BS through higher layer signaling, when interpreting a PTRS-DMRS association field in DCI receivable from the BS, the terminal may consider the following method.

### PTRS-DMRS Association Method 2-2-1

If, as described above, higher layer signaling indicating that PUSCH transmission based on 2 CWs, that is PUSCH transmission configured by 5 or more layers is possible is configured for the terminal by the BS, the terminal has received DCI scheduling PUSCH transmission of 5 or more layers from the BS, and a TPMI defined as shown in method 2-2 is indicated through the same DCI, the terminal may expect that PUSCH antenna ports in two coherent antenna sets are all included in each CW. When a DMRS port connectable to one PTRS port is selected through a PTRS-DMRS association field in the DCI, the terminal may compare two MCS fields in the DCI to select a CW having a higher MCS among two CWs and select one of DMRS ports in the CW. If MCSs for the two CWs are the same, the PTRS port may select one of DMRS ports existing in a first CW. The terminal may connect 2 PTRS ports to particular DMRS ports according to the meaning of each codepoint of a PTRS-DMRS association field of Table 53 below defined by 2 bits, and use same at the time of PUSCH transmission. The terminal and the BS may define the meaning of each codepoint of a PTRS-DMRS association field as shown in Table 53.

TABLE 53

| Value | | Value | |
|---|---|---|---|
| of MSB | DMRS port | of LSB | DMRS port |
| 0 | 1^{st} DMRS port which | 0 | 1^{st} DMRS port which |
| | shares PTRS port 0 | | shares PTRS port 1 |
| | with the CW | | with the CW |
| 1 | 2^{nd} DMRS port which | 1 | 2^{nd} DMRS port which |
| | shares PTRS port 0 | | shares PTRS port 1 |
| | with the CW | | with the CW |

In Table 53, the terminal may perform, through an MSB among two bits of a PTRS-DMRS association field in DCI, connection to a DMRS port connected to a PUSCH antenna port sharing PTRS port 0 among DMRS ports in a determined CW (e.g., a CW having a high MCS among two CWs, or a first CW if the two CWs have the same MCS), and perform, through an LSB, connection to a DMRS port connected to a PUSCH antenna port sharing PTRS port 1 among DMRS ports in the determined CW.

If a TPMI determined through method 2-2 is used, a DMRS port corresponding to a particular coherent antenna set is allocable in each CW to the terminal in numbers corresponding to a maximum of 2. Therefore, as shown in Table 53, the terminal may select DMRS ports connected to PTRS port 0 and 1 in one CW through one MSB and one LSB.

If the BS defines a PTRS-DMRS association field in DCI, based on [PTRS-DMRS association method 2-2-1], while DCI overhead is maintained by consuming 2 bits, compared to a case of a maximum number of PTRS ports being 1, the BS may indicate a connection relation with 2 PTRS ports for all DMRS ports in each CW. Therefore, the BS may secure a high degree of freedom for scheduling.

When the terminal supports 4 transmission antennas, DMRS ports corresponding to different coherent antenna sets may be included in one CW even at the time of partial-coherent PUSCH transmission for a maximum of 4 layers. In method 2-2, when the terminal supports 8 transmission antennas, the terminal may perform partial-coherent PUSCH transmission of 5 or more layers, similarly to maximum 4-layer partial coherent PUSCH transmission, after including DMRS ports corresponding to different coherent antenna sets in one CW. Therefore, when the BS performs channel estimation for the PUSCH, the BS may use an implementation scheme similar to when receiving partial-coherent PUSCH transmission for a maximum of 4 layers from the terminal, and when the BS indicates which DMRS ports to which 2 PTRS ports are connected, it is enough to indicate a connection relation only for 2 DMRS ports in a particular CW, and thus reduction of DCI overhead is possible.

### Another Method of PTRS-DMRS Connection at Time of PUSCH Transmission by 8TX Partial-Coherent Terminal

According to an embodiment of the disclosure, when a terminal supports 8 transmission antennas and supports partial coherent UL transmission in which a total of 4 antenna sets capable of coherent transmission, each set including 2 antennas may exist, a method of connecting a PTRS and a DMRS at the time of PUSCH transmission by the terminal is provided. This embodiment may be operated in combination with all of other embodiments of the disclosure.

Which set of PUSCH antenna ports is connected to which PTRS port and is able to share phase error information estimated when the PTRS port is received by the BS may be fixedly defined by the terminal and the BS in a specification, may be configured for the terminal by the BS through higher layer signaling, may be activated through a MAC-CE, may be indicated through L1 signaling, and may be notified through a combination of at least one of higher layer signaling, MAC-CE, and L1 signaling.

If the terminal and the BS fixedly define a connection relation between a PTRS port and a PUSCH antenna port set in a specification, the terminal and the BS may assume that a set configured by PUSCH antenna ports 1000, 1002, 1004, and 1006 is connected to PTRS port 0 so that phase error information estimated when the PTRS port is received by the BS is sharable between respective ports of the PUSCH antenna port set, and may assume that a set configured by PUSCH antenna ports 1001, 1003, 1005, and 1007 may have a relation similar to the above relation with PTRS port 1. In this case, although the terminal defines the coherency between PUSCH antenna ports by considering one of [Partial coherent antenna set combination 2-1] to [Partial coherent antenna set combination 2-4], when connection with a particular PTRS port and information sharing are considered, the terminal may assume that even coherent antenna sets assumable to be not coherent to each other are able to share a particular PTRS port. For example, even if the terminal has four coherent antenna sets, the terminal may define a connection relation between a PTRS port and a PUSCH antenna port set by considering one of [Partial coherent antenna set combination 1-1] to [Partial coherent antenna set combination 1-4].

As another method, when the terminal defines a relation between a PTRS port and a PUSCH antenna port set as described above, the terminal may use one of [Partial coherent antenna set combination 2-1] to [Partial coherent antenna set combination 2-4] or use other set combinations. If [Partial coherent antenna set combination 2-1] is used, it may be assumed that PUSCH antenna ports 1000 and 1002 that are a first coherent antenna set and PUSCH antenna ports 1004 and 1006 that are a second coherent antenna set are all connected to PTRS port 0 and may share information on the PTRS port, and PUSCH antenna ports 1001 and 1003 that are a third coherent antenna set and PUSCH antenna ports 1005 and 1007 that are a fourth coherent antenna set are all connected to PTRS port 1 and may share information on the PTRS port.

If the terminal has received PTRS transmission-related higher layer signaling from the BS and 2 is configured as the number of maximally transmittable PTRS ports by the BS through higher layer signaling, when interpreting a PTRS-DMRS association field in DCI receivable from the BS, the terminal may consider the following method.

If the terminal supports partial coherent UL transmission in which a total of 4 antenna sets capable of coherent transmission may exist, the terminal may identify the connectivity between a PUSCH antenna port and a DMRS port according to an indicated TPMI structure. For example, if the terminal receives a scheduling for PUSCH transmission configured by 8 layers from the BS, 4 DMRS ports may be included in a first CW and 4 DMRS ports may be included also in a second CW. The 4 DMRS ports in each CW may all correspond to a single coherent antenna set, and some of the 4 DMRS ports in each CW may correspond to a particular coherent antenna set and the remaining some of the 4 DMRS ports may correspond to another particular coherent antenna set. If the two types of situations are generalized for 5 or more layers, the following description may be given.

### Method 3-1

At the time of PUSCH transmission of 5 or more layers, the terminal and the BS may define a TPMI so that DMRS ports corresponding to 2 coherent antenna sets are allocatable in each CW. As items required to be considered when a TPMI is configured, a combination of at least one of the following items may be considered.

The terminal may consider a scheme of combining coherent antenna ports among PUSCH antenna ports, i.e., one of [Partial coherent antenna set combination 1-1] to [Partial coherent antenna set combination 1-4] and [Partial coherent antenna set combination 2-1] to [Partial coherent antenna set combination 2-4].

When a TPMI corresponding to 8 transmission antennas is configured, a method of reusing a full-coherent TPMI predefined considering 2 transmission antennas or a method of reusing a partial-coherent TPMI predefined considering 4 transmission antennas may be considered.

A sharing relation between a set of PUSCH antenna ports and each PTRS port may be considered.

In consideration of the above items considered at the time of TPMI configuration, if, in consideration of [Partial coherent antenna set combination 2-1], PUSCH antenna ports 1000 and 1002 are included in a first coherent antenna set, PUSCH antenna ports 1004 and 1006 are included in a second coherent antenna set, PUSCH antenna ports 1001 and 1003 are included in a third coherent antenna set, and PUSCH antenna ports 1005 and 1007 are included in a fourth coherent antenna set, and a full-coherent TPMI defined considering 2 transmission antennas is reused, the terminal and the BS may define, e.g., a partial-coherent TPMI having 4 coherent antenna sets for 5 layers, as shown in Equation (20) below.

$$W = \frac{1}{\sqrt{10}} [ \begin{matrix}1 & 0 & 0 & 0 & 0 \\ 0 & 1 & 0 & 0 & 0 \\ 1 & 0 & 0 & 0 & 0 \\ 0 & 1 & 0 & 0 & 0 \\ 0 & 0 & 1 & 1 & 0 \\ 0 & 0 & 0 & 0 & 1 \\ 0 & 0 & 1 & - 1 & 0 \\ 0 & 0 & 0 & 0 & 1\end{matrix} ] \qquad ( 20 )$$

A TPMI expressed by Equation (20) may be applied to a codebook-based PUSCH scheduled as 5 layers.

DMRS ports corresponding to the first 2 layers of the TPMI may be included in a first CW, and DMRS ports corresponding to the remaining 3 layers may be included in a second CW.

PUSCH antenna ports connected to DMRS ports corresponding to the first layer of the TPMI may be 1000 and 1002, it may be noted that the PUSCH antenna ports are both included in a first coherent antenna set, and it may be understood that respective rows of the 2nd TPMI having 1 layer defined in Table 18 are placed on PUSCH antenna ports 1000 and 1002 that are the first coherent antenna set of the TPMI expressed by Equation (20), and the first column of the 2nd TPMI having 1 layer defined in Table 18 is placed on the first layer of the TPMI expressed by Equation (20).

PUSCH antenna ports connected to DMRS ports corresponding to the second layer of the TPMI may be 1001 and 1003, it may be noted that the PUSCH antenna ports are both included in a third coherent antenna set, and it may be understood that respective rows of the 2nd TPMI having 1 layer defined in Table 18 are placed on PUSCH antenna ports 1001 and 1003 that are the third coherent antenna set of the TPMI expressed by Equation (20), and the first column of the 2nd TPMI having 1 layer defined in Table 18 is placed on the second layer of the TPMI expressed by Equation (20).

PUSCH antenna ports connected to DMRS ports corresponding to the third layer and the fourth layer of the TPMI may be 1004 and 1006, it may be noted that the PUSCH antenna ports are both included in a second coherent antenna set, and it may be understood that respective rows of the 1st TPMI having 2 layers defined in Table 21 are placed on PUSCH antenna ports 1005 and 1007 that are the second coherent antenna set of the TPMI expressed by Equation (20), the first column of the 1st TPMI having 2 layers defined in Table 21 is placed on the third layer of the TPMI expressed by Equation (20), and the second column is placed on the fourth layer.

PUSCH antenna ports connected to DMRS ports corresponding to the fifth layer of the TPMI may be 1005 and 1007, it may be noted that the PUSCH antenna ports are both included in a fourth coherent antenna set, and it may be understood that respective rows of the 2nd TPMI having 1 layer defined in Table 18 are placed on PUSCH antenna ports 1005 and 1007 that are the fourth coherent antenna set of the TPMI expressed by Equation (20), and the first column of the 2nd TPMI having 1 layer defined in Table 18 is placed on the fifth layer of the TPMI expressed by Equation (20).

According to an embodiment of the disclosure, a partial-coherent TPMI having 4 coherent antenna sets for 5 layers may use one of the 2nd to 5th TPMIs defined in Table 18 for each of the first coherent antenna set, the third coherent antenna set, and the fourth coherent antenna set and use one of the 1st and 2nd TPMIs defined in Table 21 for the second coherent antenna set and be made by placing the rows of each TPMI on the position of a corresponding coherent antenna set, and a total of 128 TPMIs may be possible.

Equation (20) uses a predefined full-coherent 1-layer TPMI of 2 transmission antennas with respect to a first layer set including the first layer, a second layer set including the second layer, and a fourth layer set including the fifth layer, and uses a predefined full-coherent 2-layer TPMI of 2 transmission antennas with respect to a third layer set including the third layer and the fourth layer. However, methods of using predefined 2 full-coherent 1-layer TPMIs of 2 transmission antennas with respect to the third layer set may also be considered without being excluded.

In addition, any order change in two columns corresponding to the first 2 layers of the TPMI expressed by Equation (20), and any order change in three columns corresponding to the remaining 3 layers may be considered without being excluded.

According to an embodiment of the disclosure, the terminal and the BS may define a partial-coherent TPMI having 4 coherent antenna sets for 5 layers as shown in

$$W = \frac{1}{\sqrt{10}} [ \begin{matrix}1 & 0 & 0 & 0 & 0 \\ 0 & 1 & 0 & 0 & 0 \\ 1 & 0 & 0 & 0 & 0 \\ 0 & 1 & 0 & 0 & 0 \\ 0 & 0 & 1 & 0 & 0 \\ 0 & 0 & 0 & 1 & 1 \\ 0 & 0 & 1 & 0 & 0 \\ 0 & 0 & 0 & 1 & - 1\end{matrix} ] \qquad ( 21 )$$

A TPMI expressed by Equation (21) may be applied to a codebook-based PUSCH scheduled as 5 layers.

DMRS ports corresponding to the first 2 layers of the TPMI may be included in a first CW, and DMRS ports corresponding to the remaining 3 layers may be included in a second CW.

PUSCH antenna ports connected to DMRS ports corresponding to the first layer of the TPMI may be 1000 and 1002, it may be noted that the PUSCH antenna ports are both included in a first coherent antenna set, and it may be understood that respective rows of the 2nd TPMI having 1 layer defined in Table 18 are placed on PUSCH antenna ports 1000 and 1002 that are the first coherent antenna set of the TPMI expressed by Equation (21), and the first column of the 2nd TPMI having 1 layer defined in Table 18 is placed on the first layer of the TPMI expressed by Equation (21).

PUSCH antenna ports connected to DMRS ports corresponding to the second layer of the TPMI may be 1001 and 1003, it may be noted that the PUSCH antenna ports are both included in a third coherent antenna set, and it may be understood that respective rows of the 2nd TPMI having 1 layer defined in Table 18 are placed on PUSCH antenna ports 1001 and 1003 that are the third coherent antenna set of the TPMI expressed by Equation (21), and the first column of the 2nd TPMI having 1 layer defined in Table 18 is placed on the second layer of the TPMI expressed by Equation (21).

PUSCH antenna ports connected to DMRS ports corresponding to the third layer of the TPMI may be 1004 and 1006, it may be noted that the PUSCH antenna ports are both included in a second coherent antenna set, and it may be understood that respective rows of the 2nd TPMI having 1 layer defined in Table 18 are placed on PUSCH antenna ports 1004 and 1006 that are the second coherent antenna set of the TPMI expressed by Equation (21), and the first column of the 2nd TPMI having 1 layer defined in Table 18 is placed on the third layer of the TPMI expressed by Equation (21).

PUSCH antenna ports connected to DMRS ports corresponding to the fourth layer and the fifth layer of the TPMI may be 1005 and 1007, it may be noted that the PUSCH antenna ports are both included in a fourth coherent antenna set, and it may be understood that respective rows of the 1st TPMI having 2 layers defined in Table 21 are placed on PUSCH antenna ports 1005 and 1007 that are the fourth coherent antenna set of the TPMI expressed by Equation (21), the first column of the 1st TPMI having 2 layers defined in Table 21 is placed on the fourth layer of the TPMI expressed by Equation (21), and the second column is placed on the fifth layer.

Similarly, a partial-coherent TPMI having 4 coherent antenna sets for 5 layers may use one of the 2nd to 5th TPMIs defined in Table 18 for each of the first coherent antenna set, the second coherent antenna set, and the third coherent antenna set and use one of the 1st and 2nd TPMIs defined in Table 21 for the fourth coherent antenna set and be made by placing the rows of each TPMI on the position of a corresponding coherent antenna set, and a total of 128 TPMIs may be possible.

Equation (21) uses a predefined full-coherent 1-layer TPMI of 2 transmission antennas with respect to a first layer set including the first layer, a second layer set including the second layer, and a third layer set including the third layer, and uses a predefined full-coherent 2-layer TPMI of 2 transmission antennas with respect to a fourth layer set including the fourth layer and the fifth layer. However, methods of using predefined 2 full-coherent 1-layer TPMIs of 2 transmission antennas with respect to the fourth layer set may also be considered without being excluded.

In addition, any order change in two columns corresponding to the first 2 layers of the TPMI expressed by Equation (21), and any order change in three columns corresponding to the remaining 3 layers may be considered without being excluded.

According to an embodiment of the disclosure, the terminal and the BS may define a partial-coherent TPMI having 4 coherent antenna sets for 6 layers as shown in Equation (22) below.

$$W = \frac{1}{\sqrt{10}} [ \begin{matrix}1 & 1 & 0 & 0 & 0 & 0 \\ 0 & 0 & 1 & 0 & 0 & 0 \\ 1 & - 1 & 0 & 0 & 0 & 0 \\ 0 & 0 & 1 & 0 & 0 & 0 \\ 0 & 0 & 0 & 1 & 1 & 0 \\ 0 & 0 & 0 & 0 & 0 & 1 \\ 0 & 0 & 0 & 1 & - 1 & 0 \\ 0 & 0 & 0 & 0 & 0 & 1\end{matrix} ] \qquad ( 22 )$$

A TPMI expressed by Equation (22) may be applied to a codebook-based PUSCH scheduled as 6 layers.

DMRS ports corresponding to the first 3 layers of the TPMI may be included in a first CW, and DMRS ports corresponding to the remaining 3 layers may be included in a second CW.

PUSCH antenna ports connected to DMRS ports corresponding to the first layer and the second layer of the TPMI may be 1000 and 1002, it may be noted that the PUSCH antenna ports are both included in a first coherent antenna set, and it may be understood that respective rows of the 1st TPMI having 2 layers defined in Table 21 are placed on PUSCH antenna ports 1000 and 1002 that are the first coherent antenna set of the TPMI expressed by Equation (22), the first column of the 1st TPMI having 2 layers defined in Table 21 is placed on the first layer of the TPMI expressed by Equation (22), and the second column is placed on the second layer.

PUSCH antenna ports connected to DMRS ports corresponding to the third layer of the TPMI may be 1001 and 1003, it may be noted that the PUSCH antenna ports are both included in a third coherent antenna set, and it may be understood that respective rows of the 2nd TPMI having 1 layer defined in Table 18 are placed on PUSCH antenna ports 1001 and 1003 that are the third coherent antenna set of the TPMI expressed by Equation (22), and the first column of the 2nd TPMI having 1 layer defined in Table 18 is placed on the third layer of the TPMI expressed by Equation (22).

PUSCH antenna ports connected to DMRS ports corresponding to the fourth layer and the fifth layer of the TPMI may be 1004 and 1006, it may be noted that the PUSCH antenna ports are both included in a second coherent antenna set, and it may be understood that respective rows of the 1st TPMI having 2 layers defined in Table 21 are placed on PUSCH antenna ports 1004 and 1006 that are the second coherent antenna set of the TPMI expressed by Equation (22), the first column of the 1st TPMI having 2 layers defined in Table 21 is placed on the fourth layer of the TPMI expressed by Equation (22), and the second column is placed on the fifth layer.

PUSCH antenna ports connected to DMRS ports corresponding to the sixth layer of the TPMI may be 1005 and 1007, it may be noted that the PUSCH antenna ports are both included in a fourth coherent antenna set, and it may be understood that respective rows of the 2nd TPMI having 1 layer defined in Table 18 are placed on PUSCH antenna ports 1005 and 1007 that are the fourth coherent antenna set of the TPMI expressed by Equation (22), and the first column of the 2nd TPMI having 1 layer defined in Table 18 is placed on the sixth layer of the TPMI expressed by Equation (22).

Similarly, a partial-coherent TPMI having 4 coherent antenna sets for 6 layers may use one of the 2nd to 5th TPMIs defined in Table 18 for each of the third coherent antenna set and the fourth coherent antenna set and use one of the 1st and 2nd TPMIs defined in Table 21 for the first coherent antenna set and the second coherent antenna set and be made by placing the rows of each TPMI on the position of a corresponding coherent antenna set, and a total of 64 TPMIs may be possible.

Equation (22) uses a predefined full-coherent 2-layer TPMI of 2 transmission antennas with respect to a first layer set including the first layer and the second layer and a third layer set including the fourth layer and the fifth layer and uses an existing full-coherent 1-layer TPMI of 2 transmission antennas with respect to a second layer set including the third layer and a fourth layer set including the sixth layer. However, methods of using predefined 6 full-coherent 1-layer TPMIs of 2 transmission antennas with respect to the first layer set, the second layer set, the third layer set, and the fourth layer set may also be considered without being excluded.

In addition, any order change in two columns corresponding to the first 3 layers of the TPMI expressed by Equation (22), and any order change in three columns corresponding to the remaining 3 layers may be considered without being excluded.

As another example, the terminal and the BS may define a partial-coherent TPMI having 4 coherent antenna sets for 6 layers as shown in Equation (23) below.

$$W = \frac{1}{\sqrt{10}} [ \begin{matrix}1 & 1 & 0 & 0 & 0 & 0 \\ 0 & 0 & 1 & 0 & 0 & 0 \\ 1 & - 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 1 \\ 0 & 0 & 0 & 1 & 0 & 0 \\ 0 & 0 & 0 & 0 & - 1 & 1\end{matrix} ] \qquad ( 23 )$$

A TPMI expressed by Equation (23) may be applied to a codebook-based PUSCH scheduled as 6 layers.

DMRS ports corresponding to the first 3 layers of the TPMI may be included in a first CW, and DMRS ports corresponding to the remaining 3 layers may be included in a second CW.

PUSCH antenna ports connected to DMRS ports corresponding to the first layer and the second layer of the TPMI may be 1000 and 1002, it may be noted that the PUSCH antenna ports are both included in a first coherent antenna set, and it may be understood that respective rows of the 1st TPMI having 2 layers defined in Table 21 are placed on PUSCH antenna ports 1000 and 1002 that are the first coherent antenna set of the TPMI expressed by Equation (23), the first column of the 1st TPMI having 2 layers defined in Table 21 is placed on the first layer of the TPMI expressed by Equation (23), and the second column is placed on the second layer.

PUSCH antenna ports connected to DMRS ports corresponding to the third layer of the TPMI may be 1001 and 1003, it may be noted that the PUSCH antenna ports are both included in a third coherent antenna set, and it may be understood that respective rows of the 2nd TPMI having 1 layer defined in Table 18 are placed on PUSCH antenna ports 1001 and 1003 that are the third coherent antenna set of the TPMI expressed by Equation (23), and the first column of the 2nd TPMI having 1 layer defined in Table 18 is placed on the third layer of the TPMI expressed by Equation (23).

PUSCH antenna ports connected to DMRS ports corresponding to the fourth layer of the TPMI may be 1004 and 1006, it may be noted that the PUSCH antenna ports are both included in a second coherent antenna set, and it may be understood that respective rows of the 2nd TPMI having 1 layer defined in Table 18 are placed on PUSCH antenna ports 1004 and 1006 that are the second coherent antenna set of the TPMI expressed by Equation (23), and the first column of the 2nd TPMI having 1 layer defined in Table 18 is placed on the fourth layer of the TPMI expressed by Equation (23).

PUSCH antenna ports connected to DMRS ports corresponding to the fifth layer and the sixth layer of the TPMI may be 1005 and 1007, it may be noted that the PUSCH antenna ports are both included in a fourth coherent antenna set, and it may be understood that respective rows of the 1st TPMI having 2 layers defined in Table 21 are placed on PUSCH antenna ports 1005 and 1007 that are the fourth coherent antenna set of the TPMI expressed by Equation (23), the first column of the 1st TPMI having 2 layers defined in Table 21 is placed on the fifth layer of the TPMI expressed by Equation (23), and the second column is placed on the sixth layer.

Similarly, a partial-coherent TPMI having 4 coherent antenna sets for 6 layers may use one of the 2nd to 5th TPMIs defined in Table 18 for each of the third coherent antenna set and the fourth coherent antenna set and use one of the 1st and 2nd TPMIs defined in Table 21 for the first coherent antenna set and the second coherent antenna set and be made by placing the rows of each TPMI on the position of a corresponding coherent antenna set, and a total of 64 TPMIs may be possible.

Equation (23) uses a predefined full-coherent 2-layer TPMI of 2 transmission antennas with respect to a first layer set including the first layer and the second layer and a fourth layer set including the fifth layer and the sixth layer and uses an existing full-coherent 1-layer TPMI of 2 transmission antennas with respect to a second layer set including the third layer and a third layer set including the fourth layer. However, methods of using predefined 6 full-coherent 1-layer TPMIs of 2 transmission antennas with respect to the first layer set, the second layer set, the third layer set, and the fourth layer set may also be considered without being excluded.

In addition, any order change in two columns corresponding to the first 3 layers of the TPMI expressed by Equation (23), and any order change in three columns corresponding to the remaining 3 layers may be considered without being excluded.

As another example, the terminal and the BS may define a partial-coherent TPMI having 4 coherent antenna sets for 6 layers as shown in Equation (24) below.

$$W = \frac{1}{2 \sqrt{3}} [ \begin{matrix}1 & 0 & 0 & 0 & 0 & 0 \\ 0 & 1 & 1 & 0 & 0 & 0 \\ 1 & 0 & 0 & 0 & 0 & 0 \\ 0 & - 1 & 1 & 0 & 0 & 0 \\ 0 & 0 & 0 & 1 & 1 & 0 \\ 0 & 0 & 0 & 0 & 0 & 1 \\ 0 & 0 & 0 & 1 & - 1 & 0 \\ 0 & 0 & 0 & 0 & 0 & 1\end{matrix} ] \qquad ( 24 )$$

A TPMI expressed by Equation (24) may be applied to a codebook-based PUSCH scheduled as 6 layers.

DMRS ports corresponding to the first 3 layers of the TPMI may be included in a first CW, and DMRS ports corresponding to the remaining 3 layers may be included in a second CW.

PUSCH antenna ports connected to DMRS ports corresponding to the first layer of the TPMI may be 1000 and 1002, it may be noted that the PUSCH antenna ports are both included in a first coherent antenna set, and it may be understood that respective rows of the 2nd TPMI having 1 layer defined in Table 18 are placed on PUSCH antenna ports 1000 and 1002 that are the first coherent antenna set of the TPMI expressed by Equation (24), and the first column of the 2nd TPMI having 1 layer defined in Table 18 is placed on the first layer of the TPMI expressed by Equation (24).

PUSCH antenna ports connected to DMRS ports corresponding to the second layer and the third layer of the TPMI may be 1001 and 1003, it may be noted that the PUSCH antenna ports are both included in a third coherent antenna set, and it may be understood that respective rows of the 1st TPMI having 2 layers defined in Table 21 are placed on PUSCH antenna ports 1001 and 1003 that are the third coherent antenna set of the TPMI expressed by Equation (24), the first column of the 1st TPMI having 2 layers defined in Table 21 is placed on the second layer of the TPMI expressed by Equation (24), and the second column is placed on the third layer.

PUSCH antenna ports connected to DMRS ports corresponding to the fourth layer and the fifth layer of the TPMI may be 1004 and 1006, it may be noted that the PUSCH antenna ports are both included in a second coherent antenna set, and it may be understood that respective rows of the 1st TPMI having 2 layers defined in Table 21 are placed on PUSCH antenna ports 1004 and 1006 that are the second coherent antenna set of the TPMI expressed by Equation (24), the first column of the 1st TPMI having 2 layers defined in Table 21 is placed on the fourth layer of the TPMI expressed by Equation (24), and the second column is placed on the fifth layer.

PUSCH antenna ports connected to DMRS ports corresponding to the sixth layer of the TPMI may be 1005 and 1007, it may be noted that the PUSCH antenna ports are both included in a fourth coherent antenna set, and it may be understood that respective rows of the 2nd TPMI having 1 layer defined in Table 18 are placed on PUSCH antenna ports 1005 and 1007 that are the fourth coherent antenna set of the TPMI expressed by Equation (24), and the first column of the 2nd TPMI having 1 layer defined in Table 18 is placed on the sixth layer of the TPMI expressed by Equation (24).

Similarly, a partial-coherent TPMI having 4 coherent antenna sets for 6 layers may use one of the 2nd to 5th TPMIs defined in Table 18 for each of the first coherent antenna set and the fourth coherent antenna set and use one of the 1st and 2nd TPMIs defined in Table 21 for the second coherent antenna set and the third coherent antenna set and be made by placing the rows of each TPMI on the position of a corresponding coherent antenna set, and a total of 64 TPMIs may be possible.

Equation (24) uses a predefined full-coherent 2-layer TPMI of 2 transmission antennas with respect to a second layer set including the second layer and the third layer and a third layer set including the fourth layer and the fifth layer and uses an existing full-coherent 1-layer TPMI of 2 transmission antennas with respect to a first layer set including the first layer and a fourth layer set including the sixth layer. However, methods of using predefined 6 full-coherent 1-layer TPMIs of 2 transmission antennas with respect to the first layer set, the second layer set, the third layer set, and the fourth layer set may also be considered without being excluded.

In addition, any order change in two columns corresponding to the first 3 layers of the TPMI expressed by Equation (24), and any order change in three columns corresponding to the remaining 3 layers may be considered without being excluded.

As another example, the terminal and the BS may define a partial-coherent TPMI having 4 coherent antenna sets for 6 layers as shown in Equation (25) below.

$$W = \frac{1}{2 \sqrt{3}} [ \begin{matrix}1 & 0 & 0 & 0 & 0 & 0 \\ 0 & 1 & 1 & 0 & 0 & 0 \\ 1 & 0 & 0 & 0 & 0 & 0 \\ 0 & 1 & - 1 & 0 & 0 & 0 \\ 0 & 0 & 0 & 1 & 0 & 0 \\ 0 & 0 & 0 & 0 & 1 & 1 \\ 0 & 0 & 0 & 1 & 0 & 0 \\ 0 & 0 & 0 & 0 & 1 & - 1\end{matrix} ] \qquad ( 25 )$$

A TPMI expressed by Equation (25) may be applied to a codebook-based PUSCH scheduled as 6 layers.

DMRS ports corresponding to the first 3 layers of the TPMI may be included in a first CW, and DMRS ports corresponding to the remaining 3 layers may be included in a second CW.

PUSCH antenna ports connected to DMRS ports corresponding to the first layer of the TPMI may be 1000 and 1002, it may be noted that the PUSCH antenna ports are both included in a first coherent antenna set, and it may be understood that respective rows of the 2nd TPMI having 1 layer defined in Table 18 are placed on PUSCH antenna ports 1000 and 1002 that are the first coherent antenna set of the TPMI expressed by Equation (25), and the first column of the 2nd TPMI having 1 layer defined in Table 18 is placed on the first layer of the TPMI expressed by Equation (25).

PUSCH antenna ports connected to DMRS ports corresponding to the second layer and the third layer of the TPMI may be 1001 and 1003, it may be noted that the PUSCH antenna ports are both included in a third coherent antenna set, and it may be understood that respective rows of the 1st TPMI having 2 layers defined in Table 21 are placed on PUSCH antenna ports 1001 and 1003 that are the third coherent antenna set of the TPMI expressed by Equation (25), the first column of the 1st TPMI having 2 layers defined in Table 21 is placed on the second layer of the TPMI expressed by Equation (25), and the second column is placed on the third layer.

PUSCH antenna ports connected to DMRS ports corresponding to the fourth layer of the TPMI may be 1004 and 1006, it may be noted that the PUSCH antenna ports are both included in a second coherent antenna set, and it may be understood that respective rows of the 2nd TPMI having 1 layer defined in Table 18 are placed on PUSCH antenna ports 1004 and 1006 that are the second coherent antenna set of the TPMI expressed by Equation (25), and the first column of the 2nd TPMI having 1 layer defined in Table 18 is placed on the fourth layer of the TPMI expressed by Equation (25).

PUSCH antenna ports connected to DMRS ports corresponding to the fifth layer and the sixth layer of the TPMI may be 1005 and 1007, it may be noted that the PUSCH antenna ports are both included in a fourth coherent antenna set, and it may be understood that respective rows of the 1st TPMI having 2 layers defined in Table 21 are placed on PUSCH antenna ports 1005 and 1007 that are the fourth coherent antenna set of the TPMI expressed by Equation (25), the first column of the 1st TPMI having 2 layers defined in Table 21 is placed on the fifth layer of the TPMI expressed by Equation (25), and the second column is placed on the sixth layer.

Similarly, a partial-coherent TPMI having 4 coherent antenna sets for 6 layers may use one of the 1st to 5th TPMIs defined in Table 18 for each of the first coherent antenna set and the second coherent antenna set and use one of the 1st and 2nd TPMIs defined in Table 21 for the third coherent antenna set and the fourth coherent antenna set and be made by placing the rows of each TPMI on the position of a corresponding coherent antenna set, and a total of 64 TPMIs may be possible.

Equation (25) uses a predefined full-coherent 2-layer TPMI of 2 transmission antennas with respect to a second layer set including the second layer and the third layer and a fourth layer set including the fifth layer and the sixth layer and uses an existing full-coherent 1-layer TPMI of 2 transmission antennas with respect to a first layer set including the first layer and a third layer set including the fourth layer. However, methods of using predefined 6 full-coherent 1-layer TPMIs of 2 transmission antennas with respect to the first layer set, the second layer set, the third layer set, and the fourth layer set may also be considered without being excluded.

In addition, any order change in two columns corresponding to the first 3 layers of the TPMI expressed by Equation (25), and any order change in three columns corresponding to the remaining 3 layers may be considered without being excluded.

Similarly, the terminal and the BS may define, for example, a partial-coherent TPMI having 4 coherent antenna sets for 7 layers as shown in Equation (26) below.

$$W = \frac{1}{\sqrt{14}} [ \begin{matrix}1 & 1 & 0 & 0 & 0 & 0 & 0 \\ 0 & 0 & 1 & 0 & 0 & 0 & 0 \\ 1 & - 1 & 0 & 0 & 0 & 0 & 0 \\ 0 & 0 & 1 & 0 & 0 & 0 & 0 \\ 0 & 0 & 0 & 1 & 1 & 0 & 0 \\ 0 & 0 & 0 & 0 & 0 & 1 & 1 \\ 0 & 0 & 0 & 1 & - 1 & 0 & 0 \\ 0 & 0 & 0 & 0 & 0 & 1 & - 1\end{matrix} ] \qquad ( 26 )$$

A TPMI expressed by Equation (26) may be applied to a codebook-based PUSCH scheduled as 7 layers.

DMRS ports corresponding to the first 3 layers of the TPMI may be included in a first CW, and DMRS ports corresponding to the remaining 4 layers may be included in a second CW.

PUSCH antenna ports connected to DMRS ports corresponding to the first layer and the second layer of the TPMI may be 0 and 2, it may be noted that the PUSCH antenna ports are both included in a first coherent antenna set, and it may be understood that respective rows of the 1st TPMI having 2 layers defined in Table 21 are placed on PUSCH antenna ports 0 and 2 that are the first coherent antenna set of the TPMI expressed by Equation (26), the first column of the 1st TPMI having 2 layers defined in Table 21 is placed on the first layer of the TPMI expressed by Equation (26), and the second column is placed on the second layer.

PUSCH antenna ports connected to DMRS ports corresponding to the third layer of the TPMI may be 1 and 3, it may be noted that the PUSCH antenna ports are both included in a third coherent antenna set, and it may be understood that respective rows of the 2nd TPMI having 1 layer defined in Table 18 are placed on PUSCH antenna ports 1 and 3 that are the third coherent antenna set of the TPMI expressed by Equation (26), and the first column of the 2nd TPMI having 1 layer defined in Table 18 is placed on the third layer of the TPMI expressed by Equation (26).

PUSCH antenna ports connected to DMRS ports corresponding to the fourth layer and the fifth layer of the TPMI may be 4 and 6, it may be noted that the PUSCH antenna ports are both included in a second coherent antenna set, and it may be understood that respective rows of the 1st TPMI having 2 layers defined in Table 21 are placed on PUSCH antenna ports 4 and 6 that are the second coherent antenna set of the TPMI expressed by Equation (26), the first column of the 1st TPMI having 2 layers defined in Table 21 is placed on the fourth layer of the TPMI expressed by Equation (26), and the second column is placed on the fifth layer.

PUSCH antenna ports connected to DMRS ports corresponding to the sixth layer and the seventh layer of the TPMI may be 5 and 7, it may be noted that the PUSCH antenna ports are both included in a fourth coherent antenna set, and it may be understood that respective rows of the 2nd TPMI having 1 layer defined in Table 18 are placed on PUSCH antenna ports 5 and 7 that are the fourth coherent antenna set of the TPMI expressed by Equation (26), the first column of the 2nd TPMI having 1 layer defined in Table 18 is placed on the sixth layer of the TPMI expressed by Equation (26), and the second column is placed on the seventh layer.

Similarly, a partial-coherent TPMI having 4 coherent antenna sets for 7 layers may use one of the 2nd to 5th TPMIs defined in Table 18 for the third coherent antenna set and use one of the 1st and 2nd TPMIs defined in Table 21 for the first coherent antenna set, the second coherent antenna set, and the fourth coherent antenna set and be made by placing the rows of each TPMI on the position of a corresponding coherent antenna set, and a total of 32 TPMIs may be possible.

Equation (26) uses a predefined full-coherent 2-layer TPMI of 2 transmission antennas with respect to a first layer set including the first layer and the second layer, a third layer set including the fourth layer and the fifth layer, and a fourth layer set including the sixth layer and the seventh layer and uses an existing full-coherent 1-layer TPMI of 2 transmission antennas with respect to a second layer set including the third layer. However, methods of using predefined 7 full-coherent 1-layer TPMIs of 2 transmission antennas with respect to the first layer set, the second layer set, the third layer set, and the fourth layer set may also be considered without being excluded.

In addition, any order change in two columns corresponding to the first 3 layers of the TPMI expressed by Equation (26), and any order change in three columns corresponding to the remaining 4 layers may be considered without being excluded.

As another example, the terminal and the BS may define a partial-coherent TPMI having 4 coherent antenna sets for 7 layers as shown in Equation (27) below.

$$W = \frac{1}{\sqrt{14}} [ \begin{matrix}1 & 0 & 0 & 0 & 0 & 0 & 0 \\ 0 & 1 & 1 & 0 & 0 & 0 & 0 \\ 1 & 0 & 0 & 0 & 0 & 0 & 0 \\ 0 & 1 & - 1 & 0 & 0 & 0 & 0 \\ 0 & 0 & 0 & 1 & 1 & 0 & 0 \\ 0 & 0 & 0 & 0 & 0 & 1 & 1 \\ 0 & 0 & 0 & 1 & - 1 & 0 & 0 \\ 0 & 0 & 0 & 0 & 0 & 1 & - 1\end{matrix} ] \qquad ( 27 )$$

A TPMI expressed by Equation (27) may be applied to a codebook-based PUSCH scheduled as 7 layers.

DMRS ports corresponding to the first 3 layers of the TPMI may be included in a first CW, and DMRS ports corresponding to the remaining 4 layers may be included in a second CW.

PUSCH antenna ports connected to DMRS ports corresponding to the first layer of the TPMI may be 1000 and 1002, it may be noted that the PUSCH antenna ports are both included in a first coherent antenna set, and it may be understood that respective rows of the 2nd TPMI having 1 layer defined in Table 18 are placed on PUSCH antenna ports 1000 and 1002 that are the first coherent antenna set of the TPMI expressed by Equation (27), and the first column of the 2nd TPMI having 1 layer defined in Table 18 is placed on the first layer of the TPMI expressed by Equation (27).

PUSCH antenna ports connected to DMRS ports corresponding to the second layer and the third layer of the TPMI may be 1001 and 1003, it may be noted that the PUSCH antenna ports are both included in a third coherent antenna set, and it may be understood that respective rows of the 1st TPMI having 2 layers defined in Table 21 are placed on PUSCH antenna ports 1001 and 1003 that are the third coherent antenna set of the TPMI expressed by Equation (27), the first column of the 1st TPMI having 2 layers defined in Table 21 is placed on the second layer of the TPMI expressed by Equation (27), and the second column is placed on the third layer.

PUSCH antenna ports connected to DMRS ports corresponding to the fourth layer and the fifth layer of the TPMI may be 1004 and 1006, it may be noted that the PUSCH antenna ports are both included in a second coherent antenna set, and it may be understood that respective rows of the 1st TPMI having 2 layers defined in Table 21 are placed on PUSCH antenna ports 1004 and 1006 that are the second coherent antenna set of the TPMI expressed by Equation (27), the first column of the 1st TPMI having 2 layers defined in Table 21 is placed on the fourth layer of the TPMI expressed by Equation (27), and the second column is placed on the fifth layer.

PUSCH antenna ports connected to DMRS ports corresponding to the sixth layer and the seventh layer of the TPMI may be 1005 and 1007, it may be noted that the PUSCH antenna ports are both included in a fourth coherent antenna set, and it may be understood that respective rows of the 2nd TPMI having 1 layer defined in Table 18 are placed on PUSCH antenna ports 1005 and 1007 that are the fourth coherent antenna set of the TPMI expressed by Equation (27), the first column of the 2nd TPMI having 1 layer defined in Table 18 is placed on the sixth layer of the TPMI expressed by Equation (27), and the second column is placed on the seventh layer.

Similarly, a partial-coherent TPMI having 4 coherent antenna sets for 7 layers may use one of the 2nd to 5th TPMIs defined in Table 18 for the first coherent antenna set and use one of the 1st and 2nd TPMIs defined in Table 21 for the second coherent antenna set, the third coherent antenna set, and the fourth coherent antenna set and be made by placing the rows of each TPMI on the position of a corresponding coherent antenna set, and a total of 32 TPMIs may be possible.

Equation (27) uses a predefined full-coherent 2-layer TPMI of 2 transmission antennas with respect to a second layer set including the second layer and the third layer, a third layer set including the fourth layer and the fifth layer, and a fourth layer set including the sixth layer and the seventh layer and uses an existing full-coherent 1-layer TPMI of 2 transmission antennas with respect to a first layer set including the first layer. However, methods of using predefined 7 full-coherent 1-layer TPMIs of 2 transmission antennas with respect to the first layer set, the second layer set, the third layer set, and the fourth layer set may also be considered without being excluded.

In addition, any order change in two columns corresponding to the first 3 layers of the TPMI expressed by Equation (27), and any order change in three columns corresponding to the remaining 4 layers may be considered without being excluded.

Similarly, the terminal and the BS may define a partial-coherent TPMI having 4 coherent antenna sets for 8 layers as shown in Equation (28) below.

$$W = \frac{1}{4} [ \begin{matrix}1 & 1 & 0 & 0 & 0 & 0 & 0 & 0 \\ 0 & 0 & 1 & 1 & 0 & 0 & 0 & 0 \\ 1 & - 1 & 0 & 0 & 0 & 0 & 0 & 0 \\ 0 & 0 & 1 & - 1 & 0 & 0 & 0 & 0 \\ 0 & 0 & 0 & 0 & 1 & 1 & 0 & 0 \\ 0 & 0 & 0 & 0 & 0 & 0 & 1 & 1 \\ 0 & 0 & 0 & 0 & 1 & - 1 & 0 & 0 \\ 0 & 0 & 0 & 0 & 0 & 0 & 1 & - 1\end{matrix} ] \qquad ( 28 )$$

A TPMI expressed by Equation (28) may be applied to a codebook-based PUSCH scheduled as 8 layers.

DMRS ports corresponding to the first 4 layers of the TPMI may be included in a first CW, and DMRS ports corresponding to the remaining 4 layers may be included in a second CW.

PUSCH antenna ports connected to DMRS ports corresponding to the first layer and the second layer of the TPMI may be 0 and 2, it may be noted that the PUSCH antenna ports are both included in a first coherent antenna set, and it may be understood that respective rows of the 1st TPMI having 2 layers defined in Table 21 are placed on PUSCH antenna ports 0 and 2 that are the first coherent antenna set of the TPMI expressed by Equation (28), the first column of the 1st TPMI having 2 layers defined in Table 21 is placed on the first layer of the TPMI expressed by Equation (28), and the second column is placed on the second layer.

PUSCH antenna ports connected to DMRS ports corresponding to the third layer and the fourth layer of the TPMI may be 1 and 3, it may be noted that the PUSCH antenna ports are both included in a third coherent antenna set, and it may be understood that respective rows of the 1st TPMI having 2 layers defined in Table 21 are placed on PUSCH antenna ports 1 and 3 that are the second coherent antenna set of the TPMI expressed by Equation (28), the first column of the 1st TPMI having 2 layers defined in Table 21 is placed on the third layer of the TPMI expressed by Equation (28), and the second column is placed on the fourth layer.

PUSCH antenna ports connected to DMRS ports corresponding to the fifth layer and the sixth layer of the TPMI may be 4 and 6, it may be noted that the PUSCH antenna ports are both included in a second coherent antenna set, and it may be understood that respective rows of the 1st TPMI having 2 layers defined in Table 21 are placed on PUSCH antenna ports 4 and 6 that are the second coherent antenna set of the TPMI expressed by Equation (28), the first column of the 1st TPMI having 2 layers defined in Table 21 is placed on the fifth layer of the TPMI expressed by Equation (28), and the second column is placed on the sixth layer.

PUSCH antenna ports connected to DMRS ports corresponding to the seventh layer and the eighth layer of the TPMI may be 5 and 7, it may be noted that the PUSCH antenna ports are both included in a fourth coherent antenna set, and it may be understood that respective rows of the 2nd TPMI having 1 layer defined in Table 18 are placed on PUSCH antenna ports 5 and 7 that are the fourth coherent antenna set of the TPMI expressed by Equation (28), the first column of the 2nd TPMI having 1 layer defined in Table 18 is placed on the seventh layer of the TPMI expressed by Equation (28), and the second column is placed on the eighth layer.

Similarly, a partial-coherent TPMI having 4 coherent antenna sets for 8 layers may use one of the 1st and 2nd TPMIs defined in Table 21 for the first coherent antenna set, the second coherent antenna set, the third coherent antenna set, and the fourth coherent antenna set and be made by placing the rows of each TPMI on the position of a corresponding coherent antenna set, and a total of 16 TPMIs may be possible.

Equation (28) uses a predefined full-coherent 2-layer TPMI of 2 transmission antennas with respect to a first layer set including the first layer and the second layer, a second layer set including the third layer and the fourth layer, a third layer set including the fifth layer and the sixth layer, and a fourth layer set including the seventh layer and the eight layer. However, methods of using predefined 8 full-coherent 1-layer TPMIs of 2 transmission antennas with respect to the first layer set, the second layer set, the third layer set, and the fourth layer set may also be considered without being excluded.

In addition, any order change in two columns corresponding to the first 4 layers of the TPMI expressed by Equation (28), and any order change in three columns corresponding to the remaining 4 layers may be considered without being excluded.

5-layer, 6-layer, 7-layer, and 8-layer TPMIs expressed by Equation (20) to Equation (28) may include, when the terminal performs PUSCH transmission of 5 or more layers, PUSCH antenna ports corresponding to a first coherent antenna set and a third coherent antenna set in a first CW (e.g., according to [Partial coherent antenna set combination 2-1], PUSCH antenna ports 0 and 2 that are the first coherent antenna set and PUSCH antenna ports 1 and 3 that are the third coherent antenna set may be included), and include PUSCH antenna ports corresponding to a second coherent antenna set and a fourth coherent antenna set in a second CW (e.g., according to [Partial coherent antenna set combination 2-1], PUSCH antenna ports 4 and 6 that are the second coherent antenna set and PUSCH antenna ports 5 and 7 that are the fourth coherent antenna set may be included). As an example of a connection relation between a PTRS port and a PUSCH antenna port, the terminal may assume that PTRS port 0 is connected to PUSCH antenna ports 0, 2, 4, and 6, and PTRS port 1 is connected to PUSCH antenna ports 1, 3, 5, and 7.

As another method, PUSCH antenna ports corresponding to a first coherent antenna set and a second coherent antenna set may be included in a first CW (e.g., according to [Partial coherent antenna set combination 2-1], PUSCH antenna ports 0 and 2 that are the first coherent antenna set and PUSCH antenna ports 4 and 6 that are the second coherent antenna set may be included), and PUSCH antenna ports corresponding to a third coherent antenna set and a fourth coherent antenna set may be included in a second CW (e.g., according to [Partial coherent antenna set combination 2-1], PUSCH antenna ports 1 and 3 that are the second coherent antenna set and PUSCH antenna ports 5 and 7 that are the fourth coherent antenna set may be included).

According to an embodiment of the disclosure, as an example of a connection relation between a PTRS port and a PUSCH antenna port, the terminal may assume that PTRS port 0 is connected to PUSCH antenna ports 0, 1, 2, and 3, and PTRS port 1 is connected to PUSCH antenna ports 4, 5, 6, and 7.

In this case, if the terminal has received PTRS transmission-related higher layer signaling from the BS and 2 is configured as the number of maximally transmittable PTRS ports by the BS through higher layer signaling, when interpreting a PTRS-DMRS association field in DCI receivable from the BS, the terminal may consider the following method.

### PTRS-DMRS Association Method 3-1-1

If, as described above, higher layer signaling indicating that PUSCH transmission based on 2 CWs, that is PUSCH transmission configured by 5 or more layers is possible is configured for the terminal by the BS, the terminal has received DCI scheduling PUSCH transmission of 5 or more layers from the BS, and a TPMI defined as shown in method 3-1 is indicated through the same DCI, the terminal may expect that DMRS ports corresponding to PUSCH antenna ports in two coherent antenna sets are all included in each CW. In addition, the terminal may expect that DMRS ports corresponding to different PUSCH antenna sets sharing two PTRS ports, respectively are included in each CW.

As another method, PUSCH antenna ports corresponding to a first coherent antenna set and a third coherent antenna set may be included in a first CW (e.g., according to [Partial coherent antenna set combination 2-1], PUSCH antenna ports 0 and 2 that are the first coherent antenna set and PUSCH antenna ports 1 and 3 that are the third coherent antenna set may be included), and PUSCH antenna ports corresponding to a second coherent antenna set and a fourth coherent antenna set may be included in a second CW (e.g., according to [Partial coherent antenna set combination 2-1], PUSCH antenna ports 4 and 6 that are the second coherent antenna set and PUSCH antenna ports 5 and 7 that are the fourth coherent antenna set may be included).

As an example of a connection relation between a PTRS port and a PUSCH antenna port, the terminal may assume that PTRS port 0 is connected to PUSCH antenna ports 0, 2, 4, and 6, and PTRS port 1 is connected to PUSCH antenna ports 1, 3, 5, and 7. In this case, the terminal may expect that DMRS ports corresponding to PUSCH antenna ports 0, 1, 2, and 3 are included in the first CW and may expect that DMRS ports corresponding to PUSCH antenna ports 4, 5, 6, and 7 are included in the second CW and, in the first CW, PUSCH antenna ports sharing PTRS port 0 are 0 and 2 and PUSCH antenna ports sharing PTRS port 1 are 1 and 3 and thus DMRS ports corresponding to the PUSCH antenna ports connected to the respective two PTRS ports may be included in the first CW. Similarly, DMRS ports corresponding to PUSCH antenna ports connected to the respective two PTRS ports may also be included in the second CW.

When a DMRS port connectable to one PTRS port is selected through a PTRS-DMRS association field in DCI, the terminal may compare two MCS fields in the DCI to select a CW having a higher MCS among two CWs and select one of DMRS ports in the CW. If MCSs for the two CWs are the same, the PTRS port may select one of DMRS ports existing in a first CW. The terminal may connect 2 PTRS ports to particular DMRS ports according to the meaning of each codepoint of a PTRS-DMRS association field of [Table 54] below defined by 2 bits, and use same at the time of PUSCH transmission. The terminal and the BS may define the meaning of each codepoint of a PTRS-DMRS association field as shown in Table 54.

TABLE 54

| Value | | Value | |
|---|---|---|---|
| of MSB | DMRS port | of LSB | DMRS port |
| 0 | 1^{st} DMRS port which | 0 | 1^{st} DMRS port which |
| | shares PTRS port 0 | | shares PTRS port 1 |
| | with the CW | | with the CW |
| 1 | 2^{nd} DMRS port which | 1 | 2^{nd} DMRS port which |
| | shares PTRS port 0 | | shares PTRS port 1 |
| | with the CW | | with the CW |

In Table 54, the terminal may perform, through an MSB among two bits of a PTRS-DMRS association field in DCI, connection to a DMRS port connected to a PUSCH antenna port sharing PTRS port 0 among DMRS ports in a determined CW (e.g., a CW having a high MCS among two CWs, or a first CW if the two CWs have the same MCS), and perform, through an LSB, connection to a DMRS port connected to a PUSCH antenna port sharing PTRS port 1 among DMRS ports in the determined CW.

If a TPMI determined through method 3-1 is used, a DMRS port corresponding to a particular coherent antenna set is allocable in each CW to the terminal in numbers corresponding to a maximum of 2. Therefore, as shown in Table 54, the terminal may select DMRS ports connected to PTRS port 0 and 1 in one CW through one MSB and one LSB.

If the BS defines a PTRS-DMRS association field in DCI, based on [PTRS-DMRS association method 3-1-1], while DCI overhead is maintained by consuming 2 bits, compared to a case of a maximum number of PTRS ports being 1, the BS may indicate a connection relation with 2 PTRS ports for all DMRS ports in each CW.

### PTRS-DMRS Association Method 3-1-2

If, as described above, higher layer signaling indicating that PUSCH transmission based on 2 CWs, that is PUSCH transmission configured by 5 or more layers is possible is configured for the terminal by the BS, the terminal has received DCI scheduling PUSCH transmission of 5 or more layers from the BS, and a TPMI defined as shown in method 3-1 is indicated through the same DCI, the terminal may expect that PUSCH antenna ports in two coherent antenna sets are all included in each CW, and the terminal may expect that only PUSCH antenna sets sharing one PTRS port are included in one CW. For example, DMRS ports connected to PUSCH antenna ports corresponding to a first coherent antenna set and a second coherent antenna set may be included in a first CW (e.g., according to [Partial coherent antenna set combination 2-1], PUSCH antenna ports 0 and 2 that are the first coherent antenna set and PUSCH antenna ports 4 and 6 that are the second coherent antenna set may be included), and DMRS ports connected to PUSCH antenna ports corresponding to a third coherent antenna set and a fourth coherent antenna set may be included in a second CW (e.g., according to [Partial coherent antenna set combination 2-1], PUSCH antenna ports 1 and 3 that are the second coherent antenna set and PUSCH antenna ports 5 and 7 that are the fourth coherent antenna set may be included).

According to an embodiment of the disclosure, as an example of a connection relation between a PTRS port and a PUSCH antenna port, the terminal may assume that PTRS port 0 is connected to PUSCH antenna ports 0, 2, 4, and 6, and PTRS port 1 is connected to PUSCH antenna ports 1, 3, 5, and 7. In this case, the terminal may expect that DMRS ports corresponding to PUSCH antenna ports 0, 2, 4, and 6 are included in the first CW and may expect that DMRS ports corresponding to PUSCH antenna ports 1, 3, 5, and 7 are included in the second CW and, in the first CW, PUSCH antenna ports sharing PTRS port 0 are 0, 2, 4, and 6, DMRS ports corresponding thereto may be included, and DMRS ports connected to PUSCH antenna ports sharing PTRS port 1 may not be included.

Similarly, in the second CW, DMRS ports connected to PUSCH antenna ports sharing PTRS port 0 may not be included, PUSCH antenna ports sharing PTRS port 1 are 1, 3, 5, and 7, and DMRS ports corresponding thereto may be included.

The terminal may connect 2 PTRS ports to particular DMRS ports according to the meaning of each codepoint of a PTRS-DMRS association field of Table 55 below defined by 4 bits, and use same at the time of PUSCH transmission. The terminal and the BS may define the meaning of each codepoint of a PTRS-DMRS association field as shown in Table 55.

TABLE 55

| Value | | Value | |
|---|---|---|---|
| of two | | of two | |
| MSBs | DMRS port | LSBs | DMRS port |
| 0 | 1^{st} DMRS port which | 0 | 1^{st} DMRS port which |
| | shares PTRS port 0 | | shares PTRS port 1 |
| | with the CW1 | | with the CW2 |
| 1 | 2^{nd} DMRS port which | 1 | 2^{nd} DMRS port which |
| | shares PTRS port 0 | | shares PTRS port 1 |
| | with the CW1 | | with the CW2 |
| 2 | 3^{rd} DMRS port which | 2 | 3^{rd} DMRS port which |
| | shares PTRS port 0 | | shares PTRS port 1 |
| | with the CW1 | | with the CW2 |
| 3 | 4^{th} DMRS port which | 3 | 4^{th} DMRS port which |
| | shares PTRS port 0 | | shares PTRS port 1 |
| | with the CW1 | | with the CW2 |

In Table 55, one of DMRS ports included in a first CW (CW1) may be connected to PTRS port 0 through 2 MSBs among 4 bits of a PTRS-DMRS association field in DCI, and one of DMRS ports included in a second CW (CW2) may be connected to PTRS port 1 through 2 least LSBs. According to which PUSCH antenna port to which a DMRS is connected, the DMRS being included in each CW, a connection relation of PTRS port 0 indicated through 2 MSBs in Table 55 may correspond to a DMRS port in CW2 rather than CW1.

With respect to a first codepoint (when the value of two MSBs is 0) indicated through 2 MSBs in Table 55, the terminal may interpret a connected DMRS port to be “1st DMRS port which shares PTRS port 0 with the CW2”. In addition, as described above, which set of PUSCH antenna ports is connected to a random PTRS port and is able to share information processible by the BS are determined, and if the connection and sharing relations are identical to those of a coherent antenna set included in each CW, a DMRS port connected to a particular CW (CW1 or CW2) may not be indicated to the terminal through a PTRS-DMRS association field.

With respect to a first codepoint (when the value of two MSBs is 0) indicated through 2 MSBs in Table 55, the terminal may interpret a connected DMRS port to be the first DMRS port sharing PTRS port 0, such as “1st DMRS port which shares PTRS port 0”, rather than a DMRS port included in CW1.

If the BS defines a PTRS-DMRS association field in DCI, based on [PTRS-DMRS association method 3-1-2], while DCI overhead is increased by consuming 4 bits, compared to a case of a maximum number of PTRS ports being 1, the BS may indicate a connection relation with 2 PTRS ports for all DMRS ports in all CWs. Therefore, the BS may secure a high degree of freedom for scheduling.

When the terminal supports 4 transmission antennas, DMRS ports corresponding to different coherent antenna sets may be included in one CW even at the time of partial-coherent PUSCH transmission for a maximum of 4 layers.

In method 2-2, when the terminal supports 8 transmission antennas, the terminal may perform partial-coherent PUSCH transmission of 5 or more layers, similarly to maximum 4-layer partial coherent PUSCH transmission, after including DMRS ports corresponding to different coherent antenna sets in one CW. Therefore, when the BS performs channel estimation for the PUSCH, the BS may use an implementation scheme similar to when receiving partial-coherent PUSCH transmission for a maximum of 4 layers from the terminal, and when the BS indicates which DMRS ports to which 2 PTRS ports are connected, it is enough to indicate a connection relation only for 2 DMRS ports in a particular CW, and thus reduction of DCI overhead is possible.

### Method 3-2

At the time of PUSCH transmission of 5 or more layers, the terminal and the BS may define a TPMI so that DMRS ports corresponding to a maximum of 4 coherent antenna sets are allocatable in each CW. As items required to be considered at the time of defining, a combination of at least one of the following items may be considered.

The terminal may consider a scheme of combining coherent antenna ports among PUSCH antenna ports, i.e., one of [Partial coherent antenna set combination 1-1] to [Partial coherent antenna set combination 1-4] and [Partial coherent antenna set combination 2-1] to [Partial coherent antenna set combination 2-4].

When a TPMI corresponding to 8 transmission antennas is configured, a method of reusing a full-coherent TPMI predefined considering 2 transmission antennas or a method of reusing a partial-coherent TPMI predefined considering 4 transmission antennas may be considered.

A sharing relation between a set of PUSCH antenna ports and each PTRS port may be considered.

In consideration of the items considered at the time of TPMI configuration, e.g., if, in consideration of [Partial coherent antenna set combination 2-1], PUSCH antenna ports 0 and 2 are included in a first coherent antenna set, PUSCH antenna ports 4 and 6 are included in a second coherent antenna set, PUSCH antenna ports 1 and 3 are included in a third coherent antenna set, and PUSCH antenna ports 5 and 7 are included in a fourth coherent antenna set, and a full-coherent TPMI defined considering 2 transmission antennas is reused, the terminal and the BS may define a partial-coherent TPMI having 4 coherent antenna sets for 5 layers, as shown in Equation (29) below.

$$W = \frac{1}{\sqrt{10}} [ \begin{matrix}1 & 0 & 1 & 0 & 0 \\ 0 & 1 & 0 & 1 & 0 \\ 1 & 0 & - 1 & 0 & 0 \\ 0 & 1 & 0 & - 1 & 0 \\ 0 & 0 & 0 & 0 & 1 \\ 0 & 0 & 0 & 0 & 0 \\ 0 & 0 & 0 & 0 & 1 \\ 0 & 0 & 0 & 0 & 0\end{matrix} ] \qquad ( 29 )$$

A TPMI expressed by Equation (29) may be applied to a codebook-based PUSCH scheduled as 5 layers.

DMRS ports corresponding to the first 2 layers of the TPMI may be included in a first CW, and DMRS ports corresponding to the remaining 3 layers may be included in a second CW.

PUSCH antenna ports connected to DMRS ports corresponding to the first layer and the third layer of the TPMI may be 0 and 2, it may be noted that the PUSCH antenna ports are both included in a first coherent antenna set, and it may be understood that respective rows of the 1st TPMI having 2 layers defined in Table 21 are placed on PUSCH antenna ports 0 and 2 that are the first coherent antenna set of the TPMI expressed by Equation (29), the first column of the 1st TPMI having 2 layers defined in Table 21 is placed on the first layer of the TPMI expressed by Equation (29), and the second column is placed on the third layer.

PUSCH antenna ports connected to DMRS ports corresponding to the second layer and the fourth layer of the TPMI may be 1 and 3, it may be noted that the PUSCH antenna ports are both included in a third coherent antenna set, and it may be understood that respective rows of the 1st TPMI having 2 layers defined in Table 21 are placed on PUSCH antenna ports 1 and 3 that are the third coherent antenna set of the TPMI expressed by Equation (29), the first column of the 1st TPMI having 2 layers defined in Table 21 is placed on the second layer of the TPMI expressed by Equation (29), and the second column is placed on the fourth layer.

PUSCH antenna ports connected to DMRS ports corresponding to the fifth layer of the TPMI may be 4 and 6, it may be noted that the PUSCH antenna ports are both included in a second coherent antenna set, and it may be understood that respective rows of the 2nd TPMI having 1 layer defined in Table 18 are placed on PUSCH antenna ports 4 and 6 that are the second coherent antenna set of the TPMI expressed by Equation (29), and the first column of the 2nd TPMI having 1 layer defined in Table 18 is placed on the fifth layer of the TPMI expressed by Equation (29).

Similarly, a partial-coherent TPMI having 4 coherent antenna sets for 5 layers may use one of the 2nd to 5th TPMIs defined in Table 18 for the second coherent antenna set and use one of the 1st and 2nd TPMIs defined in Table 21 for the first coherent antenna set and the third coherent antenna set and be made by placing the rows of each TPMI on the position of a corresponding coherent antenna set, and a total of 16 TPMIs may be possible.

Equation (29) uses a predefined full-coherent 1-layer TPMI of 2 transmission antennas with respect to a third layer set including the fifth layer and uses a predefined full-coherent 2-layer TPMI of 2 transmission antennas with respect to a first layer set including the first layer and the third layer and a second layer set including the second layer and the fourth layer. However, methods of using predefined 5 full-coherent 1-layer TPMIs of 2 transmission antennas with respect to the first layer set, the second layer set, and the third layer set may also be considered without being excluded.

In addition, any order change in two columns corresponding to the first 2 layers of the TPMI expressed by Equation (29), and any order change in three columns corresponding to the remaining 3 layers may be considered without being excluded.

Similarly, the terminal and the BS may define, e.g., a partial-coherent TPMI having 4 coherent antenna sets for 6 layers as shown in Equation (30) below.

$$W = \frac{1}{2 \sqrt{3}} [ \begin{matrix}1 & 0 & 0 & 1 & 0 & 0 \\ 0 & 1 & 0 & 0 & 1 & 0 \\ 1 & 0 & 0 & - 1 & 0 & 0 \\ 0 & 1 & 0 & 0 & - 1 & 0 \\ 0 & 0 & 1 & 0 & 0 & 1 \\ 0 & 0 & 0 & 0 & 0 & 0 \\ 0 & 0 & 1 & 0 & 0 & - 1 \\ 0 & 0 & 0 & 0 & 0 & 0\end{matrix} ] \qquad ( 30 )$$

A TPMI expressed by Equation (30) may be applied to a codebook-based PUSCH scheduled as 6 layers.

DMRS ports corresponding to the first 3 layers of the TPMI may be included in a first CW, and DMRS ports corresponding to the remaining 3 layers may be included in a second CW.

PUSCH antenna ports connected to DMRS ports corresponding to the first layer and the fourth layer of the TPMI may be 1000 and 1002, it may be noted that the PUSCH antenna ports are both included in a first coherent antenna set, and it may be understood that respective rows of the 1st TPMI having 2 layers defined in Table 21 are placed on PUSCH antenna ports 1000 and 1002 that are the first coherent antenna set of the TPMI expressed by Equation (30), the first column of the 1st TPMI having 2 layers defined in Table 21 is placed on the first layer of the TPMI expressed by Equation (30), and the second column is placed on the fourth layer.

PUSCH antenna ports connected to DMRS ports corresponding to the second layer and the fifth layer of the TPMI may be 1001 and 1003, it may be noted that the PUSCH antenna ports are both included in a third coherent antenna set, and it may be understood that respective rows of the 1st TPMI having 2 layers defined in Table 21 are placed on PUSCH antenna ports 1001 and 1003 that are the third coherent antenna set of the TPMI expressed by Equation (30), the first column of the 1st TPMI having 2 layers defined in Table 21 is placed on the second layer of the TPMI expressed by Equation (30), and the second column is placed on the fifth layer.

PUSCH antenna ports connected to DMRS ports corresponding to the third layer and the sixth layer of the TPMI may be 1004 and 1006, it may be noted that the PUSCH antenna ports are both included in a second coherent antenna set, and it may be understood that respective rows of the 1st TPMI having 2 layers defined in Table 21 are placed on PUSCH antenna ports 1004 and 1006 that are the fourth coherent antenna set of the TPMI expressed by Equation (30), the first column of the 1st TPMI having 2 layers defined in Table 21 is placed on the third layer of the TPMI expressed by Equation (30), and the second column is placed on the sixth layer.

Similarly, a partial-coherent TPMI having 4 coherent antenna sets for 6 layers may use one of the 1st and 2nd TPMIs defined in Table 21 for the first coherent antenna set, the second coherent antenna set, and the third coherent antenna set and be made by placing the rows of each TPMI on the position of a corresponding coherent antenna set, and a total of 8 TPMIs may be possible.

Equation (30) uses a predefined full-coherent 2-layer TPMI of 2 transmission antennas with respect to a first layer set including the first layer and the fourth layer, a second layer set including the second layer and the fifth layer, and a third layer set including the third layer and the sixth layer. However, methods of using predefined 6 full-coherent 1-layer TPMIs of 2 transmission antennas with respect to the first layer set, the second layer set, and the third layer set may also be considered without being excluded.

In addition, any order change in two columns corresponding to the first 3 layers of the TPMI expressed by Equation (30), and any order change in three columns corresponding to the remaining 3 layers may be considered without being excluded.

Similarly, the terminal and the BS may define a partial-coherent TPMI having 4 coherent antenna sets for 7 layers as shown in Equation (31) below.

$$W = \frac{1}{\sqrt{14}} [ \begin{matrix}1 & 0 & 0 & 1 & 0 & 0 & 0 \\ 0 & 1 & 0 & 0 & 1 & 0 & 0 \\ 1 & 0 & 0 & - 1 & 0 & 0 & 0 \\ 0 & 1 & 0 & 0 & - 1 & 0 & 0 \\ 0 & 0 & 1 & 0 & 0 & 1 & 0 \\ 0 & 0 & 0 & 0 & 0 & 0 & 1 \\ 0 & 0 & 1 & 0 & 0 & - 1 & 0 \\ 0 & 0 & 0 & 0 & 0 & 0 & 1\end{matrix} ]$$

A TPMI expressed by Equation (31) may be applied to a codebook-based PUSCH scheduled as 7 layers.

DMRS ports corresponding to the first 3 layers of the TPMI may be included in a first CW, and DMRS ports corresponding to the remaining 4 layers may be included in a second CW.

PUSCH antenna ports connected to DMRS ports corresponding to the first layer and the fourth layer of the TPMI may be 1000 and 1002, it may be noted that the PUSCH antenna ports are both included in a first coherent antenna set, and it may be understood that respective rows of the 1st TPMI having 2 layers defined in Table 21 are placed on PUSCH antenna ports 1000 and 1002 that are the first coherent antenna set of the TPMI expressed by Equation (31), the first column of the 1st TPMI having 2 layers defined in Table 21 is placed on the first layer of the TPMI expressed by Equation (31), and the second column is placed on the fourth layer.

PUSCH antenna ports connected to DMRS ports corresponding to the second layer and the fifth layer of the TPMI may be 1001 and 1003, it may be noted that the PUSCH antenna ports are both included in a third coherent antenna set, and it may be understood that respective rows of the 1st TPMI having 2 layers defined in Table 21 are placed on PUSCH antenna ports 1001 and 1003 that are the third coherent antenna set of the TPMI expressed by Equation (31), the first column of the 1st TPMI having 2 layers defined in Table 21 is placed on the second layer of the TPMI expressed by Equation (31), and the second column is placed on the fifth layer.

PUSCH antenna ports connected to DMRS ports corresponding to the third layer and the sixth layer of the TPMI may be 1002 and 1004, it may be noted that the PUSCH antenna ports are both included in a second coherent antenna set, and it may be understood that respective rows of the 1st TPMI having 2 layers defined in Table 21 are placed on PUSCH antenna ports 1002 and 1004 that are the second coherent antenna set of the TPMI expressed by Equation (31), the first column of the 1st TPMI having 2 layers defined in Table 21 is placed on the third layer of the TPMI expressed by Equation (31), and the second column is placed on the sixth layer.

PUSCH antenna ports connected to DMRS ports corresponding to the seventh layer of the TPMI may be 1005 and 1007, it may be noted that the PUSCH antenna ports are both included in a fourth coherent antenna set, and it may be understood that respective rows of the 2nd TPMI having 1 layer defined in Table 18 are placed on PUSCH antenna ports 1005 and 1007 that are the fourth coherent antenna set of the TPMI expressed by Equation (31), and the first column of the 2nd TPMI having 1 layer defined in Table 18 is placed on the seventh layer of the TPMI expressed by Equation (31).

Similarly, a partial-coherent TPMI having 4 coherent antenna sets for 7 layers may use one of the 2nd to 5th TPMIs defined in Table 18 for the fourth coherent antenna set and use one of the 1st and 2nd TPMIs defined in Table 21 for the first coherent antenna set, the second coherent antenna set, and the third coherent antenna set and be made by placing the rows of each TPMI on the position of a corresponding coherent antenna set, and a total of 16 TPMIs may be possible.

Equation (31) uses a predefined full-coherent 2-layer TPMI of 2 transmission antennas with respect to a first layer set including the first layer and the fourth layer, a second layer set including the second layer and the fifth layer, and a third layer set including the third layer and the sixth layer and uses an existing full-coherent 1-layer TPMI of 2 transmission antennas with respect to a fourth layer set including the seventh layer. However, methods of using predefined 7 full-coherent 1-layer TPMIs of 2 transmission antennas with respect to the first layer set, the second layer set, the third layer set, and the fourth layer set may also be considered without being excluded.

In addition, any order change in two columns corresponding to the first 3 layers of the TPMI expressed by Equation (31), and any order change in three columns corresponding to the remaining 4 layers may be considered without being excluded.

Similarly, the terminal and the BS may define, e.g., a partial-coherent TPMI having 4 coherent antenna sets for 8 layers as shown in Equation (32) below.

$$W = \frac{1}{4} [ \begin{matrix}1 & 0 & 0 & 0 & 1 & 0 & 0 & 0 \\ 0 & 1 & 0 & 0 & 0 & 1 & 0 & 0 \\ 1 & 0 & 0 & 0 & - 1 & 0 & 0 & 0 \\ 0 & 1 & 0 & 0 & 0 & - 1 & 0 & 0 \\ 0 & 0 & 1 & 0 & 0 & 0 & 1 & 0 \\ 0 & 0 & 0 & 1 & 0 & 0 & 0 & 1 \\ 0 & 0 & 1 & 0 & 0 & 0 & - 1 & 0 \\ 0 & 0 & 0 & 1 & 0 & 0 & 0 & - 1\end{matrix} ] \qquad ( 32 )$$

A TPMI expressed by Equation (32) may be applied to a codebook-based PUSCH scheduled as 8 layers.

DMRS ports corresponding to the first 4 layers of the TPMI may be included in a first CW, and DMRS ports corresponding to the remaining 4 layers may be included in a second CW.

PUSCH antenna ports connected to DMRS ports corresponding to the first layer and the fifth layer of the TPMI may be 1000 and 1002, it may be noted that the PUSCH antenna ports are both included in a first coherent antenna set, and it may be understood that respective rows of the 1st TPMI having 2 layers defined in Table 21 are placed on PUSCH antenna ports 1000 and 1002 that are the first coherent antenna set of the TPMI expressed by Equation (32), the first column of the 1st TPMI having 2 layers defined in Table 21 is placed on the first layer of the TPMI expressed by Equation (32), and the second column is placed on the fourth layer.

PUSCH antenna ports connected to DMRS ports corresponding to the second layer and the sixth layer of the TPMI may be 1001 and 1003, it may be noted that the PUSCH antenna ports are both included in a third coherent antenna set, and it may be understood that respective rows of the 1st TPMI having 2 layers defined in Table 21 are placed on PUSCH antenna ports 1001 and 1003 that are the third coherent antenna set of the TPMI expressed by Equation (32), the first column of the 1st TPMI having 2 layers defined in Table 21 is placed on the second layer of the TPMI expressed by Equation (32), and the second column is placed on the sixth layer.

PUSCH antenna ports connected to DMRS ports corresponding to the third layer and the seventh layer of the TPMI may be 1004 and 1006, it may be noted that the PUSCH antenna ports are both included in a second coherent antenna set, and it may be understood that respective rows of the 1st TPMI having 2 layers defined in Table 21 are placed on PUSCH antenna ports 1004 and 1006 that are the second coherent antenna set of the TPMI expressed by Equation (32), the first column of the 1st TPMI having 2 layers defined in Table 21 is placed on the third layer of the TPMI expressed by Equation (32), and the second column is placed on the seventh layer.

PUSCH antenna ports connected to DMRS ports corresponding to the fourth layer and the eighth layer of the TPMI may be 1005 and 1007, it may be noted that the PUSCH antenna ports are both included in a fourth coherent antenna set, and it may be understood that respective rows of the 1st TPMI having 2 layers defined in Table 21 are placed on PUSCH antenna ports 1005 and 1007 that are the fourth coherent antenna set of the TPMI expressed by Equation (32), the first column of the 1st TPMI having 2 layers defined in Table 21 is placed on the fourth layer of the TPMI expressed by Equation (32), and the second column is placed on the eighth layer.

Similarly, a partial-coherent TPMI having 4 coherent antenna sets for 8 layers may use one of the 1st and 2nd TPMIs defined in Table 21 for the first coherent antenna set, the second coherent antenna set, the third coherent antenna set, and the fourth coherent antenna set and be made by placing the rows of each TPMI on the position of a corresponding coherent antenna set, and a total of 16 TPMIs may be possible.

Equation (32) uses a predefined full-coherent 2-layer TPMI of 2 transmission antennas and an existing full-coherent 1-layer TPMI of 2 transmission antennas with respect to a first layer set including the first layer and the fifth layer, a second layer set including the second layer and the sixth layer, and a third layer set including the third layer and the seventh layer. However, methods of using predefined 8 full-coherent 1-layer TPMIs of 2 transmission antennas with respect to the first layer set, the second layer set, the third layer set, and the fourth layer set may also be considered without being excluded.

In addition, any order change in two columns corresponding to the first 4 layers of the TPMI expressed by Equation (32), and any order change in three columns corresponding to the remaining 4 layers may be considered without being excluded.

When the terminal performs PUSCH transmission of 5 or more layers, if, according to [Partial coherent antenna set combination 2-1], PUSCH antenna ports 1000 and 1002 may be included in a first coherent antenna set, PUSCH antenna ports 1004 and 1006 may be included in a second coherent antenna set, PUSCH antenna ports 1001 and 1003 may be included in a third coherent antenna set, and PUSCH antenna ports 1005 and 1007 may be included in a fourth coherent antenna set, 5-layer, 6-layer, 7-layer, and 8-layer TPMIs expressible by Equation (29) to Equation (32) may include, in a first CW, DMRS ports connected to PUSCH antenna ports corresponding to the first coherent antenna set, the second coherent antenna set, the third coherent antenna set, and the fourth coherent antenna set, and may similarly include, also in a second CW, DMRS ports connected to PUSCH antenna ports corresponding to the first coherent antenna set, the second coherent antenna set, the third coherent antenna set, and the fourth coherent antenna set.

According to an embodiment of the disclosure, as an example of a connection relation between a PTRS port and a PUSCH antenna port, the terminal may assume that PTRS port 0 is connected to PUSCH antenna ports 1000, 1002, 1004, and 1006, and PTRS port 1 is connected to PUSCH antenna ports 1001, 1003, 1005, and 1007. In this case, what are connected to DMRS ports included in the first CW among PUSCH antenna ports connected to PTRS port 0 are included in the first coherent antenna set and the second coherent antenna set, and what are connected to DMRS ports included in the second CW among PUSCH antenna ports connected to PTRS port 1 are included in the third coherent antenna set and the fourth coherent antenna set. That is, even if one CW is selected, DMRS ports connectable to two PTRS ports, respectively may exist in the CW.

As another method for selecting DMRS ports connectable to two PTRS ports, respectively, by selecting one CW, DMRS ports connected to PUSCH antenna ports corresponding to a first coherent antenna set and a second coherent antenna set may be included in a first CW (e.g., according to [Partial coherent antenna set combination 2-1], PUSCH antenna ports 1000 and 1002 that are the first coherent antenna set and PUSCH antenna ports 1004 and 1006 that are the second coherent antenna set may be included), and DMRS ports connected to PUSCH antenna ports corresponding to a third coherent antenna set and a fourth coherent antenna set may be included in a second CW (e.g., according to [Partial coherent antenna set combination 2-1], PUSCH antenna ports 1001 and 1003 that are the second coherent antenna set and PUSCH antenna ports 1005 and 1007 that are the fourth coherent antenna set may be included).

As an example of a connection relation between a PTRS port and a PUSCH antenna port, the terminal may assume that PTRS port 0 is connected to PUSCH antenna ports 1000, 1001, 1002, and 1003, and PTRS port 1 is connected to PUSCH antenna ports 1004, 1005, 1006, and 1007.

In this case, according to an embodiment of the disclosure, if the terminal has received PTRS transmission-related higher layer signaling from the BS and 2 is configured as the number of maximally transmittable PTRS ports by the BS through higher layer signaling, when interpreting a PTRS-DMRS association field in DCI receivable from the BS, the terminal may consider the following method.

### PTRS-DMRS Association Method 3-2-1

If, as described above, higher layer signaling indicating that PUSCH transmission based on 2 CWs, that is PUSCH transmission configured by 5 or more layers is possible is configured for the terminal by the BS, the terminal has received DCI scheduling PUSCH transmission of 5 or more layers from the BS, and a TPMI defined as shown in method 3-2 is indicated through the same DCI, the terminal may expect that DMRS ports corresponding to PUSCH antenna ports in a maximum of 4 coherent antenna sets are all included in each CW, and the terminal may expect that DMRS ports corresponding to different PUSCH antenna sets sharing two PTRS ports, respectively are included in each CW.

According to an embodiment of the disclosure, if, according to [Partial coherent antenna set combination 2-1], PUSCH antenna ports 1000 and 1002 may be included in a first coherent antenna set, PUSCH antenna ports 1004 and 1006 may be included in a second coherent antenna set, PUSCH antenna ports 1001 and 1003 may be included in a third coherent antenna set, and PUSCH antenna ports 1005 and 1007 may be included in a fourth coherent antenna set, DMRS ports connected to PUSCH antenna ports corresponding to the first coherent antenna set, the second coherent antenna set, the third coherent antenna set, and the fourth coherent antenna set may be included in a first CW and, similarly, DMRS ports connected to PUSCH antenna ports corresponding to the first coherent antenna set, the second coherent antenna set, the third coherent antenna set, and the fourth coherent antenna set may be included also in a second CW.

As an example of a connection relation between a PTRS port and a PUSCH antenna port, the terminal may assume that PTRS port 0 is connected to PUSCH antenna ports 1000, 1002, 1004, and 1006, and PTRS port 1 is connected to PUSCH antenna ports 1001, 1003, 1005, and 1007. In this case, what are connected to DMRS ports included in the first CW among PUSCH antenna ports connected to PTRS port 0 are included in the first coherent antenna set and the second coherent antenna set, and what are connected to DMRS ports included in the second CW among PUSCH antenna ports connected to PTRS port 1 are included in the third coherent antenna set and the fourth coherent antenna set. That is, even if one CW is selected, DMRS ports connectable to two PTRS ports, respectively may exist in the CW.

When a DMRS port connectable to one PTRS port is selected through a PTRS-DMRS association field in DCI, the terminal may compare two MCS fields in the DCI to select a CW having a higher MCS among two CWs and select one of DMRS ports in the CW. If MCSs for the two CWs are the same, the PTRS port may select one of DMRS ports existing in a first CW. The terminal may connect 2 PTRS ports to particular DMRS ports according to the meaning of each codepoint of a PTRS-DMRS association field of Table 56 below defined by 2 bits, and use same at the time of PUSCH transmission. The terminal and the BS may define the meaning of each codepoint of a PTRS-DMRS association field as shown in Table 56.

TABLE 56

| Value | | Value | |
|---|---|---|---|
| of MSB | DMRS port | of LSB | DMRS port |
| 0 | 1^{st} DMRS port which | 0 | 1^{st} DMRS port which |
| | shares PTRS port 0 | | shares PTRS port 1 |
| | with the CW | | with the CW |
| 1 | 2^{nd} DMRS port which | 1 | 2^{nd} DMRS port which |
| | shares PTRS port 0 | | shares PTRS port 1 |
| | with the CW | | with the CW |

In Table 56, the terminal may perform, through an MSB among two bits of a PTRS-DMRS association field in DCI, connection to a DMRS port connected to a PUSCH antenna port sharing PTRS port 0 among DMRS ports in a determined CW (e.g., a CW having a high MCS among two CWs, or a first CW if the two CWs have the same MCS), and perform, through an LSB, connection to a DMRS port connected to a PUSCH antenna port sharing PTRS port 1 among DMRS ports in the determined CW.

If a TPMI determined through [method 3-2] is used, a DMRS port corresponding to a particular coherent antenna set is allocable in each CW to the terminal in numbers corresponding to a maximum of 2. Therefore, as shown in Table 56, the terminal may select DMRS ports connected to PTRS port 0 and 1 in one CW through one MSB and one LSB.

If the BS defines a PTRS-DMRS association field in DCI, based on [PTRS-DMRS association method 3-2-1], while DCI overhead is maintained by consuming 2 bits, compared to a case of a maximum number of PTRS ports being 1, the BS may indicate a connection relation with 2 PTRS ports for all DMRS ports in each CW.

### Method of PTRS-DMRS Connection at Time of PUSCH Transmission by 8TX Non-Coherent Terminal

According to an embodiment of the disclosure, when a terminal supports 8 transmission antennas and supports non-coherent UL transmission, a method of connecting a PTRS and a DMRS at the time of PUSCH transmission by the terminal is provided. This embodiment may be operated in combination with all of other embodiments of the disclosure.

Which set of PUSCH antenna ports is connected to which PTRS port and is able to share phase error information estimated when the PTRS port is received by the BS may be fixedly defined by the terminal and the BS in a specification, may be configured for the terminal by the BS through higher layer signaling, may be activated through a MAC-CE, may be indicated through L1 signaling, and may be notified through a combination of at least one of higher layer signaling, MAC-CE, and L1 signaling. Even if the terminal supports non-coherent UL transmission, a connection relation between a PTRS port and a PUSCH antenna port set may be the same as that of a partial-coherent or full-coherent case according to the following description.

For example, if the terminal and the BS fixedly define a connection relation between a PTRS port and a PUSCH antenna port set in a specification, the terminal and the BS may assume that a set configured by PUSCH antenna ports 1000, 1002, 1004, and 1006 is connected to PTRS port 0 so that phase error information estimated when the PTRS port is received by the BS is sharable between respective ports of the PUSCH antenna port set, and may assume that a set configured by PUSCH antenna ports 1001, 1003, 1005, and 1007 may have a relation similar to the above relation with PTRS port 1. In this case, although the terminal defines the coherency between PUSCH antenna ports by considering one of [Partial coherent antenna set combination 2-1] to [Partial coherent antenna set combination 2-4], when connection with a particular PTRS port and information sharing are considered, the terminal may assume that even coherent antenna sets assumable to be not coherent to each other are able to share a particular PTRS port.

As another example, even if the terminal has four coherent antenna sets, the terminal may define a connection relation between a PTRS port and a PUSCH antenna port set by considering one of [Partial coherent antenna set combination 1-1] to [Partial coherent antenna set combination 1-4].

As another method, when the terminal defines a relation between a PTRS port and a PUSCH antenna port set described above, the terminal may use one of [Partial coherent antenna set combination 2-1] to [Partial coherent antenna set combination 2-4] or use other set combinations. If [Partial coherent antenna set combination 2-1] is used, it may be assumed that PUSCH antenna ports 1000 and 1002 that are a first coherent antenna set and PUSCH antenna ports 1004 and 1006 that are a second coherent antenna set are all connected to PTRS port 0 and may share information on the PTRS port, and PUSCH antenna ports 1001 and 1003 that are a third coherent antenna set and PUSCH antenna ports 1005 and 1007 that are a fourth coherent antenna set are all connected to PTRS port 1 and may share information on the PTRS port.

If the terminal has received PTRS transmission-related higher layer signaling from the BS and 2 is configured as the number of maximally transmittable PTRS ports by the BS through higher layer signaling, when interpreting a PTRS-DMRS association field in DCI receivable from the BS, the terminal may consider the following method.

If the terminal supports non-coherent UL transmission, the terminal may identify the connectivity between a PUSCH antenna port and a DMRS port according to an indicated TPMI structure. For example, if the terminal receives a scheduling for PUSCH transmission configured by 8 layers from the BS, 4 DMRS ports may be included in a first CW and 4 DMRS ports may be included also in a second CW. The 4 DMRS ports in each CW may all correspond to an all-non-coherent PUSCH antenna set. If the above situation is generalized for 5 or more layers, the following description may be given.

### Method 4-1

The terminal and the BS may include DMRS ports corresponding to the PUSCH antenna ports connectable to 2 PTRS ports, respectively, in each CW in consideration of a connection relation between a particular PTRS port and a PUSCH antenna port at the time of PUSCH transmission of 5 or more layers. Therefore, at the time of PUSCH transmission of 5 or more layers, the terminal and the BS may define a TPMI so that DMRS ports corresponding to 2 coherent antenna sets are allocatable in each CW. As items required to be considered at the time of defining, a combination of at least one of the following items may be considered.

A sharing relation between a set of PUSCH antenna ports and each PTRS port may be considered. For example, PTRS port 0 is connected to PUSCH antenna ports 1000, 1002, 1004, and 1006 and PTRS port 1 is connected to PUSCH antenna ports 1001, 1003, 1005, and 1007 and thus may share channel estimation information.

By considering the items required to be considered at the time of the TPMI defining, the terminal and the BS may define a non-coherent TPMI for 5 layers as shown in Equation (33) below.

$$W = \frac{1}{\sqrt{5}} [ \begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1 \\ 0 & 0 & 0 & 0 & 0 \\ 0 & 0 & 0 & 0 & 0 \\ 0 & 0 & 0 & 0 & 0\end{matrix} ] \qquad ( 33 )$$

A TPMI expressed by Equation (33) may be applied to a codebook-based PUSCH scheduled as 5 layers.

DMRS ports corresponding to the first 2 layers of the TPMI may be included in a first CW, and DMRS ports corresponding to the remaining 3 layers may be included in a second CW.

One of the DMRS ports corresponding to the first 2 layers of the TPMI may be connected to a PUSCH antenna port connected to PTRS port 0 (e.g., one of PUSCH antenna ports 1000, 1002, 1004, and 1006) and the remaining one DMRS port may be connected to a PUSCH antenna port connected to PTRS port 1 (e.g., one of PUSCH antenna ports 1001, 1003, 1005, and 1007).

One or more of the DMRS ports corresponding to the last 3 layers of the TPMI may be connected to a PUSCH antenna port connected to PTRS port 0 (e.g., one of PUSCH antenna ports 1000, 1002, 1004, and 1006) and a remaining DMRS port may be connected to a PUSCH antenna port connected to PTRS port 1 (e.g., one of PUSCH antenna ports 1001, 1003, 1005, and 1007).

In Equation (33), in the first CW, a DMRS port corresponding to the first layer is connected to PUSCH antenna port 1000, i.e., to a PUSCH antenna port connected to PTRS port 0, and a DMRS port corresponding to the second layer is connected to PUSCH antenna port 1001, i.e., to a PUSCH antenna port connected to PTRS port 1. Additionally, other modifications may not be excluded such as the DMRS port corresponding to the first layer being connected to PUSCH antenna port 1002 that is another PUSCH antenna port connected to PTRS port 0, and the DMRS port corresponding to the second layer being connected to PUSCH antenna port 1005 that is another PUSCH antenna port connected to PTRS port 1.

In Equation (33), in the second CW, a DMRS port corresponding to the third layer is connected to PUSCH antenna port 1002, i.e., to a PUSCH antenna port connected to PTRS port 0, a DMRS port corresponding to the fourth layer is connected to PUSCH antenna port 1003, i.e., to a PUSCH antenna port connected to PTRS port 1, and a DMRS port corresponding to the fifth layer is connected to PUSCH antenna port 1004, i.e., to a PUSCH antenna port connected to PTRS port 0. Additionally, other modifications may not be excluded such as the DMRS port corresponding to the third layer being connected to PUSCH antenna port 1000 that is another PUSCH antenna port connected to PTRS port 0, the DMRS port corresponding to the fourth layer being connected to PUSCH antenna port 1007 that is another PUSCH antenna port connected to PTRS port 1, and the DMRS port corresponding to the fifth layer being connected to PUSCH antenna port 1006 that is another PUSCH antenna port connected to PTRS port 0.

Each of the DMRS ports included in the first CW and the second CW may be connected to one PUSCH antenna port, and the terminal may not expect that two or more DMRS ports are connected to the same PUSCH antenna port.

A DMRS port being connected to a PUSCH antenna port may imply that a value of the position of a column corresponding to the DMRS port in a TPMI and of the position of a row corresponding to the PUSCH antenna port is 1. The position of 1 existing in each column in the TPMI may be changed in consideration of a connection relation between a PTRS port and a PUSCH antenna port.

In addition, any order change in two columns corresponding to the first 2 layers of the TPMI expressed by Equation (33), and any order change in three columns corresponding to the remaining 3 layers may be considered without being excluded.

Similarly, the terminal and the BS may define a non-coherent TPMI for 6 layers as shown in Equation (34) below.

$$W = \frac{1}{\sqrt{6}} [ \begin{matrix}1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0 \\ 0 & 0 & 0 & 0 & 0 & 1 \\ 0 & 0 & 0 & 0 & 0 & 0 \\ 0 & 0 & 0 & 0 & 0 & 0\end{matrix} ] \qquad ( 34 )$$

A TPMI expressed by Equation (34) may be applied to a codebook-based PUSCH scheduled as 6 layers.

DMRS ports corresponding to the first 3 layers of the TPMI may be included in a first CW, and DMRS ports corresponding to the remaining 3 layers may be included in a second CW.

One or more of the DMRS ports corresponding to the first 3 layers of the TPMI may be connected to a PUSCH antenna port connected to PTRS port 0 (e.g., one of PUSCH antenna ports 1000, 1002, 1004, and 1006) and a remaining DMRS port may be connected to a PUSCH antenna port connected to PTRS port 1 (e.g., one of PUSCH antenna ports 1001, 1003, 1005, and 1007).

One or more of the DMRS ports corresponding to the last 3 layers of the TPMI may be connected to a PUSCH antenna port connected to PTRS port 0 (e.g., one of PUSCH antenna ports 1000, 1002, 1004, and 1006) and a remaining DMRS port may be connected to a PUSCH antenna port connected to PTRS port 1 (e.g., one of PUSCH antenna ports 1001, 1003, 1005, and 1007).

In Equation (34), in the first CW, a DMRS port corresponding to the first layer is connected to PUSCH antenna port 1000, i.e., to a PUSCH antenna port connected to PTRS port 0, a DMRS port corresponding to the second layer is connected to PUSCH antenna port 1001, i.e., to a PUSCH antenna port connected to PTRS port 1, and a DMRS port corresponding to the third layer is connected to PUSCH antenna port 1002, i.e., to a PUSCH antenna port connected to PTRS port 0. Additionally, other modifications may not be excluded such as the DMRS port corresponding to the first layer being connected to PUSCH antenna port 1002 that is another PUSCH antenna port connected to PTRS port 0, the DMRS port corresponding to the second layer being connected to PUSCH antenna port 1005 that is another PUSCH antenna port connected to PTRS port 1, and the DMRS port corresponding to the third layer being connected to PUSCH antenna port 1003 that is another PUSCH antenna port connected to PTRS port 1.

In addition, in Equation (34), in the second CW, a DMRS port corresponding to the fourth layer is connected to PUSCH antenna port 1003, i.e., to a PUSCH antenna port connected to PTRS port 1, a DMRS port corresponding to the fifth layer is connected to PUSCH antenna port 1004, i.e., to a PUSCH antenna port connected to PTRS port 0, and a DMRS port corresponding to the sixth layer is connected to PUSCH antenna port 1005, i.e., to a PUSCH antenna port connected to PTRS port 1. Additionally, other modifications may not be excluded such as the DMRS port corresponding to the fourth layer being connected to PUSCH antenna port 1000 that is another PUSCH antenna port connected to PTRS port 0, the DMRS port corresponding to the fifth layer being connected to PUSCH antenna port 1004 that is another PUSCH antenna port connected to PTRS port 0, and the DMRS port corresponding to the sixth layer being connected to PUSCH antenna port 1005 that is another PUSCH antenna port connected to PTRS port 1.

Each of the DMRS ports included in the first CW and the second CW may be connected to one PUSCH antenna port, and the terminal may not expect that two or more DMRS ports are connected to the same PUSCH antenna port.

A DMRS port being connected to a PUSCH antenna port may imply that a value of the position of a column corresponding to the DMRS port in a TPMI and of the position of a row corresponding to the PUSCH antenna port is 1. The position of 1 existing in each column in the TPMI may be changed in consideration of a connection relation between a PTRS port and a PUSCH antenna port.

In addition, any order change in two columns corresponding to the first 3 layers of the TPMI expressed by Equation (34), and any order change in three columns corresponding to the remaining 3 layers may be considered without being excluded.

Similarly, the terminal and the BS may define a non-coherent TPMI for 7 layers as shown in Equation (35) below.

$$W = \frac{1}{\sqrt{7}} [ \begin{matrix}1 & 0 & 0 & 0 & 0 & 0 & 0 \\ 0 & 1 & 0 & 0 & 0 & 0 & 0 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1 \\ 0 & 0 & 0 & 0 & 0 & 0 & 0\end{matrix} ] \qquad ( 35 )$$

A TPMI expressed by Equation (35) may be applied to a codebook-based PUSCH scheduled as 7 layers.

DMRS ports corresponding to the first 3 layers of the TPMI may be included in a first CW, and DMRS ports corresponding to the remaining 4 layers may be included in a second CW.

One or more of the DMRS ports corresponding to the first 3 layers of the TPMI may be connected to a PUSCH antenna port connected to PTRS port 0 (e.g., one of PUSCH antenna ports 1000, 1002, 1004, and 1006) and a remaining DMRS port may be connected to a PUSCH antenna port connected to PTRS port 1 (e.g., one of PUSCH antenna ports 1001, 1003, 1005, and 1007).

One or more of the DMRS ports corresponding to the last 4 layers of the TPMI may be connected to a PUSCH antenna port connected to PTRS port 0 (e.g., one of PUSCH antenna ports 1000, 1002, 1004, and 1006) and a remaining DMRS port may be connected to a PUSCH antenna port connected to PTRS port 1 (e.g., one of PUSCH antenna ports 1001, 1003, 1005, and 1007).

In Equation (35), in the first CW, a DMRS port corresponding to the first layer is connected to PUSCH antenna port 1000, i.e., to a PUSCH antenna port connected to PTRS port 0, a DMRS port corresponding to the second layer is connected to PUSCH antenna port 1001, i.e., to a PUSCH antenna port connected to PTRS port 1, and a DMRS port corresponding to the third layer is connected to PUSCH antenna port 1002, i.e., to a PUSCH antenna port connected to PTRS port 0. Additionally, other modifications may not be excluded such as the DMRS port corresponding to the first layer being connected to PUSCH antenna port 1002 that is another PUSCH antenna port connected to PTRS port 0, the DMRS port corresponding to the second layer being connected to PUSCH antenna port 1005 that is another PUSCH antenna port connected to PTRS port 1, and the DMRS port corresponding to the third layer being connected to PUSCH antenna port 1003 that is another PUSCH antenna port connected to PTRS port 1.

In Equation (35), in the second CW, a DMRS port corresponding to the fourth layer is connected to PUSCH antenna port 1003, i.e., to a PUSCH antenna port connected to PTRS port 1, a DMRS port corresponding to the fifth layer is connected to PUSCH antenna port 1004, i.e., to a PUSCH antenna port connected to PTRS port 0, a DMRS port corresponding to the sixth layer is connected to PUSCH antenna port 1005, i.e., to a PUSCH antenna port connected to PTRS port 1, and a DMRS port corresponding to the seventh layer is connected to PUSCH antenna port 1006, i.e., to a PUSCH antenna port connected to PTRS port 0. Additionally, other modifications may not be excluded such as the DMRS port corresponding to the fourth layer being connected to PUSCH antenna port 1000 that is another PUSCH antenna port connected to PTRS port 0, the DMRS port corresponding to the fifth layer being connected to PUSCH antenna port 1004 that is another PUSCH antenna port connected to PTRS port 0, the DMRS port corresponding to the sixth layer being connected to PUSCH antenna port 1005 that is another PUSCH antenna port connected to PTRS port 1, and the DMRS port corresponding to the seventh layer being connected to PUSCH antenna port 1003 that is another PUSCH antenna port connected to PTRS port 1.

Each of the DMRS ports included in the first CW and the second CW may be connected to one PUSCH antenna port, and the terminal may not expect that two or more DMRS ports are connected to the same PUSCH antenna port.

A DMRS port being connected to a PUSCH antenna port may imply that a value of the position of a column corresponding to the DMRS port in a TPMI and of the position of a row corresponding to the PUSCH antenna port is 1. The position of 1 existing in each column in the TPMI may be changed in consideration of a connection relation between a PTRS port and a PUSCH antenna port.

In addition, any order change in two columns corresponding to the first 3 layers of the TPMI expressed by Equation (35), and any order change in three columns corresponding to the remaining 4 layers may be considered without being excluded.

Similarly, the terminal and the BS may define a non-coherent TPMI for 8 layers as shown in Equation (36) below.

$$W = \frac{1}{2 \sqrt{2}} [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ] \qquad ( 36 )$$

A TPMI expressed by Equation (36) may be applied to a codebook-based PUSCH scheduled as 8 layers.

DMRS ports corresponding to the first 4 layers of the TPMI may be included in a first CW, and DMRS ports corresponding to the remaining 4 layers may be included in a second CW.

One or more of the DMRS ports corresponding to the first 4 layers of the TPMI may be connected to a PUSCH antenna port connected to PTRS port 0 (e.g., one of PUSCH antenna ports 1000, 1002, 1004, and 1006) and a remaining DMRS port may be connected to a PUSCH antenna port connected to PTRS port 1 (e.g., one of PUSCH antenna ports 1001, 1003, 1005, and 1007).

One or more of the DMRS ports corresponding to the last 4 layers of the TPMI may be connected to a PUSCH antenna port connected to PTRS port 0 (e.g., one of PUSCH antenna ports 1000, 1002, 1004, and 1006) and a remaining DMRS port may be connected to a PUSCH antenna port connected to PTRS port 1 (e.g., one of PUSCH antenna ports 1001, 1003, 1005, and 1007).

In Equation (36), in the first CW, a DMRS port corresponding to the first layer is connected to PUSCH antenna port 1000, i.e., to a PUSCH antenna port connected to PTRS port 0, a DMRS port corresponding to the second layer is connected to PUSCH antenna port 1001, i.e., to a PUSCH antenna port connected to PTRS port 1, a DMRS port corresponding to the third layer is connected to PUSCH antenna port 1002, i.e., to a PUSCH antenna port connected to PTRS port 0, and a DMRS port corresponding to the fourth layer is connected to PUSCH antenna port 1003, i.e., to a PUSCH antenna port connected to PTRS port 1. Additionally, other modifications may not be excluded such as the DMRS port corresponding to the first layer being connected to PUSCH antenna port 1002 that is another PUSCH antenna port connected to PTRS port 0, the DMRS port corresponding to the second layer being connected to PUSCH antenna port 1005 that is another PUSCH antenna port connected to PTRS port 1, the DMRS port corresponding to the third layer being connected to PUSCH antenna port 1003 that is another PUSCH antenna port connected to PTRS port 1, and the DMRS port corresponding to the fourth layer being connected to PUSCH antenna port 1001 that is another PUSCH antenna port connected to PTRS port 1.

In Equation (36), in the second CW, a DMRS port corresponding to the fifth layer is connected to PUSCH antenna port 1004, i.e., to a PUSCH antenna port connected to PTRS port 0, a DMRS port corresponding to the sixth layer is connected to PUSCH antenna port 1005, i.e., to a PUSCH antenna port connected to PTRS port 1, a DMRS port corresponding to the seventh layer is connected to PUSCH antenna port 1006, i.e., to a PUSCH antenna port connected to PTRS port 0, and a DMRS port corresponding to the eighth layer is connected to PUSCH antenna port 1007, i.e., to a PUSCH antenna port connected to PTRS port 1. Additionally, other modifications may not be excluded such as the DMRS port corresponding to the fifth layer being connected to PUSCH antenna port 1000 that is another PUSCH antenna port connected to PTRS port 0, the DMRS port corresponding to the sixth layer being connected to PUSCH antenna port 1004 that is another PUSCH antenna port connected to PTRS port 0, the DMRS port corresponding to the seventh layer being connected to PUSCH antenna port 1005 that is another PUSCH antenna port connected to PTRS port 1, and the DMRS port corresponding to the eighth layer being connected to PUSCH antenna port 1003 that is another PUSCH antenna port connected to PTRS port 1.

Each of the DMRS ports included in the first CW and the second CW may be connected to one PUSCH antenna port, and the terminal may not expect that two or more DMRS ports are connected to the same PUSCH antenna port.

A DMRS port being connected to a PUSCH antenna port may imply that a value of the position of a column corresponding to the DMRS port in a TPMI and of the position of a row corresponding to the PUSCH antenna port is 1. The position of 1 existing in each column in the TPMI may be changed in consideration of a connection relation between a PTRS port and a PUSCH antenna port.

In addition, any order change in two columns corresponding to the first 4 layers of the TPMI expressed by Equation (36), and any order change in three columns corresponding to the remaining 4 layers may be considered without being excluded.

5-layer, 6-layer, 7-layer, and 8-layer TPMIs expressible by Equation (33)] to Equation (36) may include, when the terminal performs PUSCH transmission of 5 or more layers, all DMRS ports connected to PUSCH antenna ports connectable to 2 PTRS ports in a first CW, and similarly, may include all DMRS ports connected to PUSCH antenna ports connectable to 2 PTRS ports in a second CW.

In this case, if the terminal has received PTRS transmission-related higher layer signaling from the BS and 2 is configured as the number of maximally transmittable PTRS ports by the BS through higher layer signaling, when interpreting a PTRS-DMRS association field in DCI receivable from the BS, the terminal may consider the following method.

### PTRS-DMRS Association Method 4-1-1

If, as described above, higher layer signaling indicating that PUSCH transmission based on 2 CWs, that is PUSCH transmission configured by 5 or more layers is possible is configured for the terminal by the BS, the terminal has received DCI scheduling PUSCH transmission of 5 or more layers from the BS, and a TPMI defined as shown in method 4-1 is indicated through the same DCI, the terminal may expect that DMRS ports corresponding to different PUSCH antenna sets sharing two PTRS ports, respectively, are included in each CW. In this case, some of DMRS ports included in one CW may correspond to PUSCH antenna ports connected to PTRS port 0, and the remaining some of the DMRS ports included in the one CW may correspond to PUSCH antenna ports connected to PTRS port 1. That is, even if one CW is selected, DMRS ports connectable to two PTRS ports, respectively, may exist in the CW.

When a DMRS port connectable to one PTRS port is selected through a PTRS-DMRS association field in DCI, the terminal may compare two MCS fields in the DCI to select a CW having a higher MCS among two CWs and select one of DMRS ports in the CW. If MCSs for the two CWs are the same, the PTRS port may select one of DMRS ports existing in a first CW. The terminal may connect 2 PTRS ports to particular DMRS ports according to the meaning of each codepoint of a PTRS-DMRS association field of Table 57 below defined by 2 bits, and use same at the time of PUSCH transmission. The terminal and the BS may define the meaning of each codepoint of a PTRS-DMRS association field as shown in Table 57.

TABLE 57

| Value | | Value | |
|---|---|---|---|
| of MSB | DMRS port | of LSB | DMRS port |
| 0 | 1^{st} DMRS port which | 0 | 1^{st} DMRS port which |
| | shares PTRS port 0 | | shares PTRS port 1 |
| | with the CW | | with the CW |
| 1 | 2^{nd} DMRS port which | 1 | 2^{nd} DMRS port which |
| | shares PTRS port 0 | | shares PTRS port 1 |
| | with the CW | | with the CW |

In Table 57, the terminal may perform, through an MSB among two bits of a PTRS-DMRS association field in DCI, connection to a DMRS port connected to a PUSCH antenna port sharing PTRS port 0 among DMRS ports in a determined CW (e.g., a CW having a high MCS among two CWs, or a first CW if the two CWs have the same MCS), and perform, through an LSB, connection to a DMRS port connected to a PUSCH antenna port sharing PTRS port 1 among DMRS ports in the determined CW.

If a TPMI determined through method 4-1 is used, a DMRS port corresponding to a particular coherent antenna set is allocable in each CW to the terminal in numbers corresponding a maximum of 2. Therefore, as shown in Table 57, the terminal may select DMRS ports connected to PTRS port 0 and 1 in one CW through one MSB and one LSB.

If the BS defines a PTRS-DMRS association field in DCI, based on [PTRS-DMRS association method 4-1-1], while DCI overhead is maintained by consuming 2 bits, compared to a case of a maximum number of PTRS ports being 1, the BS may indicate a connection relation with 2 PTRS ports for all DMRS ports in each CW.

When the terminal supports 4 transmission antennas, DMRS ports corresponding to different coherent antenna sets may be included in one CW even at the time of partial-coherent PUSCH transmission for a maximum of 4 layers.

In method 4-1, in a case where the terminal supports 8 transmission antennas, at the time of non-coherent PUSCH transmission of 5 or more layers, all DMRS ports corresponding to PUSCH antenna ports connectable to 2 PTRS ports, respectively, are allocated in one CW. Therefore, when the BS performs channel estimation for the PUSCH, the BS may use an implementation scheme similar to when receiving partial-coherent or non-coherent PUSCH transmission for a maximum of 4 layers from the terminal, and when the BS indicates which DMRS ports to which 2 PTRS ports are connected, it is enough to indicate a connection relation only for 2 DMRS ports in a particular CW, and thus reduction of DCI overhead is possible.

### Method 4-2

The terminal and the BS may include only DMRS ports corresponding to PUSCH antenna ports connectable to one PTRS port in each CW in consideration of a connection relation between a particular PTRS port and a PUSCH antenna port at the time of PUSCH transmission of 5 or more layers. Therefore, at the time of PUSCH transmission of 5 or more layers, the terminal and the BS may define a TPMI so that DMRS ports corresponding to 2 coherent antenna sets are allocatable in each CW. As items required to be considered when a TPMI is defined, a combination of at least one of the following items may be considered.

A sharing relation between a set of PUSCH antenna ports and each PTRS port may be considered. For example, PTRS port 0 is connected to PUSCH antenna ports 1000, 1002, 1004, and 1006 and PTRS port 1 is connected to PUSCH antenna ports 1001, 1003, 1005, and 1007 and thus may share channel estimation information.

By considering the items required to be considered at the time of the TPMI defining, the terminal and the BS may define a non-coherent TPMI for 5 layers as shown in Equation (37) below.

$$W = \frac{1}{\sqrt{5}} [ \begin{matrix}1 & 0 & 0 & 0 & 0 \\ 0 & 0 & 1 & 0 & 0 \\ 0 & 1 & 0 & 0 & 0 \\ 0 & 0 & 0 & 1 & 0 \\ 0 & 0 & 0 & 0 & 0 \\ 0 & 0 & 0 & 0 & 1 \\ 0 & 0 & 0 & 0 & 0 \\ 0 & 0 & 0 & 0 & 0\end{matrix} ] \qquad ( 37 )$$

A TPMI expressed by Equation (37) may be applied to a codebook-based PUSCH scheduled as 5 layers.

DMRS ports corresponding to the first 2 layers of the TPMI may be included in a first CW, and DMRS ports corresponding to the remaining 3 layers may be included in a second CW.

Each of the DMRS ports corresponding to the first 2 layers of the TPMI may be connected to a PUSCH antenna port connected to PTRS port 0 (e.g., one of PUSCH antenna ports 1000, 1002, 1004, and 1006), or may be connected to a PUSCH antenna port connected to PTRS port 1 (e.g., one of PUSCH antenna ports 1001, 1003, 1005, and 1007).

Each of the DMRS ports corresponding to the last 3 layers of the TPMI may be connected to a PUSCH antenna port connected to PTRS port 0 (e.g., one of PUSCH antenna ports 1000, 1002, 1004, and 1006), or may be connected to a PUSCH antenna port connected to PTRS port 1 (e.g., one of PUSCH antenna ports 1001, 1003, 1005, and 1007).

A PTRS port connected to PUSCH antenna ports corresponding to the DMRS ports in the first CW may be different from a PTRS port connected to PUSCH antenna ports corresponding to the DMRS ports in the second CW. For example, if a PTRS port connected to PUSCH antenna ports corresponding to the DMRS ports in the first CW is PTRS port 1, a PTRS port connected to PUSCH antenna ports corresponding to the DMRS ports in the second CW may be PTRS port 0.

In Equation (37), in the first CW, a DMRS port corresponding to the first layer is connected to PUSCH antenna port 1000, i.e., to a PUSCH antenna port connected to PTRS port 0, and a DMRS port corresponding to the second layer is connected to PUSCH antenna port 1002, i.e., to a PUSCH antenna port connected to PTRS port 0. Additionally, other modifications may not be excluded such as the DMRS port corresponding to the first layer being connected to PUSCH antenna port 1002 that is another PUSCH antenna port connected to PTRS port 0, and the DMRS port corresponding to the second layer being connected to PUSCH antenna port 1004 that is another PUSCH antenna port connected to PTRS port 0.

In Equation (37), in the second CW, a DMRS port corresponding to the third layer is connected to PUSCH antenna port 1001, i.e., to a PUSCH antenna port connected to PTRS port 1, a DMRS port corresponding to the fourth layer is connected to PUSCH antenna port 1003, i.e., to a PUSCH antenna port connected to PTRS port 1, and a DMRS port corresponding to the fifth layer is connected to PUSCH antenna port 1005, i.e., to a PUSCH antenna port connected to PTRS port 1. Additionally, other modifications may not be excluded such as the DMRS port corresponding to the third layer being connected to PUSCH antenna port 1003 that is another PUSCH antenna port connected to PTRS port 1, the DMRS port corresponding to the fourth layer being connected to PUSCH antenna port 1007 that is another PUSCH antenna port connected to PTRS port 1, and the DMRS port corresponding to the fifth layer being connected to PUSCH antenna port 1001 that is another PUSCH antenna port connected to PTRS port 1.

Each of the DMRS ports included in the first CW and the second CW may be connected to one PUSCH antenna port, and the terminal may not expect that two or more DMRS ports are connected to the same PUSCH antenna port.

A DMRS port being connected to a PUSCH antenna port may imply that a value of the position of a column corresponding to the DMRS port in a TPMI and of the position of a row corresponding to the PUSCH antenna port is 1. The position of 1 existing in each column in the TPMI may be changed in consideration of a connection relation between a PTRS port and a PUSCH antenna port.

In addition, any order change in two columns corresponding to the first 2 layers of the TPMI expressed by Equation (37), and any order change in three columns corresponding to the remaining 3 layers may be considered without being excluded.

Similarly, the terminal and the BS may define a non-coherent TPMI for 6 layers as shown in Equation (38) below.

$$W = \frac{1}{\sqrt{6}} [ \begin{matrix}1 & 0 & 0 & 0 & 0 & 0 \\ 0 & 0 & 0 & 1 & 0 & 0 \\ 0 & 1 & 0 & 0 & 0 & 0 \\ 0 & 0 & 0 & 0 & 1 & 0 \\ 0 & 0 & 1 & 0 & 0 & 0 \\ 0 & 0 & 0 & 0 & 0 & 1 \\ 0 & 0 & 0 & 0 & 0 & 0 \\ 0 & 0 & 0 & 0 & 0 & 0\end{matrix} ] \qquad ( 38 )$$

A TPMI expressed by Equation (38) may be applied to a codebook-based PUSCH scheduled as 6 layers.

DMRS ports corresponding to the first 3 layers of the TPMI may be included in a first CW, and DMRS ports corresponding to the remaining 3 layers may be included in a second CW.

Each of the DMRS ports corresponding to the first 3 layers of the TPMI may be connected to a PUSCH antenna port connected to PTRS port 0 (e.g., one of PUSCH antenna ports 1000, 1002, 1004, and 1006), or may be connected to a PUSCH antenna port connected to PTRS port 1 (e.g., one of PUSCH antenna ports 1001, 1003, 1005, and 1007).

Each of the DMRS ports corresponding to the last 3 layers of the TPMI may be connected to a PUSCH antenna port connected to PTRS port 0 (e.g., one of PUSCH antenna ports 1000, 1002, 1004, and 1006), or may be connected to a PUSCH antenna port connected to PTRS port 1 (e.g., one of PUSCH antenna ports 1001, 1003, 1005, and 1007).

A PTRS port connected to PUSCH antenna ports corresponding to the DMRS ports in the first CW may be different from a PTRS port connected to PUSCH antenna ports corresponding to the DMRS ports in the second CW. For example, if a PTRS port connected to PUSCH antenna ports corresponding to the DMRS ports in the first CW is PTRS port 1, a PTRS port connected to PUSCH antenna ports corresponding to the DMRS ports in the second CW may be PTRS port 0.

In Equation (38), in the first CW, a DMRS port corresponding to the first layer is connected to PUSCH antenna port 1000, i.e., to a PUSCH antenna port connected to PTRS port 0, a DMRS port corresponding to the second layer is connected to PUSCH antenna port 1002, i.e., to a PUSCH antenna port connected to PTRS port 0, and a DMRS port corresponding to the third layer is connected to PUSCH antenna port 1004, i.e., to a PUSCH antenna port connected to PTRS port 0. Additionally, other modifications may not be excluded such as the DMRS port corresponding to the first layer being connected to PUSCH antenna port 1002 that is another PUSCH antenna port connected to PTRS port 0, the DMRS port corresponding to the second layer being connected to PUSCH antenna port 1006 that is another PUSCH antenna port connected to PTRS port 0, and the DMRS port corresponding to the third layer being connected to PUSCH antenna port 1004 that is another PUSCH antenna port connected to PTRS port 0.

In Equation (38), in the second CW, a DMRS port corresponding to the fourth layer is connected to PUSCH antenna port 1001, i.e., to a PUSCH antenna port connected to PTRS port 1, a DMRS port corresponding to the fifth layer is connected to PUSCH antenna port 1003, i.e., to a PUSCH antenna port connected to PTRS port 1, and a DMRS port corresponding to the sixth layer is connected to PUSCH antenna port 1005, i.e., to a PUSCH antenna port connected to PTRS port 1. Additionally, other modifications may not be excluded such as the DMRS port corresponding to the fourth layer being connected to PUSCH antenna port 1003 that is another PUSCH antenna port connected to PTRS port 1, the DMRS port corresponding to the fifth layer being connected to PUSCH antenna port 1007 that is another PUSCH antenna port connected to PTRS port 1, and the DMRS port corresponding to the sixth layer being connected to PUSCH antenna port 1001 that is another PUSCH antenna port connected to PTRS port 1.

Each of the DMRS ports included in the first CW and the second CW may be connected to one PUSCH antenna port, and the terminal may not expect that two or more DMRS ports are connected to the same PUSCH antenna port.

A DMRS port being connected to a PUSCH antenna port may imply that a value of the position of a column corresponding to the DMRS port in a TPMI and of the position of a row corresponding to the PUSCH antenna port is 1. The position of 1 existing in each column in the TPMI may be changed in consideration of a connection relation between a PTRS port and a PUSCH antenna port.

In addition, any order change in two columns corresponding to the first 3 layers of the TPMI expressed by Equation (38), and any order change in three columns corresponding to the remaining 3 layers may be considered without being excluded.

Similarly, the terminal and the BS may define a non-coherent TPMI for 7 layers as shown in Equation (39) below.

$$W = \frac{1}{\sqrt{7}} [ \begin{matrix}1 & 0 & 0 & 0 & 0 & 0 & 0 \\ 0 & 0 & 0 & 1 & 0 & 0 & 0 \\ 0 & 1 & 0 & 0 & 0 & 0 & 0 \\ 0 & 0 & 0 & 0 & 1 & 0 & 0 \\ 0 & 0 & 1 & 0 & 0 & 0 & 0 \\ 0 & 0 & 0 & 0 & 0 & 1 & 0 \\ 0 & 0 & 0 & 0 & 0 & 0 & 0 \\ 0 & 0 & 0 & 0 & 0 & 0 & 1\end{matrix} ] \qquad ( 39 )$$

A TPMI expressed by Equation (39) may be applied to a codebook-based PUSCH scheduled as 7 layers.

DMRS ports corresponding to the first 3 layers of the TPMI may be included in a first CW, and DMRS ports corresponding to the remaining 4 layers may be included in a second CW.

Each of the DMRS ports corresponding to the first 3 layers of the TPMI may be connected to a PUSCH antenna port connected to PTRS port 0 (e.g., one of PUSCH antenna ports 1000, 1002, 1004, and 1006), or may be connected to a PUSCH antenna port connected to PTRS port 1 (e.g., one of PUSCH antenna ports 1001, 1003, 1005, and 1007).

Each of the DMRS ports corresponding to the last 4 layers of the TPMI may be connected to a PUSCH antenna port connected to PTRS port 0 (e.g., one of PUSCH antenna ports 1000, 1002, 1004, and 1006), or may be connected to a PUSCH antenna port connected to PTRS port 1 (e.g., one of PUSCH antenna ports 1001, 1003, 1005, and 1007).

A PTRS port connected to PUSCH antenna ports corresponding to the DMRS ports in the first CW may be different from a PTRS port connected to PUSCH antenna ports corresponding to the DMRS ports in the second CW. For example, if a PTRS port connected to PUSCH antenna ports corresponding to the DMRS ports in the first CW is PTRS port 1, a PTRS port connected to PUSCH antenna ports corresponding to the DMRS ports in the second CW may be PTRS port 0.

In Equation (39), in the first CW, a DMRS port corresponding to the first layer is connected to PUSCH antenna port 1000, i.e., to a PUSCH antenna port connected to PTRS port 0, a DMRS port corresponding to the second layer is connected to PUSCH antenna port 1002, i.e., to a PUSCH antenna port connected to PTRS port 0, and a DMRS port corresponding to the third layer is connected to PUSCH antenna port 1004, i.e., to a PUSCH antenna port connected to PTRS port 0. Additionally, other modifications may not be excluded such as the DMRS port corresponding to the first layer being connected to PUSCH antenna port 1002 that is another PUSCH antenna port connected to PTRS port 0, the DMRS port corresponding to the second layer being connected to PUSCH antenna port 1006 that is another PUSCH antenna port connected to PTRS port 0, and the DMRS port corresponding to the third layer being connected to PUSCH antenna port 1004 that is another PUSCH antenna port connected to PTRS port 0.

In Equation (39), in the second CW, a DMRS port corresponding to the fourth layer is connected to PUSCH antenna port 1001, i.e., to a PUSCH antenna port connected to PTRS port 1, a DMRS port corresponding to the fifth layer is connected to PUSCH antenna port 1003, i.e., to a PUSCH antenna port connected to PTRS port 1, a DMRS port corresponding to the sixth layer is connected to PUSCH antenna port 1005, i.e., to a PUSCH antenna port connected to PTRS port 1, and a DMRS port corresponding to the seventh layer is connected to PUSCH antenna port 1007, i.e., to a PUSCH antenna port connected to PTRS port 1. Additionally, other modifications may not be excluded such as the DMRS port corresponding to the fourth layer being connected to PUSCH antenna port 1003 that is another PUSCH antenna port connected to PTRS port 1, the DMRS port corresponding to the fifth layer being connected to PUSCH antenna port 1007 that is another PUSCH antenna port connected to PTRS port 1, the DMRS port corresponding to the sixth layer being connected to PUSCH antenna port 1005 that is another PUSCH antenna port connected to PTRS port 1, and the DMRS port corresponding to the seventh layer being connected to PUSCH antenna port 1001 that is another PUSCH antenna port connected to PTRS port 1.

Each of the DMRS ports included in the first CW and the second CW may be connected to one PUSCH antenna port, and the terminal may not expect that two or more DMRS ports are connected to the same PUSCH antenna port.

A DMRS port being connected to a PUSCH antenna port may imply that a value of the position of a column corresponding to the DMRS port in a TPMI and of the position of a row corresponding to the PUSCH antenna port is 1. The position of 1 existing in each column in the TPMI may be changed in consideration of a connection relation between a PTRS port and a PUSCH antenna port.

In addition, any order change in two columns corresponding to the first 3 layers of the TPMI expressed by Equation (39), and any order change in three columns corresponding to the remaining 4 layers may be considered without being excluded.

Similarly, the terminal and the BS may define a non-coherent TPMI for 8 layers as shown in Equation (40) below.

$$W = \frac{1}{2 \sqrt{2}} [ \begin{matrix}1 & 0 & 0 & 0 & 0 & 0 & 0 & 0 \\ 0 & 1 & 0 & 0 & 0 & 0 & 0 & 0 \\ 0 & 0 & 1 & 0 & 0 & 0 & 0 & 0 \\ 0 & 0 & 0 & 1 & 0 & 0 & 0 & 0 \\ 0 & 0 & 0 & 0 & 1 & 0 & 0 & 0 \\ 0 & 0 & 0 & 0 & 0 & 1 & 0 & 0 \\ 0 & 0 & 0 & 0 & 0 & 0 & 1 & 0 \\ 0 & 0 & 0 & 0 & 0 & 0 & 0 & 1\end{matrix} ]$$

A TPMI expressed by Equation (40) may be applied to a codebook-based PUSCH scheduled as 8 layers.

DMRS ports corresponding to the first 4 layers of the TPMI may be included in a first CW, and DMRS ports corresponding to the remaining 4 layers may be included in a second CW.

Each of the DMRS ports corresponding to the first 4 layers of the TPMI may be connected to a PUSCH antenna port connected to PTRS port 0 (e.g., one of PUSCH antenna ports 1000, 1002, 1004, and 1006), or may be connected to a PUSCH antenna port connected to PTRS port 1 (e.g., one of PUSCH antenna ports 1001, 1003, 1005, and 1007).

Each of the DMRS ports corresponding to the last 4 layers of the TPMI may be connected to a PUSCH antenna port connected to PTRS port 0 (e.g., one of PUSCH antenna ports 1000, 1002, 1004, and 1006), or may be connected to a PUSCH antenna port connected to PTRS port 1 (e.g., one of PUSCH antenna ports 1001, 1003, 1005, and 1007).

A PTRS port connected to PUSCH antenna ports corresponding to the DMRS ports in the first CW may be different from a PTRS port connected to PUSCH antenna ports corresponding to the DMRS ports in the second CW. For example, if a PTRS port connected to PUSCH antenna ports corresponding to the DMRS ports in the first CW is PTRS port 1, a PTRS port connected to PUSCH antenna ports corresponding to the DMRS ports in the second CW may be PTRS port 0.

In Equation (40), in the first CW, a DMRS port corresponding to the first layer is connected to PUSCH antenna port 1000, i.e., to a PUSCH antenna port connected to PTRS port 0, a DMRS port corresponding to the second layer is connected to PUSCH antenna port 1002, i.e., to a PUSCH antenna port connected to PTRS port 0, a DMRS port corresponding to the third layer is connected to PUSCH antenna port 1004, i.e., to a PUSCH antenna port connected to PTRS port 0, and a DMRS port corresponding to the fourth layer is connected to PUSCH antenna port 1006, i.e., to a PUSCH antenna port connected to PTRS port 0. Additionally, other modifications may not be excluded such as the DMRS port corresponding to the first layer being connected to PUSCH antenna port 1002 that is another PUSCH antenna port connected to PTRS port 0, the DMRS port corresponding to the second layer being connected to PUSCH antenna port 1006 that is another PUSCH antenna port connected to PTRS port 0, the DMRS port corresponding to the third layer being connected to PUSCH antenna port 1004 that is another PUSCH antenna port connected to PTRS port 0, and the DMRS port corresponding to the fourth layer being connected to PUSCH antenna port 1000 that is another PUSCH antenna port connected to PTRS port 0.

In Equation (40), in the second CW, a DMRS port corresponding to the fifth layer is connected to PUSCH antenna port 1001, i.e., to a PUSCH antenna port connected to PTRS port 1, a DMRS port corresponding to the sixth layer is connected to PUSCH antenna port 1003, i.e., to a PUSCH antenna port connected to PTRS port 1, a DMRS port corresponding to the seventh layer is connected to PUSCH antenna port 1005, i.e., to a PUSCH antenna port connected to PTRS port 1, and a DMRS port corresponding to the eighth layer is connected to PUSCH antenna port 1007, i.e., to a PUSCH antenna port connected to PTRS port 1. Additionally, other modifications may not be excluded such as the DMRS port corresponding to the fifth layer being connected to PUSCH antenna port 1003 that is another PUSCH antenna port connected to PTRS port 1, the DMRS port corresponding to the sixth layer being connected to PUSCH antenna port 1001 that is another PUSCH antenna port connected to PTRS port 1, the DMRS port corresponding to the seventh layer being connected to PUSCH antenna port 1007 that is another PUSCH antenna port connected to PTRS port 1, and the DMRS port corresponding to the eighth layer being connected to PUSCH antenna port 1005 that is another PUSCH antenna port connected to PTRS port 1.

Each of the DMRS ports included in the first CW and the second CW may be connected to one PUSCH antenna port, and the terminal may not expect that two or more DMRS ports are connected to the same PUSCH antenna port.

A DMRS port being connected to a PUSCH antenna port may imply that a value of the position of a column corresponding to the DMRS port in a TPMI and of the position of a row corresponding to the PUSCH antenna port is 1. The position of 1 existing in each column in the TPMI may be changed in consideration of a connection relation between a PTRS port and a PUSCH antenna port.

In addition, any order change in two columns corresponding to the first 4 layers of the TPMI expressed by Equation (40), and any order change in three columns corresponding to the remaining 4 layers may be considered without being excluded.

5-layer, 6-layer, 7-layer, and 8-layer TPMIs expressible by Equation (37) to Equation (40) may include, when the terminal performs PUSCH transmission of 5 or more layers, only DMRS ports connected to PUSCH antenna ports connectable to one PTRS port in each CW.

In this case, if the terminal has received PTRS transmission-related higher layer signaling from the BS and 2 is configured as the number of maximally transmittable PTRS ports by the BS through higher layer signaling, when interpreting a PTRS-DMRS association field in DCI receivable from the BS, the terminal may consider the following method.

### PTRS-DMRS Association Method 4-2-1

If, as described above, higher layer signaling indicating that PUSCH transmission based on 2 CWs, that is PUSCH transmission configured by 5 or more layers is possible is configured for the terminal by the BS, the terminal has received DCI scheduling PUSCH transmission of 5 or more layers from the BS, and a TPMI defined as shown in method 4-2 is indicated through the same DCI, the terminal may expect that only DMRS ports corresponding to PUSCH antenna ports connectable one PTRS port are included in each CW. In this case, all DMRS ports included in one CW may correspond to only PUSCH antenna ports connected to one of PTRS port 0 or 1. That is, selecting DMRS ports to be connected to two PTRS ports, respectively, by selecting one CW may be difficult.

In this case, e.g., the terminal may expect that DMRS ports corresponding to PUSCH antenna ports 1000, 1002, 1004, and 1006 are included in a first CW and may expect that DMRS ports corresponding to PUSCH antenna ports 1001, 1003, 1005, and 1007 are included in a second CW and, in the first CW, PUSCH antenna ports sharing PTRS port 0 are 1000, 1002, 1004, and 1006, DMRS ports corresponding thereto may be included, and DMRS ports connected to PUSCH antenna ports sharing PTRS port 1 may not be included. Similarly, in the second CW, DMRS ports connected to PUSCH antenna ports sharing PTRS port 0 may not be included, PUSCH antenna ports sharing PTRS port 1 are 1001, 1003, 1005, and 1007, and DMRS ports corresponding thereto may be included.

The terminal may connect 2 PTRS ports to particular DMRS ports according to the meaning of each codepoint of a PTRS-DMRS association field of Table 58 below defined by 4 bits, and use same at the time of PUSCH transmission. The terminal and the BS may define the meaning of each codepoint of a PTRS-DMRS association field as shown in Table 58.

TABLE 58

| Value | | Value | |
|---|---|---|---|
| of two | | of two | |
| MSBs | DMRS port | LSBs | DMRS port |
| 0 | 1^{st} DMRS port which | 0 | 1^{st} DMRS port which |
| | shares PTRS port 0 | | shares PTRS port 1 |
| | with the CW1 | | with the CW2 |
| 1 | 2^{nd} DMRS port which | 1 | 2^{nd} DMRS port which |
| | shares PTRS port 0 | | shares PTRS port 1 |
| | with the CW1 | | with the CW2 |
| 2 | 3^{rd} DMRS port which | 2 | 3^{rd} DMRS port which |
| | shares PTRS port 0 | | shares PTRS port 1 |
| | with the CW1 | | with the CW2 |
| 3 | 4^{th} DMRS port which | 3 | 4^{th} DMRS port which |
| | shares PTRS port 0 | | shares PTRS port 1 |
| | with the CW1 | | with the CW2 |

In Table 58, one of DMRS ports included in a first CW (CW1) may be connected to PTRS port 0 through 2 MSBs among 4 bits of a PTRS-DMRS association field in DCI, and one of DMRS ports included in a second CW (CW2) may be connected to PTRS port 1 through 2 LSBs. According to which PUSCH antenna port to which a DMRS is connected, the DMRS being included in each CW, a connection relation of PTRS port 0 indicated through 2 MSBs in Table 55 may correspond to a DMRS port in CW2 rather than CW1.

With respect to a first codepoint (when the value of two MSBs is 0) indicated through 2 MSBs in Table 58, the terminal may interpret a connected DMRS port to be “1st DMRS port which shares PTRS port 0 with the CW2”. In addition, as described above, which set of PUSCH antenna ports is connected to a random PTRS port and is able to share information processible by the BS are determined, and if the connection and sharing relations are identical to those of a coherent antenna set included in each CW, a DMRS port connected to a particular CW (CW1 or CW2) may not be indicated to the terminal through a PTRS-DMRS association field.

With respect to a first codepoint (when the value of two MSBs is 0) indicated through 2 MSBs in Table 58, the terminal may interpret a connected DMRS port to be the first DMRS port sharing PTRS port 0, such as “1st DMRS port which shares PTRS port 0”, rather than a DMRS port included in CW1.

If the BS defines a PTRS-DMRS association field in DCI, based on [PTRS-DMRS association method 4-2-1], while DCI overhead is increased by consuming 4 bits, compared to a case of a maximum number of PTRS ports being 1, the BS may indicate connection relations with 2 PTRS ports for all DMRS ports in all CWs. Therefore, the BS may secure a high degree of freedom for scheduling.

When the terminal supports 4 transmission antennas, DMRS ports corresponding to different coherent antenna sets may be included in one CW even at the time of partial-coherent PUSCH transmission for a maximum of 4 layers.

In method 4-2, when the terminal supports 8 transmission antennas, the terminal may perform non-coherent PUSCH transmission of 5 or more layers, similarly to maximum 4-layer partial coherent PUSCH transmission, after including DMRS ports corresponding to different coherent antenna sets in one CW. Therefore, when the BS performs channel estimation for the PUSCH, the BS may use an implementation scheme similar to when receiving partial-coherent PUSCH transmission for a maximum of 4 layers from the terminal, and when the BS indicates which DMRS ports to which 2 PTRS ports are connected, it is enough to indicate a connection relation only for 2 DMRS ports in a particular CW, and thus reduction of DCI overhead is possible.

In method 4-2, if the BS receives a PUSCH of 5 or more layers transmitted from the terminal, when the BS performs channel estimation for each CW and decodes data corresponding to each layer, the BS may allocate DMRS ports corresponding to PUSCH antenna ports connectable to a particular PTRS port to one CW so that, at the time of PTRS reception and application of an estimated value, decoding performance may be improved. However, in a case where the terminal transmits a PUSCH after connecting 2 PTRS ports to particular DMRS ports, when a PTRS-DMRS association is indicated, the number of bits of a PTRS-DMRS association field in DCI may be increased in order to obtain a maximum degree of freedom for scheduling.

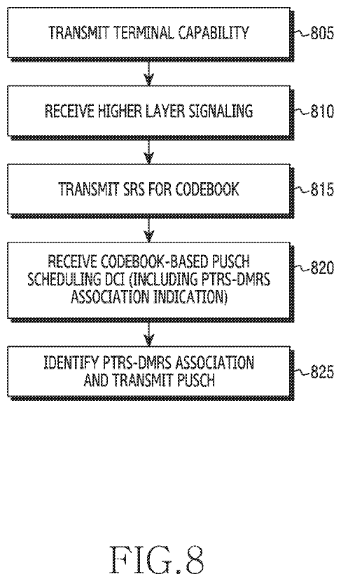

FIG. 8 is a flowchart illustrating operations of a terminal according to an embodiment.

Referring to FIG. 8, in step 805, a terminal transmits a terminal capability to a BS. The terminal capability may be, as described in the above embodiments, a PTRS-related terminal capability, a terminal capability related to the coherency of the terminal supporting 8 transmission antennas, a terminal capability indicating whether the terminal supports at least one of method 2-1, method 2-2, method 3-1, method 3-2, method 4-1, and method 4-2, or whether the terminal supports a TPMI configuration scheme and PTRS-DMRS association methods.

In step 810, the terminal receives higher layer signaling from the BS. The higher layer signaling may be PTRS-related configuration information, configuration information related to the coherency of the terminal supporting 8 transmission antennas as described in the above embodiments, configuration information relating to at least one of method 2-1, method 2-2, method 3-1, method 3-2, method 4-1, and method 4-2, and configuration information related to a TPMI configuration scheme and PTRS-DMRS association methods.

In step 815, the terminal transmits, to the BS, SRS resources having codebook as usage that is higher layer signaling in an SRS resource set. Based on the SRS resources transmitted by the terminal, the BS may estimate an UL channel between the terminal and the BS, and use same as information when scheduling codebook-based PUSCH transmission for the terminal.

In step 820, the terminal receives DCI including scheduling information for codebook-based PUSCH transmission from the BS. The terminal may identify a DMRS port index to be used at the time of PUSCH transmission through an antenna port field included in the DCI, a TPMI index of a particular coherency through a TPMI field, MCS, NDI, and RV field information for each CW in a case of 5 or more-layer PUSCH transmission scheduling, and information relating to which DMRS port to which one or two PTRS ports are connected, through a PTRS-DMRS association field. In a case of 4 or fewer-layer PUSCH transmission scheduling, a first MCS field, a first NDI field, and a first RV field may satisfy a particular condition described above or a second MCS field, a second NDI field, and a second RV field may satisfy a particular condition described above, an indicated number of DMRS ports may be equal to or smaller than 4, an indicated TPMI may include 4 or fewer layers, and a PTRS-DMRS association field may be interpreted based on Table 28 or 29 according to whether a maximum number of PTRS ports configured for the terminal by the BS through higher layer signaling is 1 or 2.

In addition, in a case of 5 or more-layer PUSCH transmission scheduling, an indicated number of DMRS ports may be equal to or greater than 5, an indicated TPMI may include 5 or more layers, and a PTRS-DMRS association field may be interpreted based on Table 50, rather than Table 28, when a maximum number of PTRS ports configured for the terminal by the BS through higher layer signaling is 1, and may be interpreted based on one of Tables 51 to 58, rather than Table 29, when the maximum number of PTRS ports is 2.

In step 825, the terminal identifies, through a PTRS-DMRS association field in the DCI received from the BS, which DMRS ports in the PUSCH to which one or two PTRS ports are connected, and connects a PTRS port to a particular DMRS port at the time of PUSCH transmission, based on the identification.

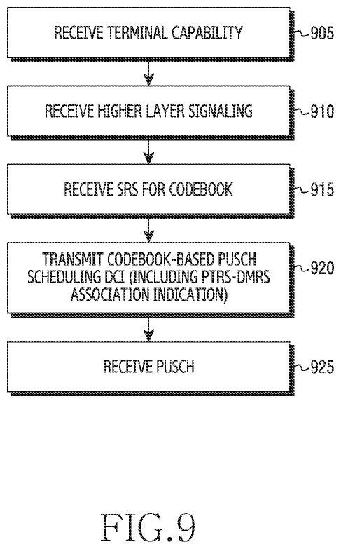

FIG. 9 is a flowchart illustrating operations of a BS according to an embodiment.

Referring to FIG. 9, in step 905, a BS receives terminal capability transmission of a terminal. The terminal capability received from the terminal may include, as described in the above embodiments, a PTRS-related terminal capability, a terminal capability related to the coherency of the terminal supporting 8 transmission antennas, and a terminal capability indicating whether the terminal supports at least one of method 2-1, method 2-2, method 3-1, method 3-2, method 4-1, and method 4-2, or whether the terminal supports a TPMI configuration scheme and PTRS-DMRS association methods.

In step 910, the BS transmits higher layer signaling to the terminal. The higher layer signaling may be PTRS-related configuration information, configuration information related to the coherency of the terminal supporting 8 transmission antennas as described in the above embodiments, configuration information relating to at least one of method 2-1, method 2-2, method 3-1, method 3-2, method 4-1, and method 4-2, and configuration information related to a TPMI configuration scheme and PTRS-DMRS association methods.

In step 915, the BS receives, from the terminal, SRS resources having codebook as usage that is higher layer signaling in an SRS resource set. Based on the received SRS resources, the BS may estimate an UL channel between the terminal and the BS, and use same as information when scheduling codebook-based PUSCH transmission for the terminal.

In step 920, the BS transmits DCI including scheduling information for codebook-based PUSCH transmission to the terminal. The BS may indicate, to the terminal, a DMRS port index to be used at the time of PUSCH transmission through an antenna port field in the DCI, a TPMI index of a particular coherency through a TPMI field, MCS, NDI, and RV field information for each CW in a case of 5 or more-layer PUSCH transmission scheduling, and information relating to which DMRS port to which one or two PTRS ports are connected, through a PTRS-DMRS association field.

In a case of 4 or fewer-layer PUSCH transmission scheduling, a first MCS field, a first NDI field, and a first RV field may satisfy a particular condition described above or a second MCS field, a second NDI field, and a second RV field may satisfy a particular condition described above, an indicated number of DMRS ports may be equal to or smaller than 4, an indicated TPMI may include 4 or fewer layers, and a PTRS-DMRS association field may be interpreted based on Table 28 or 29 according to whether a maximum number of PTRS ports configured for the terminal by the BS through higher layer signaling is 1 or 2.

In addition, in a case of 5 or more-layer PUSCH transmission scheduling, an indicated number of DMRS ports may be equal to or greater than 5, an indicated TPMI may include 5 or more layers, and a PTRS-DMRS association field may be interpreted based on Table 50, rather than Table 28, when a maximum number of PTRS ports configured for the terminal by the BS through higher layer signaling is 1, and may be interpreted based on one of Tables 51 to 58, rather than Table 29, when the maximum number of PTRS ports is 2.

In step 925, the BS indicates, to the terminal, through a PTRS-DMRS association field in the DCI transmitted to the terminal, which DMRS ports in the PUSCH to which one or two PTRS ports are connected, and may assume, based on the indication, which PTRS port is connected to which DMRS port and is then transmitted to the BS at the time of PUSCH transmission.

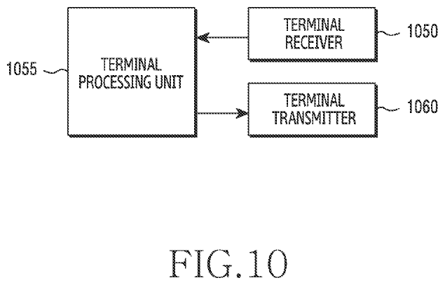

FIG. 10 illustrates a UE in a wireless communication system according to an embodiment.

Referring to FIG. 10, the UE includes a transceiver, which refers to a receiver 1050 and a transmitter 1060 as a whole, a memory, and a processing unit 1055 (e.g., a controller or processor). The transceiver, memory, and the processing unit 1055 may operate according to the above-described communication methods of the UE.

Additionally, components of the UE are not limited to the above-described example. For example, the UE may include a more or fewer components than illustrated in FIG. 10. Further, the transceiver, the memory, and the processor may be implemented as a single chip.

The transceiver may transmit/receive signals with the BS. The signals may include control information and data. To this end, the transceiver may include a radio frequency (RF) transmitter 1060 configured to up-convert and amplify the frequency of transmitted signals, an RF receiver 1050 configured to low-noise-amplify received signals and down-convert the frequency thereof, etc. This is only an embodiment of the transceiver, and the components of the transceiver are not limited to the RF transmitter 1060 and the RF receiver 1050.

In addition, the transceiver may receive signals through a radio channel, output the same to the processor, and transmit signals output from the processor through the radio channel.

The memory may store programs and data for the UE operations. In addition, the memory may store control information or data included in signals transmitted/received by the UE. The memory may include storage media such as a read only memory (ROM), a random access memory (RAM), a hard disk, a compact disc (CD)-ROM, a digital versatile disc (DVD), or a combination of storage media. In addition, the UE may include multiple memories.

In addition, the processing unit 1055 may control a series of processes such that the UE can operate according to the above-described embodiments. For example, the processing unit 1055 may control components of the UE so as to receive DCI configured in two layers such that multiple PDSCHs are received simultaneously. The processing unit 1055 may include multiple processors, and the processors may perform the UE's component control operations by executing programs stored in the memory.

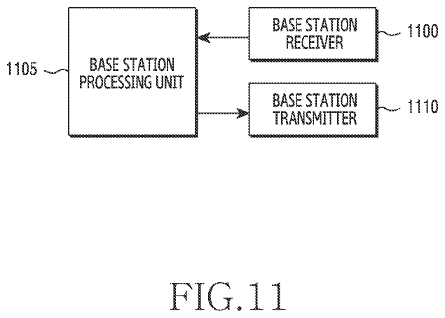

FIG. 11 illustrates a BS in a wireless communication system according to an embodiment.

Referring to FIG. 11, the BS includes a transceiver, which refers to a receiver 1100 and a transmitter 1110 as a whole, a memory, and a processing unit 1105 (e.g., a controller or a processor). The transceiver, the memory, and the processing unit 1105 may operate according to the above-described communication methods of the BS.

Components of the BS are not limited to the example illustrated in FIG. 11. For example, the BS may include more or fewer components than the above-described components. Furthermore, the transceiver, the memory, and the processing unit 1105 may be implemented as a single chip.

The transceiver may transmit/receive signals with the UE. The signals may include control information and data. To this end, the transceiver may include an RF transmitter 1110 configured to up-convert and amplify the frequency of transmitted signals, an RF receiver 1100 configured to low-noise-amplify received signals and down-convert the frequency thereof, etc. This is only an embodiment of the transceiver, and the components of the transceiver are not limited to the RF transmitter 1110 and the RF receiver 1100.

In addition, the transceiver may receive signals through a radio channel, output the same to the processing unit 1105, and transmit signals output from the processing unit 1105 through the radio channel.

The memory may store programs and data for BS operations. In addition, the memory may store control information or data included in signals transmitted/received by the BS. The memory may include storage media such as a ROM, a RAM, a hard disk, a CD-ROM, and a DVD, or a combination of storage media. In addition, the BS may include multiple memories.

The processing unit 1105 may control a series of processes such that the BS can operate according to the above-described embodiments of the disclosure. For example, the processing unit 1105 may control components of the BS so as to configure DCI configured in two layers including allocation information regarding multiple PDSCHs and to transmit the same. The processing unit 1105 may include multiple processors, and the processors may perform the BS's component control operations by executing programs stored in the memory.

Methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a ROM, an electrically erasable programmable read only memory (EEPROM), a magnetic disc storage device, a CD-ROM, a DVD, other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a BS and a terminal. For example, a part of embodiment 1 of the disclosure may be combined with a part of embodiment 2 to operate a BS and a terminal. Moreover, although the above embodiments have been described based on the FDD LTE system, other variants based on the technical idea of the embodiments may also be implemented in other systems such as TDD LTE, 5G, and NR systems.

In the drawings in which methods of the disclosure are described, the order of the description does not always correspond to the order in which steps of each method are performed, and the order relationship between the steps may be changed or the steps may be performed in parallel.

Furthermore, in the drawings in which methods of the disclosure are described, some elements may be omitted and only some elements may be included therein without departing from the essential spirit and scope of the disclosure.

Moreover, in methods of the disclosure, some or all of the contents of each embodiment may be implemented in combination without departing from the essential spirit and scope of the disclosure.

Various embodiments of the disclosure have been described above. The above description of the disclosure is merely for the purpose of illustration, and embodiments of the disclosure are not limited to the embodiments set forth herein. Those skilled in the art will appreciate that other particular modifications and changes may be easily made without departing from the technical idea or the essential features of the disclosure.

Accordingly, the scope of the disclosure should not be determined by the above description, but by the appended claims, and all modifications or changes derived from the meaning and scope of the claims and equivalent concepts thereof shall be construed as falling within the scope of the disclosure.

What is claimed is:

1. A method performed by a user equipment (UE) in a wireless communication system, the method comprising:
receiving, from a base station (BS), downlink control information (DCI) scheduling a physical uplink shared channel (PUSCH) of two codewords (CWs), the DCI including information on an association between a phase tracking reference signal (PTRS) and a demodulation reference signal (DMRS);
identifying a PTRS port based on the information; and
transmitting, to the BS, the PUSCH and the PTRS for the PUSCH,
wherein the PTRS is transmitted on the PTRS port.

2. The method of claim 1, wherein a number of the PTRS port is configured by information on a maximum number of PTRS ports, and
wherein the information on the association between the PTRS and the DMRS includes 2 bits, in case that the number of PTRS port is one, and includes 4 bits, in case that the number of PTRS port is two.

3. The method of claim 2, wherein, in case that the number of PTRS port is one, identifying the PTRS port comprises:
in case that modulation and coding scheme (MCS) values for the two CWs are different, identifying a CW with a higher MCS value among the two CWs;
in case that the MCS values for the two CWs are same, identifying a first CW among the two CWs; and
identifying a DMRS port of the identified CW for the PTRS port based on the information.

4. The method of claim 2, wherein, in case that the number of PTRS port is two, identifying the PTRS port comprises:
identifying a first DMRS port for a first PTRS port based on two most signification bits (MSBs) of the information; and
identifying a second DMRS port for a second PTRS port based on two least significant bits (LSBs) of the information.

5. The method of claim 4, wherein, in case that the plurality of antenna port is 8 antenna ports based on the DCI, antenna ports of 1000, 1001, 1004, and 1005 are associated with a first PTRS port and antenna ports of 1002, 1003, 1006, and 1007 are associated with a second PTRS port.

6. A method performed by a base station (BS) in a wireless communication system, the method comprising:
transmitting, to a user equipment (UE), downlink control information (DCI) scheduling a physical uplink shared channel (PUSCH) of two codewords (CWs), the DCI including information on an association between a phase tracking reference signal (PTRS) and a demodulation reference signal (DMRS); and
receiving, from the UE, the PUSCH and the PTRS for the PUSCH, wherein the PTRS is received on a PTRS port which is based on the information.

7. The method of claim 6, wherein a number of PTRS port is configured according to information for a maximum number of PTRS ports configured by higher layer signaling, and
wherein the information related to the association between the PTRS and the DMRS port is 2 bits size for one PTRS port or 4 bits size for two PTRS ports.

8. The method of claim 7, wherein, in case that the number of PTRS port is two, and in case that the plurality of antenna port is 8 antenna ports based on the DCI, antenna ports of 1000, 1001, 1004, and 1005 are associated with a first PTRS port and antenna ports of 1002, 1003, 1006, and 1007 are associated with a second PTRS port.

9. A user equipment (UE) in a wireless communication system, the UE comprising:
a transceiver; and
a controller coupled with the transceiver and configured to:
receive, from a base station (BS), downlink control information (DCI) scheduling a physical uplink shared channel (PUSCH) of two codewords (CWs), the DCI including information on an association between a phase tracking reference signal (PTRS) and a demodulation reference signal (DMRS),
identify a PTRS port based on the information, and
transmit, to the BS, the PUSCH and the PTRS for the PUSCH,
wherein the PTRS is transmitted on the PTRS port.

10. The UE of claim 9, wherein a number of the PTRS port is configured by information on a maximum number of PTRS ports, and
wherein the information on the association between the PTRS and the DMRS includes 2 bits, in case that the number of PTRS port is one, and includes 4 bits, in case that the number of PTRS port is two.

11. The UE of claim 10, wherein, in case that the number of PTRS port is one, the controller is further configured to:
in case that modulation and coding scheme (MCS) values for the two CWs are different, identify a CW with a higher MCS value among the two CWs,
in case that the MCS values for the two CWs are same, identify a first CW among the two CWs, and
identify a DMRS port of the identified CW for the PTRS port based on the information.

12. The UE of claim 10, wherein, in case that the number of PTRS port is two, the controller is further configured to:
identify a first DMRS port for a first PTRS port based on two most signification bits (MSBs) of the information, and
identify a second DMRS port for a second PTRS port based on two least significant bits (LSBs) of the information.

13. The UE of claim 12, wherein, in case that the plurality of antenna port is 8 antenna ports based on the DCI, antenna ports of 1000, 1001, 1004, and 1005 are associated with a first PTRS port and antenna ports of 1002, 1003, 1006, and 1007 are associated with a second PTRS port.

14. A base station (BS) in a wireless communication system, the BS comprising:
a transceiver; and
a controller coupled with the transceiver and configured to:
transmit, to a user equipment (UE), downlink control information (DCI) scheduling a physical uplink shared channel (PUSCH) of two codewords (CWs), the DCI including information on an association between a phase tracking reference signal (PTRS) and a demodulation reference signal (DMRS), and
receive, from the UE, the PUSCH and the PTRS for the PUSCH,
wherein the PTRS is received on a PTRS port which is based on the information.

15. The BS of claim 14, wherein a number of PTRS port is configured according to information for a maximum number of PTRS ports configured by higher layer signaling, and
wherein the information related to the association between the PTRS and the DMRS port is 2 bits size for one PTRS port or 4 bits size for two PTRS ports.

16. The BS of claim 15, wherein, in case that the number of PTRS port is two, and in case that the plurality of antenna port is 8 antenna ports based on the DCI, antenna ports of 1000, 1001, 1004, and 1005 are associated with a first PTRS port and antenna ports of 1002, 1003, 1006, and 1007 are associated with a second PTRS port.
